(19) United States
(12) Patent Application Publication
(10) Pub. No.: US 2011/0269029 A1
(43) Pub. Date: Nov. 3, 2011

(54) DIRECT ALCOHOL ANION FUEL CELL WITH BIOCATHODE

(75) Inventors: Wayne L. Gellett, Ballwin, MO (US); Joshua Schumacher, St. Charles, MO (US); Tracy L. Bucholz, St. Louis, MO (US); David Bao Le, Chicago, IL (US); Douglas A. Busekrus, Lafayette, IN (US); Shelley D. Minteer, Pacific, MO (US); David Trentmann, Eureka, MO (US)

(73) Assignee: AKERMIN, INC., St. Louis, MO (US)

(21) Appl. No.: 13/121,573

(22) PCT Filed: Sep. 29, 2009
(86) PCT No.: PCT/US09/58887

§ 371 Date: Jul. 14, 2011

Related U.S. Application Data
(60) Provisional application No. 61/100,766, filed on Sep. 29, 2008.
(60) Provisional application No. 61/166,477, filed on Apr. 3, 2009.

(51) Int. Cl. H01M 8/16; H01M 4/92; H01M 4/90

(52) U.S. Cl. 429/401

(57) ABSTRACT

A biofuel cell device for generating electrical current, comprising a fuel manifold, an anode assembly, a cathode assembly, a housing, and a controller is described. The anode assembly comprises at least one catalyst positioned for contact with fuel fluid in said fuel reservoir. The cathode assembly comprises at least one biocathode positioned for flow of an oxidant to the biocathode enzyme. The housing houses the manifold, anode assembly and cathode assembly. The controller controls the output of electrical current from the biofuel cell device.

### FIELD OF THE INVENTION

The present invention generally relates to an alkaline fuel cell having a biocathode, an anode, and an anion exchange membrane.

### BACKGROUND OF THE INVENTION

The present invention is directed in general to biological enzyme-based fuel cells (a.k.a. biofuel cells) and their methods of manufacture and use. More specifically, the invention is directed to biocathodes, biocathode stacks, anodes, and their method of manufacture and use in direct alcohol anion fuel cells.

A biofuel cell is an electrochemical device in which energy derived from chemical reactions is converted to electrical energy by means of the catalytic activity of living cells and/or their enzymes. Biofuel cells generally use complex molecules to generate at the anode the hydrogen ions required to reduce oxygen to water, while generating free electrons for use in electrical applications. An anode is the electrode of the biofuel cell where electrons are released upon the oxidation of a fuel and a biocathode is the electrode where electrons and protons from the anode are used by the catalyst to reduce peroxide or oxygen to water.

### SUMMARY OF THE INVENTION

Among the various aspects of the invention is a biofuel cell device for generating electrical current.

Another aspect is a biofuel cell device for generating electrical current, comprising a fuel manifold, at least one cavity in the manifold defining a fuel reservoir, an inlet for flow of fuel fluid into the manifold to fill the reservoir, an anode-cathode assembly comprising at least one anode positioned for contact with fuel fluid in said fuel reservoir and at least one biocathode positioned for flow of an oxidant to a biocathode enzyme, a housing for housing said manifold and said anode-cathode assembly, a controller for controlling the output of electrical current from the biofuel cell device, and a passive fluid management system for controlling a moisture condition inside the housing.

Yet another aspect is a biofuel cell device for generating electrical current, comprising a fuel manifold, at least one cavity in the manifold defining a fuel reservoir, an inlet for flow of fuel fluid into the manifold to fill the reservoir, an anode-cathode assembly comprising at least one anode positioned for contact with fuel fluid in said fuel reservoir and at least one biocathode positioned for flow of air to a biocathode enzyme, a housing for housing said manifold and said anode-cathode assembly, a controller for controlling the output of electrical current from the biofuel cell device, and a venting system for venting carbon dioxide gas from said fuel reservoir.

A further aspect of the invention is a biofuel cell device for supplying electrical power to a load, said device comprising at least one fuel cell; a controller for controlling an electrical output of the fuel cell according to a defined operating mode; and a MOSFET switching circuit situated between the fuel cell and the load, said switching circuit being responsive to the controller for alternately connecting the electrical output of the fuel cell to the load and disconnecting the electrical output of the fuel cell from the load according to the operating mode.

Another aspect is a biocathode comprising an electron conductor; a cathode enzyme capable of gaining electrons from the electron conductor and reacting with an oxidant to produce water, a precious metal catalyst or a combination of metal complexes wherein each metal complex in the combination has a different reduction potential; and an enzyme immobilization material capable of immobilizing and stabilizing the enzyme wherein the immobilization material being permeable to the oxidant.

A further aspect of the invention is a biofuel cell comprising an alkaline fuel fluid; an oxidant; an anode capable of oxidizing the fuel fluid and releasing electrons; a biocathode comprising a cathode enzyme capable of reacting with the oxidant to produce water; and an anion exchange membrane having the structure:

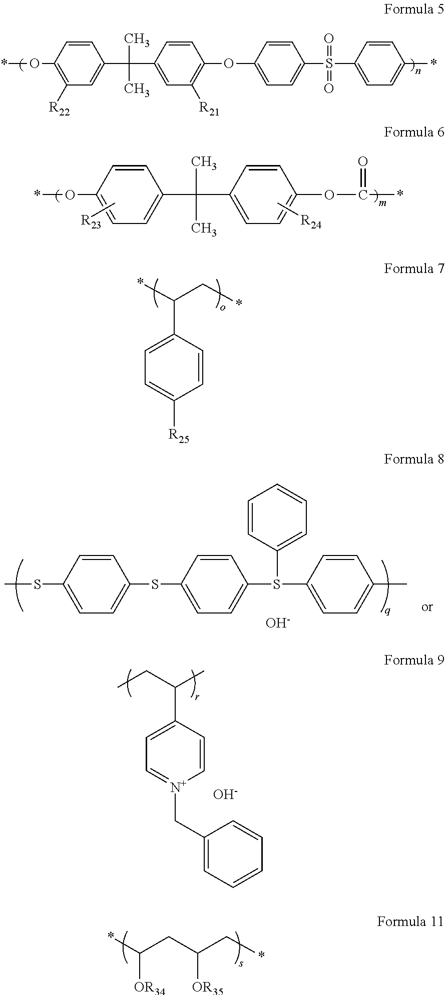

wherein
wherein R₂₁, R₂₂, R₂₃, R₂₄ and R₂₅ are independently hydrogen, alkyl, or substituted alkyl, provided that the average number of alkyl or substituted alkyl groups per repeat unit is at least 0.1; R₃₄ and R₃₅ are independently hydrogen, alkyl, or substituted alkyl, provided that the average number of substituted alkyl groups per repeat group is 0.1; and m, n, o, q, r, and s are integers of at least 10. In various embodiments, m, n, o, q, r, and s are integers from 10 to 5000.

Yet another aspect is a biocathode comprising an electron conductor; and a cathode enzyme capable of gaining electrons from the electron conductor and reacting with an oxidant to produce water. The air-breathing half-cell comprising the electrode would generate a current density of at least about 16, 20, 25, 30, 35, 40, 45, 50, 55, 60, 65, 70, 75, 80, or more mA/cm2 when operating at room temperature, an electrode potential of 0.4 V, and a catalyst loading of 10 mg/cm².

Other objects and features will be in part apparent and in part pointed out hereinafter.

### BRIEF DESCRIPTION OF THE DRAWINGS

FIG. 1 illustrates one embodiment of a fuel cell device of the present invention;

FIG. 2 is an exploded view showing the various components of the fuel cell device 1;

FIG. 3 is a perspective of a fuel manifold of the fuel device of FIG. 1;

FIG. 4 is a section taken on line 4-4 of FIG. 3;

FIG. 5 is an exploded perspective view of the components of a font anode-cathode assembly;

FIG. 6 is a schematic exploded view of the components of certain components of the fuel cell device;

FIG. 7 is a block diagram of the electronic operations of the biofuel cell device;

FIGS. 8 to 21 are circuit diagram of various operation controllers for the biofuel cell device;

FIG. 22 is a photograph of the electrical leads of the biofuel cell device;

FIG. 23 is an enlarged section view of vent tubing and vent ports of one embodiment of a carbon dioxide venting system of the fuel cell device;

FIG. 24 is a top view of the fuel manifold showing an arrangement of the vent tubing in fuel reservoirs of the manifold;

FIG. 25 is a graph of cell voltage versus current density for a laccase mixed polyphthalocyanine cathode versus a mixed polyphthalocyanine cathode without enzyme (as described in Examples 1A and 1B) and a PdPtRu anode in 10% ethanol fuel, air breathing at 20° C.;

FIG. 26 is a graph of cell voltage versus current density for a laccase mixed polyphthalocyanine cathode versus a laccase cathode (as described in Examples 1A and 1C) with a PtRu anode in 20% methanol fuel, air breathing, 20° C.;

FIG. 27 is a graph of cell voltage versus current density for an aminated polysulfone and zirconium oxide doped polysulfone anion exchange membranes (AEM) with 20% potassium hydroxide in solution;

FIG. 28 is a current density plot for a single cell fuel cell with an aminated polysulfone AEM, 10% methanol, no KOH, room temperature, and passive air breathing;

FIG. 29 is a graph of the stack voltage versus time for a fuel cell stack inside and outside of an insulated case as described in Example 4;

FIG. 30 is a graph of the stack voltage versus time for prototypes on a single fuel change. The addition of the air management controls resulted in three times longer stack runtime;

FIG. 31 is a graph of the stack voltage versus time for a fuel cell stack prototype described in Example 5 with varying potassium hydroxide concentration, 11.5 mA average load, and 40 wt. % methanol fuel;

FIG. 32 is a top perspective of an exemplary embodiment of a biofuel coin cell device of this invention, a portion of a retaining ring being broken away to show details;

FIG. 33 is a bottom perspective of an exemplary embodiment of the biofuel coin cell device of FIG. 32;

FIG. 34 is an exploded perspective of the coin cell device;

FIG. 35 is an enlarged vertical section in the plane of 35-35 of FIG. 1;

FIG. 36 is a top plan of an array of anode-cathode assemblies of the coin cell device;

FIG. 37 is an enlarged side elevation of the array of anode-cathode assemblies of FIG. 36, a segment of the array being removed to permit enlargement;

FIG. 38 is a top plan of a reservoir body of the coin cell device;

FIG. 39 is a side elevation of the reservoir body;

FIG. 40 is a top plan of a reservoir cap of the coin cell device;

FIG. 41 is a side elevation of the reservoir cap;

FIG. 42 is a top plan of a sealing member of the coin cell device;

FIG. 43 is a side elevation of the sealing member;

FIG. 44 is an exploded perspective of the reservoir body (with attached array of anode-cathode assemblies), sealing member and reservoir cap;

FIG. 45 is a view similar to FIG. 44 but showing a second embodiment of a reservoir body, sealing member and reservoir cap;

FIG. 46 is a top plan of an exterior cathode terminal of the coin cell device;

FIG. 47 is a side elevation of the exterior cathode terminal;

FIG. 48 is a top plan of an exterior anode terminal of the coin cell device;

FIG. 49 is a side elevation of the exterior anode terminal;

FIG. 50 is an exploded view showing electrical connections between the anode-cathode assemblies and exterior anode and cathode terminals;

FIG. 51 is an electrical circuit illustrating an exemplary series connection of the anode-cathode assemblies;

FIG. 52 is a top plan of a retaining ring of the coin cell device;

FIG. 53 is a side elevation of the retaining ring.

FIG. 54 is graph of the voltage vs. current for a six cell button cell stack described in Example 8 with 40% methanol and 20% KOH as the fuel/electrolyte at room temperature and with an air breathing biocathode.

FIG. 55 is a graph of the voltage vs. current density for a cell described in Example 9 and having varying glycerol concentration (20, 40, 60, and 90%). The KOH concentration for the 10 and 60% glycerol tests was 20%, 30% for the 40% glycerol test, and 5% for the 90% glycerol test.

FIG. 56 is a graph of the voltage vs. current density for a cell described in Example 10 wherein the glycerol concentration is varied (10, 20, 40, and 60%) and the KOH concentration for all tests is 20%.

FIG. 57 is a cell described in Example 11 using a cellophane membrane with 40% methanol and 20% KOH as the fuel/electrolyte. The membrane was tested after the following pretreatments: soaking in a 40% KOH solution for 5 min, dry, and hot pressed.

FIG. 58 is a six cell button cell stack with varying glycerol concentration (20, and 50%) using a zirconium doped polysulfone membrane and a palladium-ruthenium anode catalyst. The KOH concentration for all tests was 20% and the six cell stack was air breathing and at room temperature.

FIG. 59 is a graph of the cell voltage versus current density comparing varying degrees of carbonation for methanol and formate fuel solutions.

FIG. 60 is a graph of the cell voltage versus time for a single fueling duration of 13 mL of 25% formate under a 22.5 mA load.

FIG. 61 is a graph of the cell voltage versus current density for an alkaline exchange membrane comparison of 10% methanol and 25% formate as fuels with no added base electrolyte in the fuel solution in a compression cell test fixture.

FIG. 62 is a graph of the cell voltage versus current density for alkaline testing in varying carbonation levels of the electrolyte tested with formate and air in a compression cell test fixture.

Corresponding reference characters indicate corresponding parts throughout the drawings.

### DETAILED DESCRIPTION

One aspect of the present invention is directed to an alkaline fuel cell having a biocathode, an anode, and an anion exchange membrane.

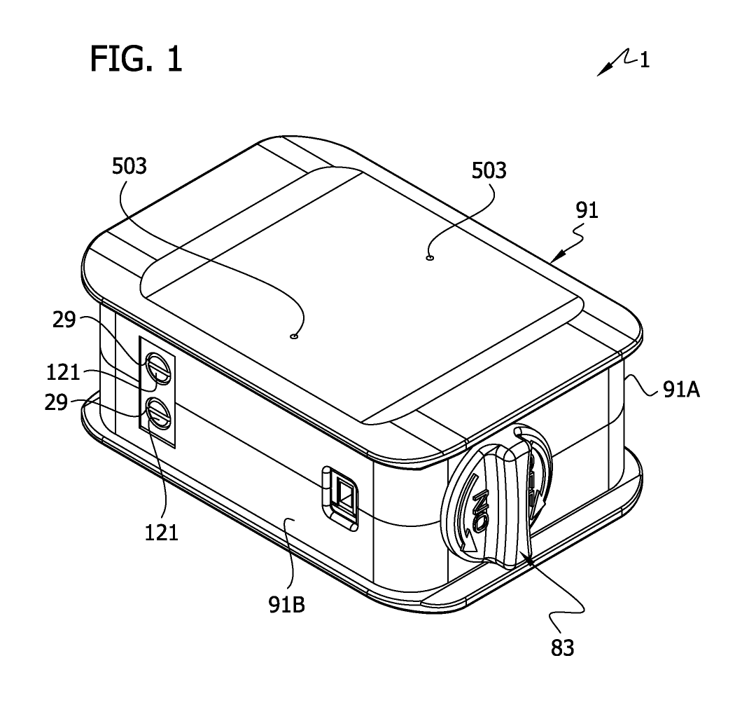

Referring now to the drawings, FIG. 1 illustrates one embodiment of a fuel cell device of the present invention, designated in its entirety by the reference numeral 1. The device 1 is capable of generating electrical current which may be used to meet the power consumption demands of a load. By way of example, the fuel cell device may be used to power small handheld electronics. Fuel for operating the device is provided from a suitable source and is either consumed during use or discharged from the device 1 after use to a suitable waste destination.

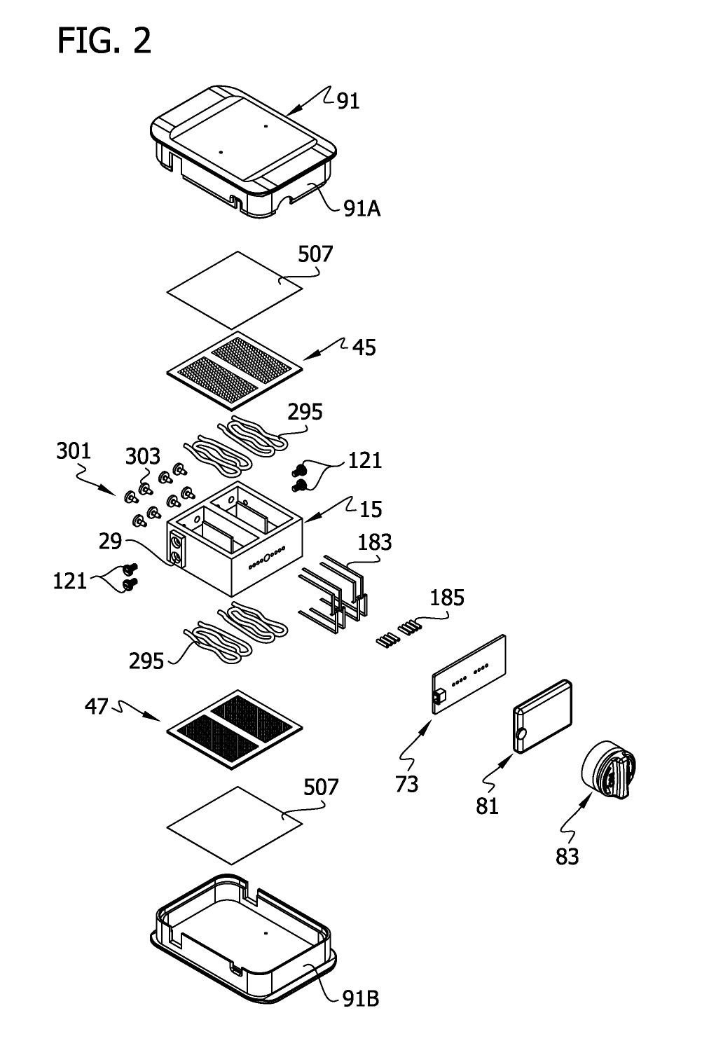

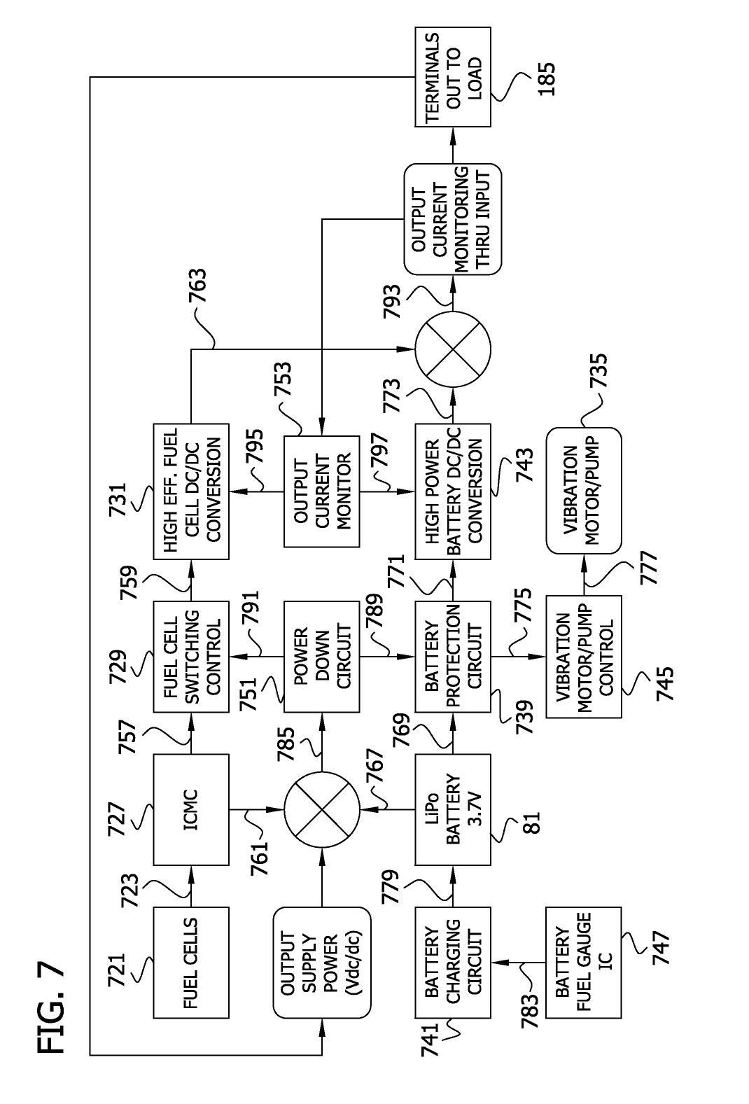

FIG. 2 is an exploded view showing the various components of the fuel cell device 1. In general, the device comprises a fuel manifold 15 having a front side 21, a back side 23 and one or more fuel reservoirs, each designated 25. The manifold 15 has fuel inlets 29 for flow of fuel fluid from a fuel source (not shown) into the manifold reservoirs 25. The fuel cell device 1 also includes front and back anode-cathode assemblies or “stacks” generally designated 45 and 47, respectively, on opposite front and back sides 21, 23 of the manifold 15 for reacting with fuel in the fuel reservoir(s) 25. An electronic controller, generally designated 71 (see FIG. 7), is provided on a printed circuit board 73 for controlling operation of the device, as will be described later. A battery, generally indicated at 81, is also included for providing power to supplement the normal output of the fuel cells, as needed, and to power the electronic controller. A wire (not shown) or other conductive means electrically connects the printed circuit board 73 to connect battery 81 to controller 71. Additionally, a plurality of wires or other conductive means electrically connect controller 71 to the other components of fuel cell device 1, as needed. An on/off switch, generally indicated at 83, permits a user to turn on or turn off fuel cell device 1. The components described above are contained in a housing, generally designated 91, so that the fuel cell device is self-contained as a relatively small, compact unit. Each of the above components is described in detail below.

### Fuel Manifold

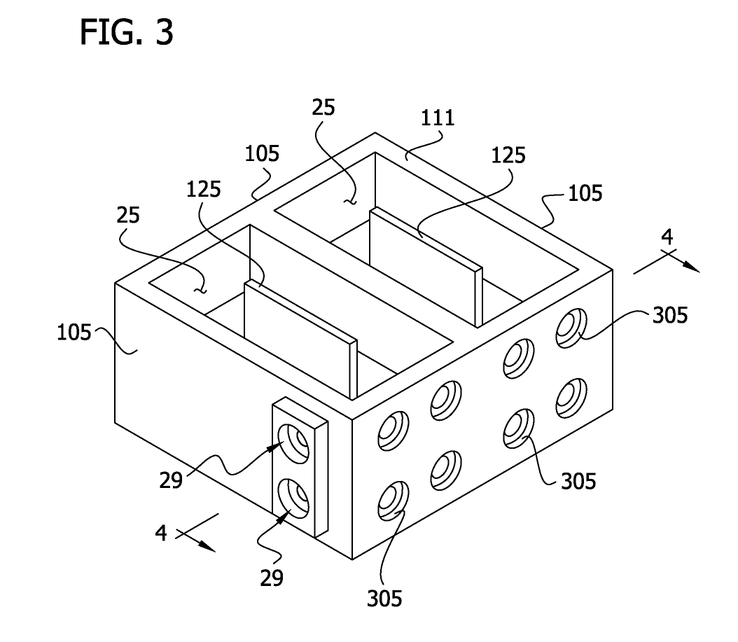

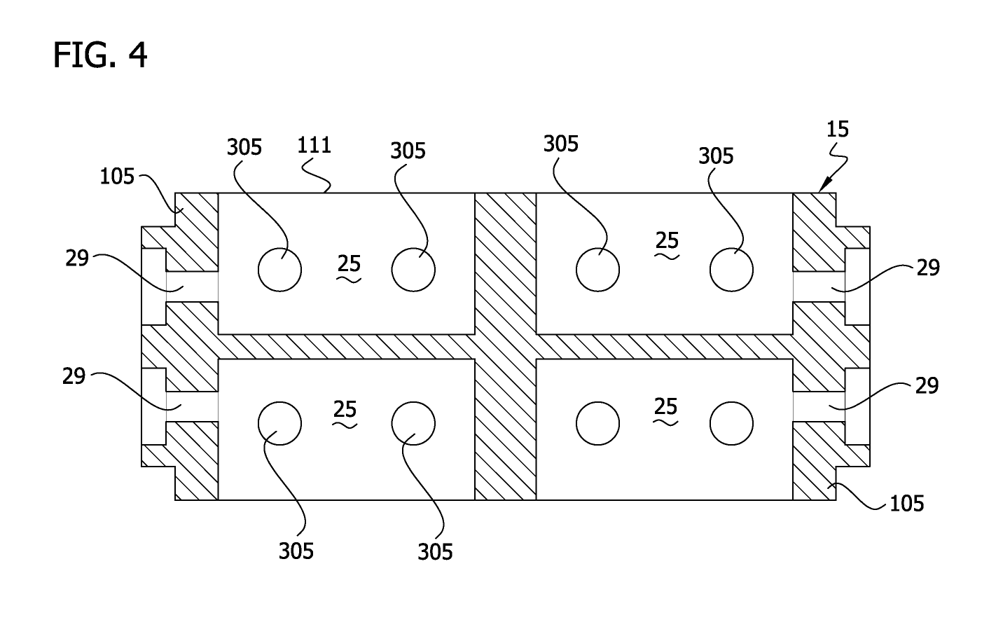

More specifically, as shown in FIGS. 3 and 4, the fuel manifold 15 of the illustrated embodiment comprises a body or block 101 of suitable dielectric material (e.g., acrylic) having side walls 105, a front face 111 and a back face 115. The block 101 is formed (e.g., molded, machined, etc.) to have any suitable shape (e.g., rectangular or otherwise) and is preferably constructed from a single one-piece member. Alternatively, it may be constructed from a number of separate members affixed to one another to form a unitary structure. The fuel reservoirs 25 are defined by cavities (also designated 25) in the front and back faces 111, 115 of the block. In the illustrated embodiment, two such cavities 25 are provided in the front face and two such cavities are provided in the back face, for a total of four cavities forming four fuel reservoirs. In other embodiments, the fuel reservoir housing 15 can contain from one fuel reservoir to up to 40 or more fuel reservoirs depending on the design and the number of biofuel cells needed in the assembly. Fuel enters each fuel reservoir 25 through a respective inlet 29 in a side wall 105 of the reservoir. A partition 125 is provided in each reservoir 25 for to provide structural support and improved cell compression.

The inlet 29 of each fuel reservoir 25 comprises an inlet passage (also designated 29) through a respective side wall 105 of the manifold 15. The inlet 29 is closed by a removable closure 121 (FIG. 2) threaded in the inlet passage. The closure 121 is easily removed to fill (or refill) the reservoir 25 and then readily replaced to seal the inlet passage closed. Other inlet arrangements are possible.

In the illustrated embodiment, the fuel reservoirs 25 in the manifold 15 are arranged such that the fuel reservoirs on the back side 23 of the manifold are directly opposite the reservoirs at the front side 21 of the manifold. However, other arrangements are possible.

### Anode-Cathode Assemblies

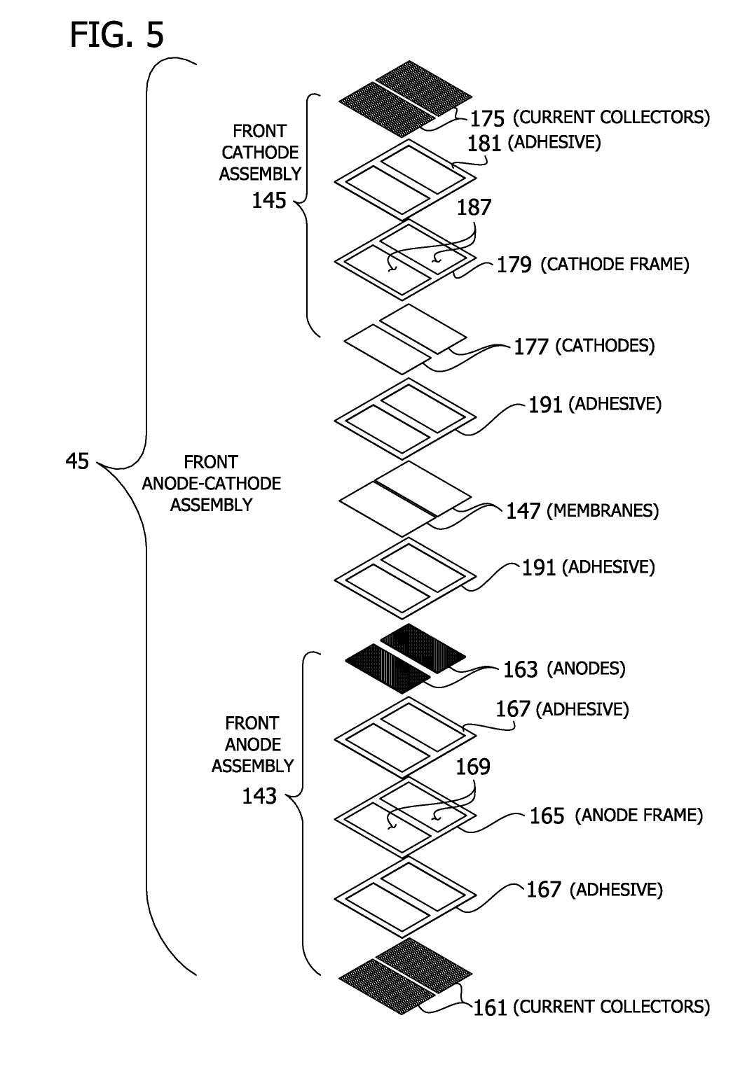

Referring to FIGS. 2, 5 and 6, the front anode-cathode assembly or stack 45 includes a number of front anode assemblies 143 and a matching number of front cathode assemblies 145, one anode assembly and one cathode assembly for each fuel reservoir 25 at the front side of the manifold 15. In the specific embodiment of FIGS. 2 and 5, there are two front anode assemblies and two front cathode assemblies, one anode assembly and one cathode assembly for each of the two front fuel reservoirs. The front stack also includes an anion exchange member 147 disposed between each front anode assembly and corresponding front cathode assembly.

Similarly, the back anode-cathode assembly or stack 47 includes a number of back anode assemblies 155 and a number of back cathode assemblies 157, one anode assembly and one cathode assembly for each fuel reservoir 25 at the back side of the manifold 15. In the specific embodiment of FIGS. 2 and 5, there are two back anode assemblies and two back cathode assemblies, one anode assembly and one cathode assembly for each of the two back fuel reservoirs. The back stack also includes an anion exchange member 159 disposed between each back anode assembly and corresponding back cathode assembly.

Each front anode assembly 143 comprises a current collector 161, an anode 163, an anode frame 165 for holding the anode, and a number of adhesive layers 167 for securing the anode components to one another. In one embodiment, the current collector 161 comprises a wire mesh (expanded metal) panel of nickel having a thickness of about 0.007 in. A suitable electrical lead 169 (e.g., a 0.125 in. wide and 0.003 in. thick nickel shim) affixed to the collector 161 is connected to a contact pin 171 mounted in a wall of the manifold 15. The anode 163 comprises a layer of nickel foam having a thickness of about 0.060 in., for example, coated with a layer of anode ink formulation. One suitable formulation comprises a mixture of 0.1 g 50% PtRu nominally on high surface area carbon, 0.2 mL 18 M-ohm deionized water, and 0.2 mL 5% Nafion solution. The anode frame 165 has an opening 169 for receiving the anode 163, the opening having a size and shape generally corresponding to the respective front fuel reservoir 25. The anode 163 and current collector 161 are sized slightly larger than the frame opening 169 so that the edge margins of the anode and collector overlap corresponding portions of the frame on opposite faces of the frame. In one embodiment the frame comprises a layer of polyetherimide (PEI) having a thickness of about 0.01 in. but other materials can be used. The adhesive layers 167 comprise a urethane hot melt adhesive film having a thickness of about 0.005 in., for example. The layers 167 are configured to have a size and shape generally corresponding to the size and shape of the frame 165. When heat is applied to the assembly (as by a hot press procedure), the adhesive melts to secure the components of the front anode assembly to one another to form a unitary front anode structure.

Each front cathode assembly 145 comprises a current collector 175, a biocathode 177, a cathode frame 179 for holding the biocathode, and a number of adhesive layers 181 for securing the cathode components to one another. In one embodiment, the current collector 175 comprises a wire mesh (expanded metal) panel of nickel having a thickness of about 0.007 in. A suitable electrical lead or conductor 183 (e.g., a 0.125 in. wide and 0.003 in. thick nickel shim) affixed to the collector 175 is connected to a contact pin 185 in a wall of the manifold. The biocathode 177 comprises a layer of double-sided carbon cloth ELAT coated on the side facing the membrane with a cathode ink formulation. One suitable formulation comprises a mixture of 1 g Printex 95 carbon black, 166 mg Laccase, 7.0 mL 0.5M Phosphate buffer solution at pH 7.2, and 1.33 mL of 15% tetrabutylammonium bromide modified Nafion

The cathode frame 179 has an opening 187 for receiving the biocathode 177, the opening 187 having a size and shape generally corresponding to the respective front fuel reservoir 25. The biocathode 177 and current collector 175 are sized slightly larger than the frame opening 187 so that the edge margins of the anode and collector overlap corresponding portions of the frame on opposite faces of the frame. In one embodiment the frame 179 comprises a layer of polyetherimide (PEI) having a thickness of about 0.01 in. but other materials can be used. The adhesive layers 181 comprise a urethane hot melt adhesive film having a thickness of about 0.005 in., for example. The layers 181 are configured to have a size and shape generally corresponding to the size and shape of the frame 179. When heat is applied to the assembly (as by a hot press procedure), the adhesive melts to secure the components of the front cathode assembly to one another to form a unitary front cathode structure.

In one embodiment, the anion exchange membrane 147 comprises a layer of polysulfone-zirconium oxide soaked in potassium hydroxide. Other transition metal oxides may be used, as well as other polymers such as polycarbonate as long as they possess desirable mechanical and processing properties. The membrane 147 is secured by layers 191 of adhesive, for example, to the anode 163 and biocathode 177.

The front anode-cathode assembly or stack 45 is secured to the front face 111 of the manifold 15 so that the anodes 163, biocathodes 177 and frame openings 167, 187 are in general alignment with respective front fuel reservoirs 25, the arrangement being such that fuel fluid in each reservoir 25 is adapted to contact a respective anode 163 of the front anode assembly 143. Desirably, the size and shape of the outline of each frame opening 167, 187 approximates the size and shape of the corresponding fuel reservoir 25 so that substantially the entire area of the anode 163 is exposed to fuel fluid from the fuel reservoir. The anode-cathode assembly or stack 45 is secured in a sealing manner to the manifold 15 by a layer of adhesive (e.g., a layer of 0.005 in. thick hot melt urethane adhesive melted at 128 degrees C.) between the back face of the current collector and the PEI frame 161 and the front face 111 of the manifold 15. In this manner, a seal is provided which isolates each front fuel reservoir 25 and its respective anode 163 from each adjacent front fuel reservoir and its respective anode 163. The seal may be formed in other ways, as by the use of one or more gaskets with external mechanical fasteners, or with heat adhesive and no gasketing (the heat adhesive acts as the gasket).

The back anode-cathode assembly or stack 47 is desirably constructed in a manner substantially identical to the front anode-cathode assembly or stack 45, and corresponding parts are identified by corresponding reference numbers. The back stack 47 is positioned against the back face 115 of the manifold 15 with the anodes 163 in registration with the fuel reservoirs 25 at the back side 23 of the manifold. The back anode-cathode assembly 47 is secured in position with respect to the manifold 15 and in sealing engagement with the back face 115 of the manifold in the same manner described above in regard to the front anode-cathode assembly 45.

In one particular embodiment, the perimeter size and shape of the manifold 15, fuel reservoirs 25, and front and back stacks 45, 47 are substantially the same so that these components can be stacked or layered to form a compact unitary structure as shown in FIG. 2 for placement in the housing 91. The size of the structure will vary depending on the number of fuel cells “stacked” together. (Each fuel cell comprises a fuel reservoir 25 and an anode-cathode assembly 45 or 47.) By way of example, a fuel cell device 1 having a stack of four cells, as shown in FIGS. 1-6 may have the following dimensions: 3.75″×2.5″×1.5″ (approximately 9.5 cm×6.4 cm×3.8 cm). In the design of this invention, any number of fuel cells can be readily stacked together to form a compact unit.

### Alternative Biocathode Materials

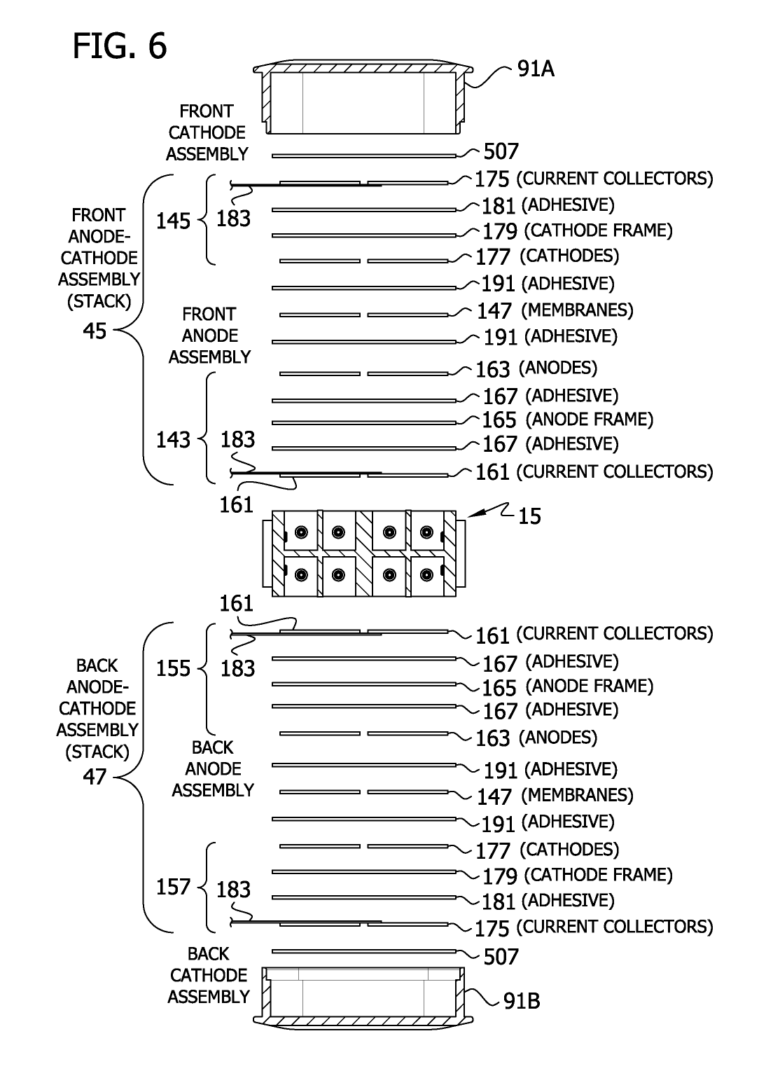

The biocathode in accordance with this invention comprises a current collector 175 and a biocathode 177 shown in FIGS. 5 and 6. The biocathode 177 comprises an electron conductor, optionally an electron mediator, optionally an electrocatalyst for the electron mediator, and an enzyme that is immobilized in an enzyme immobilization material. In various preferred embodiments, the biocathode 177 comprises an electron conductor, and an enzyme that is immobilized in an enzyme immobilization material. Preferably, these components are adjacent to one another, meaning they are physically or chemically connected by appropriate means.

### 1. Current Collector

The current collector 175 is a substance that conducts electrons and provides a lattice support for the electron conductor and catalyst layer. Thus, materials that provide these functions can be used for the current collector. For various biocathode embodiments, a nickel or nickel containing material (i.e., Inconel) is preferred.

### 2. Electron Conductor

The electron conductor is a substance that conducts electrons. The electron conductor can be organic or inorganic in nature as long as it is able to conduct electrons through the material. The electron conductor can be a carbon-based material, stainless steel, stainless steel mesh, a metallic conductor, a semiconductor, a metal oxide, a modified conductor, or combinations thereof. In preferred embodiments, the electron conductor is a carbon-based material for the biocathode.

Particularly suitable electron conductors are carbon-based materials. Exemplary carbon-based materials are carbon cloth, carbon paper, carbon screen printed electrodes, carbon paper (Toray), carbon paper (ELAT), carbon black (Vulcan XC-72, E-tek), carbon black, carbon powder, carbon fiber, single-walled carbon nanotubes, double-walled carbon nanotubes, multi-walled carbon nanotubes, carbon nanotubes arrays, diamond-coated conductors, glassy carbon, mesoporous carbon, and combinations thereof. In addition, other exemplary carbon-based materials are graphite, uncompressed graphite worms, delaminated purified flake graphite (Superior® graphite), high performance graphite and carbon powders (Formula BT™, Superior® graphite), highly ordered pyrolytic graphite, pyrolytic graphite, polycrystalline graphite, and combinations thereof. A preferred electron conductor is a sheet of carbon cloth.

In a further embodiment, the electron conductor can be made of a metallic conductor. Suitable electron conductors can be prepared from gold, platinum, iron, nickel, copper, silver, stainless steel, mercury, tungsten, other metals suitable for electrode construction, and combinations thereof. In addition, electron conductors which are metallic conductors can be constructed of nanoparticles made of cobalt, carbon, and other suitable metals. Other metallic electron conductors can be silver-plated nickel screen printed electrodes. In preferred embodiments, the electron conductor can be metal foams, frits, felts, screens, expanded metal packages, or combinations thereof.

In addition, the electron conductor can be a semiconductor. Suitable semiconductor materials include silicon and germanium, which can be doped with other elements. The semiconductors can be doped with phosphorus, boron, gallium, arsenic, indium or antimony, or a combination thereof.

Additionally, the electron conductor can be a metal oxide, metal sulfide, main group compound (i.e., transition metal compound), a material modified with an electron conductor, and combinations thereof. An exemplary electron conductor of this type is nanoporous titanium oxide, tin oxide coated glass, cerium oxide particles, molybdenum sulfide, boron nitride nanotubes, aerogels modified with a conductive material such as carbon, solgels modified with conductive material such as carbon, ruthenium carbon aerogels, mesoporous silicas modified with a conductive material such as carbon, and combinations thereof.

### 3. Catalyst

An enzyme is used as the catalyst in the biocathode and it should be capable of reducing an oxidant at the biocathode. Generally, naturally-occurring enzymes, man-made enzymes, artificial enzymes and modified naturally-occurring enzymes can be utilized. In addition, engineered enzymes that have been engineered by natural or directed evolution can be used. Stated another way, an organic or inorganic molecule that mimics an enzyme's properties can be used in an embodiment of the present invention. In various preferred embodiments, the enzyme is bilirubin oxidase, laccase, superoxide dismutase, peroxidase, or combinations thereof. Preferably, the enzyme comprises laccase.

Various cocatalysts can be added to the biocathode to enhance performance. For example, metal compounds having various advantageous reduction potentials can be added to the biocathode catalyst preparation. These metal compounds can be copper phthalocyanine, iron phthalocyanine, nickel phthalocyanine, cobalt pthalocyanine, various other transition metal phthalocyanines, or a combination thereof. The combination of cocatalysts (total metal phthalocyanine weight) are typically present in the biocathode in an amount from about 0.1 mg/cm² to about 1 mg/cm². When a combination of cocatalysts is used in the biocathode, the ratios of the cocatalysts (laccase:total metal phthalocyanines) to one another are from about 1:4 to about 1:1. The ratio of individual metal phthalocyanines to one another is generally a 1:1 ratio in either moles or weight. In various preferred embodiments, the biocathode catalyst comprises laccase, copper phthalocyanine, iron phthalocyanine, nickel phthalocyanine, and cobalt pthalocyanine

### 4. Enzyme Immobilization Material

For purposes of the present invention, an enzyme is “stabilized” if it either: (1) retains at least about 15% of its initial catalytic activity for at least about 30 days when continuously catalyzing a chemical transformation at room temperature; (2) retains at least about 15% of its initial catalytic activity for at least about 5 days when continuously catalyzing a chemical transformation at room temperature; (3) retains at least about 15% of its initial catalytic activity for at least about 5 days when continuously catalyzing a chemical transformation from about 30° C. to about 100° C., (4) retains at least about 15% of its initial catalytic activity for at least about 5 days when continuously catalyzing a chemical transformation at room temperature and a pH from about 0 to about 13, (5) retains at least about 15% of its initial catalytic activity for at least about 5 days when continuously catalyzing a chemical transformation at room temperature in a non-polar solvent, an oil, an alcohol, acetonitrile, methylene chloride, tetrahydrofuran, toluene, xylene, or a high ion concentration. Typically, a free enzyme in solution loses its catalytic activity within a few hours to a few days, whereas a properly immobilized and stabilized enzyme can retain its catalytic activity for at least about 5 days to about 1095 days (3 years). Thus, the immobilization of the enzyme provides a significant advantage in stability. The retention of catalytic activity is defined as the enzyme having at least about 15% of its initial activity, which can be measured by a means that demonstrate enzyme-mediated generation of product such as chemiluminescence, electrochemical, mass spectrometry, spectrophotometric (i.e., UV-Vis), radiochemical, IR, NMR, gravimetric, titrimetric, or fluorescence assay wherein the intensity of the property is measured at an initial time. In various embodiments, the enzyme retains at least about 15% of its initial activity while the enzyme is continuously catalyzing a chemical transformation.

With respect to the stabilization of the enzyme, the enzyme immobilization material provides a chemical and/or mechanical barrier to prevent or impede enzyme denaturation. To this end, the enzyme immobilization material physically confines the enzyme, preventing the enzyme from unfolding. The process of unfolding an enzyme from a folded three-dimensional structure is one mechanism of enzyme denaturation.

In some embodiments, the enzyme immobilization material stabilizes the enzyme so that the enzyme retains its catalytic activity for at least about 5 days to about 730 days (2 years). In other embodiments, the immobilized enzyme retains at least about 75% of its initial catalytic activity for at least about 30, 45, 60, 75, 90, 105, 120, 150, 180, 210, 240, 270, 300, 330, 365, 400, 450, 500, 550, 600, 650, 700, 730, 800, 850, 900, 950, 1000, 1050, 1095 days or more. In some instances, the immobilized enzyme retains about 75% to about 95% of its initial catalytic activity for about 30 to about 1095 days, about 45 to about 1095 days, about 60 to about 1095 days, about 75 to about 1095 days, about 90 to about 1095 days, about 105 to about 1095 days, about 120 to about 1095 days, about 150 to about 1095 days, about 180 to about 1095 days, about 210 to about 1095 days, about 240 to about 1095 days, about 270 to about 1095 days, about 300 to about 1095 days, about 330 to about 1095 days, about 365 to about 1095 days, about 400 to about 1095 days, about 450 to about 1095 days, about 500 to about 1095 days, about 550 to about 1095 days, about 600 to about 1095 days, about 650 to about 1095 days, about 700 to about 1095 days, or about 730 to about 1095 days. In various embodiments, the immobilized enzyme retains at least about 15, 20, 25, 30, 35, 40, 45, 50, 55, 60, 65, 70, 75, 80, 85, 90 or 95% or more of its initial catalytic activity for at least about 5, 7, 10, 15, 20, 25, 30, 45, 60, 75, 90, 105, 120, 150, 180, 210, 240, 270, 300, 330, 365, 400, 450, 500, 550, 600, 650, 700, 730, 800, 850, 900, 950, 1000, 1050, 1095 days or more. In some instances, the immobilized enzyme retains about 15 to about 95%, about 20 to about 95%, about 25 to about 95%, about 30 to about 95%, about 35 to about 95%, about 40 to about 95%, about 45 to about 95%, about 50 to about 95%, about 55 to about 95%, about 60 to about 95%, about 65 to about 95%, about 70 to about 95%, about 75 to about 95%, about 80 to about 95%, about 85 to about 95%, or about 90 to about 95% of its initial catalytic activity for about 5 to about 1095 days, about 7 to about 1095 days, about 10 to about 1095 days, about 15 to about 1095 days, about 20 to about 1095 days, about 25 to about 1095 days, about 30 to about 1095 days, about 45 to about 1095 days, about 60 to about 1095 days, about 75 to about 1095 days, about 90 to about 1095 days, about 105 to about 1095 days, about 120 to about 1095 days, about 150 to about 1095 days, about 180 to about 1095 days, about 210 to about 1095 days, about 240 to about 1095 days, about 270 to about 1095 days, about 300 to about 1095 days, about 330 to about 1095 days, about 365 to about 1095 days, about 400 to about 1095 days, about 450 to about 1095 days, about 500 to about 1095 days, about 550 to about 1095 days, about 600 to about 1095 days, about 650 to about 1095 days, about 700 to about 1095 days, or about 730 to about 1095 days.

In various embodiments, an enzyme having greater temperature or pH stability may also retain at least about 75% of its initial catalytic activity for at least about 5 days when actively catalyzing a chemical transformation as described above.

In other embodiments, when exposed to a pH of less than about 2, less than about 3, less than about 4, or less than about 5, the stabilized enzyme retains at least about 15, 20, 25, 30, 35, 40, 45, 50, 55, 60, 65, 70, 75, 80, 85, 90 or 95% of its initial bioelectrocatalytic activity for at least about 5, 10, 15, 30, 40, 50, 60, 75, 90 days or more when continuously catalyzing a chemical transformation. In some instances, when exposed to a pH of less than about 2, less than about 3, less than about 4, or less than about 5, the stabilized enzyme retains about 15 to about 95%, about 20 to about 95%, about 25 to about 95%, about 30 to about 95%, about 35 to about 95%, about 40 to about 95%, about 45 to about 95%, about 50 to about 95%, about 55 to about 95%, about 60 to about 95%, about 65 to about 95%, about 70 to about 95%, about 75 to about 95%, about 80 to about 95%, about 85 to about 95%, or about 90 to about 95% of its initial bioelectrocatalytic activity for about 5 to 90 days, about 10 to 90 days, about 15 to 90 days, about 20 to 90 days, about 25 to 90 days, about 30 to 90 days, about 35 to 90 days, about 40 to 90 days, about 45 to 90 days, about 50 to 90 days, about 55 to 90 days, about 60 to 90 days, about 65 to 90 days, about 70 to 90 days, about 75 to 90 days, about 80 to 90 days, about 85 to 90 days when continuously catalyzing a chemical transformation. In some instances, when exposed to a pH of less than about 2, less than about 3, less than about 4, or less than about 5, the stabilized enzyme retains about 15 to about 95%, about 20 to about 95%, about 25 to about 95%, about 30 to about 95%, about 35 to about 95%, about 40 to about 95%, about 45 to about 95%, about 50 to about 95%, about 55 to about 95%, about 60 to about 95%, about 65 to about 95%, about 70 to about 95%, about 75 to about 95%, about 80 to about 95%, about 85 to about 95%, or about 90 to about 95% of its initial bioelectrocatalytic activity for at least about 5, 10, 15, 30, 40, 50, 60, 75, 90 days or more when continuously catalyzing a chemical transformation. In some instances, when exposed to a pH of greater than about 9, greater than about 10, greater than about 11, or greater than about 12, the stabilized enzyme retains about 15 to about 95%, about 20 to about 95%, about 25 to about 95%, about 30 to about 95%, about 35 to about 95%, about 40 to about 95%, about 45 to about 95%, about 50 to about 95%, about 55 to about 95%, about 60 to about 95%, about 65 to about 95%, about 70 to about 95%, about 75 to about 95%, about 80 to about 95%, about 85 to about 95%, or about 90 to about 95% of its initial bioelectrocatalytic activity for about 5 to 90 days, about 10 to 90 days, about 15 to 90 days, about 20 to 90 days, about 25 to 90 days, about 30 to 90 days, about 35 to 90 days, about 40 to 90 days, about 45 to 90 days, about 50 to 90 days, about 55 to 90 days, about 60 to 90 days, about 65 to 90 days, about 70 to 90 days, about 75 to 90 days, about 80 to 90 days, about 85 to 90 days when continuously catalyzing a chemical transformation.

In other embodiments, when exposed to an agent such as a nonpolar solvent, an oil, an alcohol, acetonitrile, a concentrated ionic solution, or combination thereof, the stabilized enzyme retains at least about 15, 20, 25, 30, 35, 40, 45, 50, 55, 60, 65, 70, 75, 80, 85, 90 or 95% of its initial bioelectrocatalytic activity for at least about 5, 10, 15, 30, 40, 50, 60, 75, 90 days or more when continuously catalyzing a chemical transformation. In some instances, when exposed to the agent, the stabilized enzyme retains about 10 to about 95%, about 15 to about 95%, about 20 to about 95%, about 25 to about 95%, about 30 to about 95%, about 35 to about 95%, about 40 to about 95%, about 45 to about 95%, about 50 to about 95%, about 55 to about 95%, about 60 to about 95%, about 65 to about 95%, about 70 to about 95%, about 75 to about 95%, about 80 to about 95%, about 85 to about 95%, or about 90 to about 95% of its initial bioelectrocatalytic activity for about 5 to 90 days, about 10 to 90 days, about 15 to 90 days, about 20 to 90 days, about 25 to 90 days, about 30 to 90 days, about 35 to 90 days, about 40 to 90 days, about 45 to 90 days, about 50 to 90 days, about 55 to 90 days, about 60 to 90 days, about 65 to 90 days, about 70 to 90 days, about 75 to 90 days, about 80 to 90 days, about 85 to 90 days when continuously catalyzing a chemical transformation. In these instances, the concentration of the agent can be from about 1 wt. % to about 95 wt. %, 5 wt. % to about 95 wt. %, 10 wt. % to about 95 wt. %, 15 wt. % to about 95 wt. %, 20 wt. % to about 95 wt. %, 30 wt. % to about 95 wt. %, 40 wt. % to about 95 wt. %, 50 wt. % to about 95 wt. %.

An immobilized enzyme is an enzyme that is physically confined in a certain region of the enzyme immobilization material while retaining its catalytic activity. There are a variety of methods for enzyme immobilization, including carrier-binding, cross-linking and entrapping. Carrier-binding is the binding of enzymes to water-insoluble carriers. Cross-linking is the intermolecular cross-linking of enzymes by bifunctional or multifunctional reagents. Entrapping is incorporating enzymes into the lattices of a semipermeable material. The particular method of enzyme immobilization is not critically important, so long as the enzyme immobilization material (1) immobilizes the enzyme, and (2) stabilizes the enzyme. In various embodiments, the enzyme immobilization material is also permeable to a compound smaller than the enzyme. An enzyme is adsorbed to an immobilization material when it adheres to the surface of the material by chemical or physical interactions. Further, an enzyme is immobilized by entrapment when the enzyme is contained within the immobilization material whether within a pocket of the material or not.

With reference to the immobilization material's permeability to various compounds that are smaller than an enzyme, the immobilization material allows the movement of a fuel fluid or oxidant compound through it so the compound can contact the enzyme. The immobilization material can be prepared in a manner such that it contains internal pores, micellar pockets, channels, openings or a combination thereof, which allow the movement of the compound throughout the immobilization material, but which constrain the enzyme to substantially the same space within the immobilization material. Such constraint allows the enzyme to retain its catalytic activity. In various preferred embodiments, the enzyme is confined to a space that is substantially the same size and shape as the enzyme, wherein the enzyme retains substantially all of its catalytic activity. The pores, micellar pockets, channels, or openings have physical dimensions that satisfy the above requirements and depend on the size and shape of the specific enzyme to be immobilized.

The enzyme is preferably located within a pore of the immobilization material and the compound travels in and out of the immobilization material through transport channels. The pores of the enzyme immobilization material can be from about 6 nm to about 30 nm, from about 10 nm to about 30 nm, from about 15 nm to about 30 nm, from about 20 nm to about 30 nm, from about 25 nm to about 30 nm, from about 6 nm to about 20 nm, or from about 10 nm to about 20 nm. The relative size of the pores and transport channels can be such that a pore is large enough to immobilize an enzyme, but the transport channels are too small for the enzyme to travel through them. Further, a transport channel preferably has a diameter of at least about 10 nm. In some embodiments, the pore diameter to transport channel diameter ratio is at least about 2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1 or more; the pore diameter to transport channel diameter ratio can be about 2:1 to about 10:1, about 2.5:1 to about 10:1, about 3:1 to about 10:1, about 3.5:1 to about 10:1, about 4:1 to about 10:1, about 4.5:1 to about 10:1, about 5:1 to about 10:1, about 5.5:1 to about 10:1, about 6:1 to about 10:1, about 6.5:1 to about 10:1, about 7:1 to about 10:1, about 7.5:1 to about 10:1, about 8:1 to about 10:1, about 8.5:1 to about 10:1, about 9:1 to about 10:1, or about 9.5:1 to about 10:1. In yet another embodiment, preferably, a transport channel has a diameter of at least about 2 nm and the pore diameter to transport channel diameter ratio is at least about 2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1 or more; the pore diameter to transport channel diameter ratio can be about 2:1 to about 10:1, about 2.5:1 to about 10:1, about 3:1 to about 10:1, about 3.5:1 to about 10:1, about 4:1 to about 10:1, about 4.5:1 to about 10:1, about 5:1 to about 10:1, about 5.5:1 to about 10:1, about 6:1 to about 10:1, about 6.5:1 to about 10:1, about 7:1 to about 10:1, about 7.5:1 to about 10:1, about 8:1 to about 10:1, about 8.5:1 to about 10:1, about 9:1 to about 10:1, or about 9.5:1 to about 10:1.

In some of these embodiments, the immobilization material has a micellar or inverted micellar structure. Generally, the molecules making up a micelle are amphipathic, meaning they contain a polar, hydrophilic group and a nonpolar, hydrophobic group. The molecules can aggregate to form a micelle, where the polar groups are on the surface of the aggregate and the hydrocarbon, nonpolar groups are sequestered inside the aggregate. Inverted micelles have the opposite orientation of polar groups and nonpolar groups. The amphipathic molecules making up the aggregate can be arranged in a variety of ways so long as the polar groups are in proximity to each other and the nonpolar groups are in proximity to each other. Also, the molecules can form a bilayer with the nonpolar groups pointing toward each other and the polar groups pointing away from each other. Alternatively, a bilayer can form wherein the polar groups can point toward each other in the bilayer, while the nonpolar groups point away from each other.

### Modified Nafion®

In one preferred embodiment, the micellar immobilization material is a modified perfluoro sulfonic acid-PTFE copolymer (or modified perfluorinated ion exchange polymer)(modified Nafion® or modified Flemion®) membrane. The perfluorinated ion exchange polymer membrane is modified with a hydrophobic cation that is larger than the ammonium (NH₄⁺) ion. The hydrophobic cation serves the dual function of (1) dictating the membrane's pore size and (2) acting as a chemical buffer to help maintain the pore's pH level, both of which stabilize the enzyme.

With regard to the first function of the hydrophobic cation, mixture-casting a perfluoro sulfonic acid-PTFE copolymer (or perfluorinated ion exchange polymer) with a hydrophobic cation to produce a modified perfluoro sulfonic acid-PTFE copolymer (or modified perfluorinated ion exchange polymer)(Nafion® or Flemion®) membrane provides an immobilization material wherein the pore size is dependent on the size of the hydrophobic cation. Accordingly, the larger the hydrophobic cation, the larger the pore size. This function of the hydrophobic cation allows the pore size to be made larger or smaller to fit a specific enzyme by varying the size of the hydrophobic cation.

Regarding the second function of the hydrophobic cation, the properties of the perfluoro sulfonic acid-PTFE copolymer (or perfluorinated ion exchange polymer) membrane are altered by exchanging the hydrophobic cation for protons as the counterion to the —SO₃⁻ groups on the perfluoro sulfonic acid-PTFE copolymer (or anions on the perfluorinated ion exchange polymer) membrane. This change in counterion provides a buffering effect on the pH because the hydrophobic cation has a much greater affinity for the —SO₃⁻ sites than protons do. This buffering effect of the membrane causes the pH of the pore to remain substantially unchanged with changing solution pH; stated another way, the pH of the pore resists changes in the solution's pH. In addition, the membrane provides a mechanical barrier, which further protects the immobilized enzymes.

In order to prepare a modified perfluoro sulfonic acid-PTFE copolymer (or perfluorinated ion exchange polymer) membrane, the first step is to cast a suspension of perfluoro sulfonic acid-PTFE copolymer (or perfluorinated ion exchange polymer), particularly Nafion®, with a solution of the hydrophobic cations to form a membrane. The excess hydrophobic cations and their salts are then extracted from the membrane, and the membrane is re-cast. Upon re-casting, the membrane contains the hydrophobic cations in association with the —SO₃⁻ sites of the perfluoro sulfonic acid-PTFE copolymer (or perfluorinated ion exchange polymer) membrane. Removal of the salts of the hydrophobic cation from the membrane results in a more stable and reproducible membrane; if they are not removed, the excess salts can become trapped in the pore or cause voids in the membrane.

In one embodiment, a modified Nafion® membrane is prepared by casting a suspension of Nafion® polymer with a solution of a salt of a hydrophobic cation such as quaternary ammonium bromide. Excess quaternary ammonium bromide or hydrogen bromide is removed from the membrane before it is re-cast to form the salt-extracted membrane. Salt extraction of membranes retains the presence of the quaternary ammonium cations at the sulfonic acid exchange sites, but eliminates complications from excess salt that may be trapped in the pore or may cause voids in the equilibrated membrane. The chemical and physical properties of the salt-extracted membranes have been characterized by voltammetry, ion exchange capacity measurements, and fluorescence microscopy before enzyme immobilization. Exemplary hydrophobic cations are ammonium-based cations, quaternary ammonium cations, alkyltrimethylammonium cations, alkyltriethylammonium cations, organic cations, phosphonium cations, triphenylphosphonium, pyridinium cations, imidazolium cations, hexadecylpyridinium, ethidium, viologens, methyl viologen, benzyl viologen, bis(triphenylphosphine)iminium, metal complexes, bipyridyl metal complexes, phenanthroline-based metal complexes, [Ru(bipyridine)₃]²⁺ and [Fe(phenanthroline)₃]³⁺.

In one preferred embodiment, the hydrophobic cations are ammonium-based cations. In particular, the hydrophobic cations are quaternary ammonium cations. In another embodiment, the quaternary ammonium cations are represented by Formula 1:

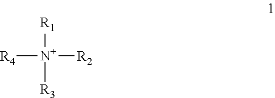

wherein R₁, R₂, R₃, and R₄ are independently hydrogen, hydrocarbyl, substituted hydrocarbyl, or heterocyclo wherein at least one of R₁, R₂, R₃, and R₄ is other than hydrogen. In a further embodiment, preferably, R₁, R₂, R₃, and R₄ are independently hydrogen, methyl, ethyl, propyl, butyl, pentyl, hexyl, heptyl, octyl, nonyl, decyl, undecyl, dodecyl, tridecyl or tetradecyl wherein at least one of R₁, R₂, R₃, and R₄ is other than hydrogen. In still another embodiment, R₁, R₂, R₃, and R₄ are the same and are methyl, ethyl, propyl, butyl, pentyl or hexyl. In yet another embodiment, preferably, R₁, R₂, R₃, and R₄ are butyl. In yet another embodiment, preferably, R₁, R₂, R₃, and R₄ are ethyl. Preferably, the quaternary ammonium cation is tetraethylammonium (T2A), tetrapropylammonium (T3A), tetrapentylammonium (T5A), tetrahexylammonium (T6A), tetraheptylammonium (T7A), trimethylicosylammonium (TMICA), trimethyloctyldecylammonium (TMODA), trimethylhexyldecylammonium (TMHDA), trimethyltetradecylammonium (TMTDA), trimethyloctylammonium (TMOA), trimethyldodecylammonium (TMDDA), trimethyldecylammonium (TMDA), trimethylhexylammonium (TMHA), tetrabutylammonium (TBA), triethylhexylammonium (TEHA), and combinations thereof.

### Hydrophobically Modified Polysaccharides

In other various embodiments, exemplary micellar or inverted micellar immobilization materials are hydrophobically modified polysaccharides, these polysaccharides are selected from chitosan, cellulose, chitin, starch, amylose, alginate, glycogen, and combinations thereof. In various embodiments, the micellar or inverted micellar immobilization materials are polycationic polymers, particularly, hydrophobically modified chitosan. Chitosan is a poly[β-(1-4)-2-amino-2-deoxy-D-glucopyranose]. Chitosan is typically prepared by deacetylation of chitin (a poly[β-(1-4)-2-acetamido-2-deoxy-D-glucopyranose]). The typical commercial chitosan has approximately 85% deacetylation. These deacetylated or free amine groups can be further functionalized with hydrocarbyl, particularly, alkyl groups. Thus, in various embodiments, the micellar hydrophobically modified chitosan corresponds to the structure of Formula 2

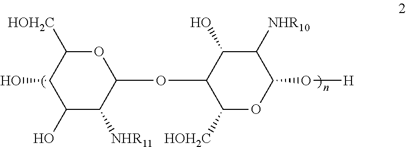

wherein n is an integer; R₁₀ is independently hydrogen, hydrocarbyl, substituted hydrocarbyl, or a hydrophobic redox mediator; and R₁₁ is independently hydrogen, hydrocarbyl, substituted hydrocarbyl, or a hydrophobic redox mediator. In certain embodiments of the invention, n is an integer that gives the polymer a molecular weight of from about 21,000 to about 4,000,000; from about 21,000 to about 500,000; preferably, from about 90,000 to about 500,000; more preferably, from about 150,000 to about 350,000; more preferably, from about 225,000 to about 275,000. In many embodiments, R₁₀ is independently hydrogen or alkyl and R₁₁ is independently hydrogen or alkyl. Further, R₁₀ is independently hydrogen or hexyl and R₁₁ is independently hydrogen or hexyl. Alternatively, R₁₀ is independently hydrogen or octyl and R₁₁ is independently hydrogen or octyl.

In other various embodiments, the micellar hydrophobically modified chitosan is a micellar hydrophobic redox mediator modified chitosan corresponding to Formula 2A

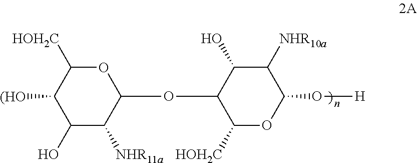

wherein n is an integer; R₁₀ₐ is independently hydrogen, or a hydrophobic redox mediator; and R₁₁ₐ is independently hydrogen, or a hydrophobic redox mediator.

Further, in various embodiments, the micellar hydrophobically modified chitosan is a modified chitosan or redox mediator modified chitosan corresponding to Formula 2B

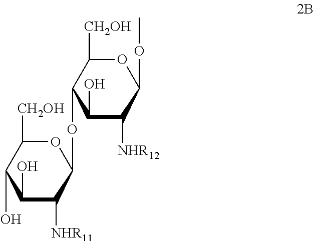

wherein R₁₁, R₁₂, and n are defined as in connection with Formula 2. In some embodiments, R₁₁ and R₁₂ are independently hydrogen or straight or branched alkyl; preferably, hydrogen, butyl, pentyl, hexyl, heptyl, octyl, nonyl, decyl, undecyl, or dodecyl. In various embodiments, R₁₁ and R₁₂ are independently hydrogen, butyl, or hexyl.

The micellar hydrophobically modified chitosans can be modified with hydrophobic groups to varying degrees. The degree of hydrophobic modification is determined by the percentage of free amine groups that are modified with hydrophobic groups as compared to the number of free amine groups in the unmodified chitosan. The degree of hydrophobic modification can be estimated from an acid-base titration and/or nuclear magnetic resonance (NMR), particularly ¹H NMR, data. This degree of hydrophobic modification can vary widely and is at least about 0.25, 0.5, 1, 2, 4, 6, 8, 10, 12, 14, 16, 18, 20, 25, 30, 32, 24, 26, 28, 40, 42, 44, 46, 48%, or more. Preferably, the degree of hydrophobic modification is from about 10% to about 45%; from about 10% to about 35%; from about 20% to about 35%; or from about 30% to about 35%.

In other various embodiments, the hydrophobic redox mediator of Formula 2A is a transition metal complex of osmium, ruthenium, iron, nickel, rhodium, rhenium, or cobalt with 1,10-phenanthroline (phen), 2,2′-bipyridine (bpy) or 2,2′,2″-terpyridine (terpy), methylene green, methylene blue, poly(methylene green), poly(methylene blue), luminol, nitro-fluorenone derivatives, azines, osmium phenanthrolinedione, catechol-pendant terpyridine, toluene blue, cresyl blue, nile blue, neutral red, phenazine derivatives, thionin, azure A, azure B, toluidine blue O, acetophenone, metallophthalocyanines, nile blue A, modified transition metal ligands, 1,10-phenanthroline-5,6-dione, 1,10-phenanthroline-5,6-diol, [Re(phen-dione)(CO)₃Cl], [Re(phen-dione)₃](PF₆)₂, poly(metallophthalocyanine), poly(thionine), quinones, diimines, diaminobenzenes, diaminopyridines, phenothiazine, phenoxazine, toluidine blue, brilliant cresyl blue, 3,4-dihydroxybenzaldehyde, poly(acrylic acid), poly(azure I), poly(nile blue A), polyaniline, polypyridine, polypyrole, polythiophene, poly(thieno[3,4-b]thiophene), poly(3-hexylthiophene), poly(3,4-ethylenedioxypyrrole), poly(isothianaphthene), poly(3,4-ethylenedioxythiophene), poly(difluoroacetylene), poly(4-dicyanomethylene-4H-cyclopenta[2,1-b;3,4-b′]dithiophene), poly(3-(4-fluorophenyl)thiophene), poly(neutral red), or combinations thereof.

Preferably, the hydrophobic redox mediator is Ru(phen)₃⁺², Fe(phen)₃⁺², Os(phen)₃⁺², Co(phen)₃⁺², Cr(phen)₃⁺², Ru(bpy)₃⁺², Os(bpy)₃⁺², Fe(bpy)₃⁺², Co(bpy)₃⁺², Cr(bpy)₃⁺², Os(terpy)₃⁺², Ru(bpy)₂(4-methyl-4′-(6-hexyl)-2,2′-bipyridine)⁺², Co(bpy)₂(4-methyl-4′-(6-hexyl)-2,2′-bipyridine)⁺², Cr(bpy)₂(4-methyl-4′-(6-hexyl)-2,2′-bipyridine)⁺², Fe(bpy)₂(4-methyl-4′-(6-hexyl)-2,2′-bipyridine)⁺², Os(bpy)₂(4-methyl-4′-(6-hexyl)-2,2′-bipyridine)⁺², or combinations thereof. More preferably, the hydrophobic redox mediator is Ru(bpy)₂(4-methyl-4′-(6-hexyl)-2,2′-bipyridine)⁺², Co(bpy)₂(4-methyl-4′-(6-hexyl)-2,2′-bipyridine)⁺², Cr(bpy)₂(4-methyl-4′-(6-hexyl)-2,2′-bipyridine)⁺², Fe(bpy)₂(4-methyl-4′-(6-hexyl)-2,2′-bipyridine)⁺², Os(bpy)₂(4-methyl-4′-(6-hexyl)-2,2′-bipyridine)⁺², or combinations thereof. In various preferred embodiments, the hydrophobic redox mediator is Ru(bpy)₂(4-methyl-4′-(6-hexyl)-2,2′-bipyridine)⁺².

For the immobilization material having a hydrophobic redox mediator as the modifier, the hydrophobic redox mediator is typically covalently bonded to the chitosan or polysaccharide backbone. Typically, in the case of chitosan, the hydrophobic redox mediator is covalently bonded to one of the amine functionalities of the chitosan through a —N—C— bond. In the case of metal complex redox mediators, the metal complex is attached to the chitosan through an —N—C— bond from a chitosan amine group to an alkyl group attached to one or more of the ligands of the metal complex. A structure corresponding to Formula 2C is an example of a metal complex attached to a chitosan

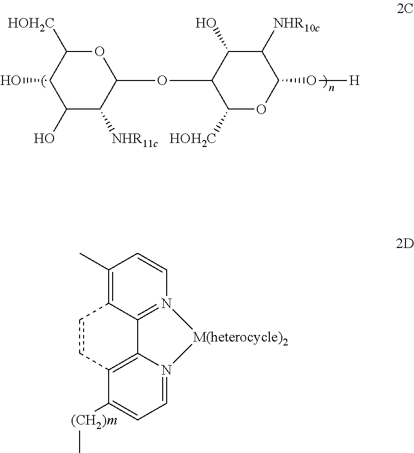

wherein n is an integer; R_{10c} is independently hydrogen or a structure corresponding to Formula 2D; R_{11c} is independently hydrogen or a structure corresponding to Formula 1D; m is an integer from 0 to 10; M is Ru, Os, Fe, Cr, or Co; and heterocycle is bipyridyl, substituted bipyridyl, phenanthroline, acetylacetone, and combinations thereof.

The hydrophobic group used to modify chitosan serves the dual function of (1) dictating the immobilization material's micelle size and (2) modifying the chitosan's electronic environment to maintain an acceptable micelle environment, both of which stabilize the enzyme. With regard to the first function of the hydrophobic group, hydrophobically modifying chitosan produces an immobilization material wherein the pore size is dependent on the size of the hydrophobic group. Accordingly, the size, shape, and extent of the modification of the chitosan with the hydrophobic group affects the size and shape of the micellar pore/pocket. This function of the hydrophobic group allows the micellar pore/pocket size to be made larger or smaller or a different shape to fit a specific enzyme by varying the size and branching of the hydrophobic group.

Regarding the second function of the hydrophobic cation, the properties of the hydrophobically modified chitosan membranes are altered by modifying chitosan with hydrophobic groups. This hydrophobic modification of chitosan affects the pore environment by increasing the number of available exchange sites to proton. In addition to affecting the pH of the material, the hydrophobic modification of chitosan provides a membrane that is a mechanical barrier, which further protects the immobilized enzymes.

Table 1 shows the number of available exchange sites to proton for the hydrophobically modified chitosan membrane.

TABLE 1
Number of available exchange sites to
proton per gram of chitosan polymer

| | Exchange sites per gram |
|---|---|
| Membrane | (×10⁻⁴ mol SO₃/g) |
| Chitosan | 10.5 ± 0.8 |
| Butyl Modified | 226 ± 21 |
| Hexyl Modified | 167 ± 45 |
| Octyl Modified | 529 ± 127 |
| Decyl Modified | 483 ± 110 |

Further, such polycationic polymers are capable of immobilizing enzymes and increasing the activity of enzymes immobilized therein as compared to the activity of the same enzyme in a buffer solution. In various embodiments, the polycationic polymers are hydrophobically modified polysaccharides, particularly, hydrophobically modified chitosan. For example, for the hydrophobic modifications noted, the enzyme activities for glucose oxidase were measured. The highest enzyme activity was observed for glucose oxidase in a hexyl modified chitosan suspended in t-amyl alcohol. These immobilization membranes showed a 2.53 fold increase in glucose oxidase enzyme activity over enzyme in buffer. Table 2 details the glucose oxidase activities for a variety of hydrophobically modified chitosans.

TABLE 2
Glucose oxidase enzyme activity for modified chitosans

| | Enzyme Activity |
|---|---|
| Membrane/Solvent | (Units/gm) |
| Buffer | 103.61 ± 3.15 |
| UNMODIFIED CHITOSAN | 214.86 ± 10.23 |
| HEXYL CHITOSAN | |
| Chloroform | 248.05 ± 12.62 |
| t-amyl alcohol | 263.05 ± 7.54 |
| 50% acetic acid | 118.98 ± 6.28 |
| DECYL CHITOSAN | |
| Chloroform | 237.05 ± 12.31 |
| t-amyl alcohol | 238.05 ± 10.02 |
| 50% acetic acid | 3.26 ± 2.82 |
| OCTYL CHITOSAN | |
| Chloroform | 232.93 ± 7.22 |
| t-amyl alcohol | 245.75 ± 9.77 |
| 50% acetic acid | 127.55 ± 11.98 |
| BUTYL CHITOSAN | |
| Chloroform | 219.15 ± 9.58 |
| t-amyl alcohol | 217.10 ± 6.55 |
| 50% acetic acid | 127.65 ± 3.02 |

To prepare the hydrophobically modified chitosans of the invention having an alkyl group as a modifier, a chitosan gel was suspended in acetic acid followed by addition of an alcohol solvent. To this chitosan gel was added an aldehyde (e.g., butanal, hexanal, octanal, or decanal), followed by addition of sodium cyanoborohydride. The resulting product was separated by vacuum filtration and washed with an alcohol solvent. The modified chitosan was then dried in a vacuum oven at 40° C. and resulted in a flaky white solid.

To prepare a hydrophobically modified chitosan of the invention having a redox mediator as a modifier, a redox mediator ligand was derivatized by contacting 4,4′-dimethyl-2,2′-bipyridine with lithium diisopropylamine followed by addition of a dihaloalkane to produce 4-methyl-4′-(6-haloalkyl)-2,2′-bipyridine. This ligand was then contacted with Ru(bipyridine)₂Cl₂ hydrate in the presence of an inorganic base and refluxed in a water-alcohol mixture until the Ru(bipyridine)₂Cl₂ was depleted. The product was then precipitated with ammonium hexafluorophosphate, or optionally a sodium or potassium perchlorate salt, followed by recrystallization. The derivatized redox mediator (Ru(bipyridine)₂(4-methyl-4′-(6-bromohexyl)-2,2′-bipyridine)⁺²) was then contacted with deacetylated chitosan and heated. The redox mediator modified chitosan was then precipitated and recrystallized.

The hydrophobically modified chitosan membranes have advantageous insolubility in ethanol. For example, the chitosan enzyme immobilization materials described above generally are functional to immobilize and stabilize the enzymes in solutions having up to greater than about 99 wt. % or 99 volume % ethanol. In various embodiments, the chitosan immobilization material is functional in solutions having 15, 20, 25, 30, 35, 40, 45, 50, 55, 60, 65, 70, 75, 80, 85, 90, 95 or more wt. % or volume % ethanol.

In other embodiments, the micellar or inverted micellar immobilization materials are polyanionic polymers, such as hydrophobically modified polysaccharides, particularly, hydrophobically modified alginate. Alginates are linear unbranched polymers containing β-(1-4)-linked D-mannuronic acid and α-(1-4)-linked L-guluronic acid residues. In the unprotonated form, β-(1-4)-linked D-mannuronic acid corresponds to the structure of Formula 3A

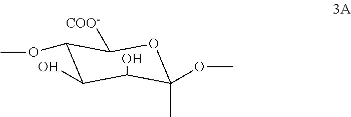

and in the unprotonated form, α-(1-4)-linked L-guluronic acid corresponds to the structure of Formula 3B(Note structures 3a and 3B could be made better by showing bonding to the C6 carboxylate to the carbon and, in 3A, bonding of C3 to the oxygen in the hydroxyl group.)

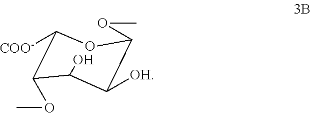

Alginate is a heterogeneous polymer consisting of polymer blocks of mannuronic acid residues and polymer blocks of guluronic acid residues.

Alginate polymers can be modified in various ways. One type is alginate modified with a hydrophobic cation that is larger than the ammonium (NH₄⁺) ion. The hydrophobic cation serves the dual function of (1) dictating the polymer's pore size and (2) acting as a chemical buffer to help maintain the micelle's pH level, both of which stabilize the enzyme. With regard to the first function of the hydrophobic cation, modifying alginate with a hydrophobic cation produces an immobilization material wherein the micelle size is dependent on the size of the hydrophobic cation. Accordingly, the size, shape, and extent of the modification of the alginate with the hydrophobic cation affects the size and shape of the micellar pore/pocket. This function of the hydrophobic cation allows the micelle size to be made larger or smaller or a different shape to fit a specific enzyme by varying the size and branching of the hydrophobic cation.

Regarding the second function of the hydrophobic cation, the properties of the alginate polymer are altered by exchanging the hydrophobic cation for protons as the counterion to the —CO₂⁻ groups on the alginate. This change in counterion provides a buffering effect on the pH because the hydrophobic cation has a much greater affinity for the —CO₂⁻ sites than protons do. This buffering effect of the alginate membrane causes the pH of the micellar pore/pocket to remain substantially unchanged with changing solution pH; stated another way, the pH of the pore resists changes in the solution's pH. In addition, the alginate membrane provides a mechanical barrier, which further protects the immobilized enzymes.

In order to prepare a modified alginate membrane, the first step is to cast a suspension of alginate polymer with a solution of the hydrophobic cation to form a membrane. The excess hydrophobic cations and their salts are then extracted from the membrane, and the membrane is re-cast. Upon re-casting, the membrane contains the hydrophobic cations in association with —CO₂⁻ sites of the alginate membrane. Removal of the salts of the hydrophobic cation from the membrane results in a more stable and reproducible membrane; if they are not removed, the excess salts can become trapped in the pore or cause voids in the membrane.

In one embodiment, a modified alginate membrane is prepared by casting a suspension of alginate polymer with a solution of a salt of a hydrophobic cation such as quaternary ammonium bromide. Excess quaternary ammonium bromide or hydrogen bromide is removed from the membrane before it is re-cast to form the salt-extracted membrane. Salt extraction of membranes retains the presence of the quaternary ammonium cations at the carboxylic acid exchange sites, but eliminates complications from excess salt that may be trapped in the pore or may cause voids in the equilibrated membrane. Exemplary hydrophobic cations are ammonium-based cations, quaternary ammonium cations, alkyltrimethylammonium cations, alkyltriethylammonium cations, organic cations, phosphonium cations, triphenylphosphonium, pyridinium cations, imidazolium cations, hexadecylpyridinium, ethidium, viologens, methyl viologen, benzyl viologen, bis(triphenylphosphine)iminium, metal complexes, bipyridyl metal complexes, phenanthroline-based metal complexes, [Ru(bipyridine)₃]²⁺ and [Fe(phenanthroline)₃]³⁺.

In one preferred embodiment, the hydrophobic cations are ammonium-based cations. In particular, the hydrophobic cations are quaternary ammonium cations. In another embodiment, the quaternary ammonium cations are represented by Formula 4:

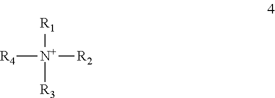

wherein R₁, R₂, R₃, and R₄ are independently hydrogen, hydrocarbyl, substituted hydrocarbyl, or heterocyclo wherein at least one of R₁, R₂, R₃, and R₄ is other than hydrogen. In a further embodiment, preferably, R₁, R₂, R₃, and R₄ are independently hydrogen, methyl, ethyl, propyl, butyl, pentyl, hexyl, heptyl, octyl, nonyl, decyl, undecyl, dodecyl, tridecyl or tetradecyl wherein at least one of R₁, R₂, R₃, and R₄ is other than hydrogen. In still another embodiment, R₁, R₂, R₃, and R₄ are the same and are methyl, ethyl, propyl, butyl, pentyl or hexyl. In yet another embodiment, preferably, R₁, R₂, R₃, and R₄ are butyl. In yet another embodiment, preferably, R₁, R₂, R₃, and R₄ are ethyl. Preferably, the quaternary ammonium cation is tetraethylammonium, tetrapropylammonium (T3A), tetrapentylammonium (T5A), tetrahexylammonium (T6A), tetraheptylammonium (T7A), trimethylicosylammonium (TMICA), trimethyloctyldecylammonium (TMODA), trimethylhexyldecylammonium (TMHDA), trimethyltetradecylammonium (TMTDA), trimethyloctylammonium (TMOA), trimethyldodecylammonium (TMDDA), trimethyldecylammonium (TMDA), trimethylhexylammonium (TMHA), tetrabutylammonium (TBA), triethylhexylammonium (TEHA), and combinations thereof.

The micelle characteristics were studied and the micellar pore/pocket structure of this membrane is ideal for enzyme immobilization, because the micellar pores/pockets are hydrophobic, micellar in structure, buffered to external pH change, and have high pore interconnectivity.

In another experiment, ultralow molecular weight alginate and dodecylamine were placed in 25% ethanol and refluxed to produce a dodecyl-modified alginate by amidation of the carboxylic acid groups. Various alkyl amines can be substituted for the dodecylamine to produce alkyl-modified alginate having a C₄-C₁₆ alkyl group attached to varying numbers of the reactive carboxylic acid groups of the alginate structure. In various embodiments, at least about 1, 2, 4, 6, 8, 10, 12, 14, 16, 18, 20, 22, 24, 26, 28, 30, 32, 34, 36, 38, 40, 42, 44, 46, 48%, or more of the carboxylic acid groups react with the alkylamine.

The hydrophobically modified alginate membranes have advantageous insolubility in ethanol. For example, the alginate enzyme immobilization materials described above generally are functional to immobilize and stabilize the enzymes in solutions having at least about 25 wt. % or 25 volume % ethanol. In various embodiments, the alginate immobilization material is functional in solutions having 25, 30, 35, 40, 45, 50, 55, 60, 65, 70, 75, 80, 85, 90 or more wt. % or volume % ethanol.

In order to evaluate the most advantageous immobilization material for a particular enzyme, the selected enzyme can be immobilized in various immobilization materials, deposited on an electron conductor, and treated with a solution containing an electron mediator (e.g., NAD⁺) and/or a substrate for the particular enzyme in a buffer solution. A fluorescence micrograph is obtained and shows fluorescence when the enzyme immobilized in the particular immobilization material is still a catalytically active enzyme after immobilization. Enzyme activity could also be determined by any standard spectroscopic assay. This is one way to determine whether a particular immobilization material will immobilize and stabilize an enzyme while retaining the enzyme's catalytic activity. For example, for starch-consuming amylase, the enzyme immobilization material that provided the greatest relative activity is provided by immobilization of the enzyme in butyl chitosan suspended in t-amyl alcohol. For maltose-consuming amylase, the greatest relative activity is provided by immobilization of the enzyme in medium molecular weight decyl modified chitosan.

One aspect of the present invention is directed to an enzyme immobilized by entrapment in a polymeric immobilization material, the immobilization material being permeable to a compound smaller than the enzyme and having the structure of either Formulae 5, 6, 7, or 10:

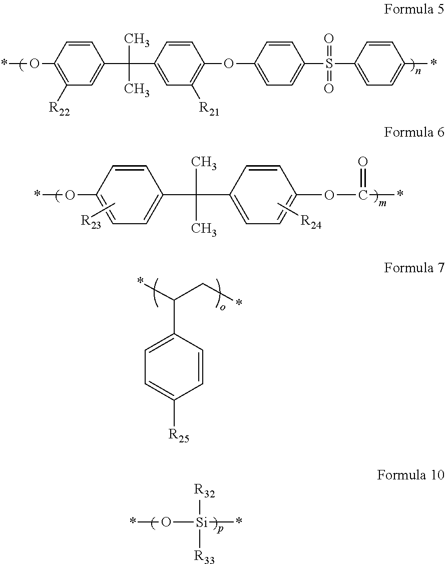

wherein R₂₁, R₂₂, R₂₃ and R₂₄ are independently hydrogen, alkyl, or substituted alkyl, provided that the average number of alkyl or substituted alkyl groups per repeat unit is at least 0.1; and R₂₅ is hydrogen or substituted alkyl, provided that the average number of substituted alkyl groups per repeat unit is at least 0.1; R₃₂ and R₃₃ are independently hydrogen, alkyl, aryl, or substituted alkyl, provided that the average number of hydrogen atoms per repeat unit is at least 0.1; and m, n, o, and p are independently integers of from about 10 to about 5000. In many of these embodiments, the enzyme immobilization material comprises a micellar or inverted micellar polymer.

### Modified Polysulfone

In some of the various embodiments, the immobilization material has a structure of Formula 5

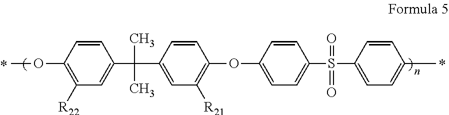

wherein R₂₁, R₂₂, and n are defined above. In various embodiments, R₂₁ and R₂₂ are independently hydrogen, alkyl, or substituted alkyl. In various embodiments, R₂₁ and R₂₂ are independently hydrogen or —(CH₂)ᵤN⁺R₂₆R₂₇R₂₈, wherein R₂₆, R₂₇, and R₂₈ are independently alkyl and u is an integer of 1, 2, or 3; particularly, R₂₆, R₂₇, and R₂₈ are independently methyl, ethyl, propyl, butyl, pentyl, or hexyl; more particularly, R₂₆, R₂₇, and R₂₈ are methyl.

Alternatively, R₂₁ and R₂₂ are independently hydrogen or —(CH₂)ᵤN⁺R₂₆R₂₇R₂₈, wherein R₂₆ and R₂₇ are independently methyl, ethyl, or propyl, R₂₈ is alkylamino, and u is an integer of 1, 2, or 3. When R₂₈ is alkylamino, preferred alkylamino groups are tertiary alkylamino groups. For example, the alkylamino group can be —CH₂N⁺R₂₉R₃₀R₃₁, —CH₂CH₂N⁺R₂₉R₃₀R₃₁ or —CH₂CH₂CH₂N⁺R₂₉R₃₀R₃₁ wherein R₂₉, R₃₀, and R₃₁ are independently hydrogen or alkyl. In various preferred embodiments, R₂₉, R₃₀, and R₃₁ are independently methyl, ethyl, propyl, butyl, pentyl, or hexyl; more particularly, R₂₉, R₃₀, and R₃₁ are methyl or ethyl.

Preferably, R₂₁, R₂₂, or R₂₁ and R₂₂ are alkyl or substituted alkyl wherein the average number of alkyl or substituted alkyl groups per repeat unit is from 0.1 to about 1.4, from about 0.2 to about 1.4, from about 0.3 to about 1.4, from about 0.3 to about 1.2, from about 0.3 to about 1, from about 0.3 to about 0.8, from about 0.4 to about 1.4, from about 0.4 to about 1.2, from about 0.4 to about 1, from about 0.4 to about 0.8, from about 0.5 to about 1.4, from about 0.5 to about 1.2, from about 0.5 to about 1, from about 0.5 to about 0.8.

In other preferred embodiments, R₂₁ and R₂₂ are independently hydrogen or —(CH₂)_{q}-polyether wherein q is an integer of 1, 2, or 3. In preferred embodiments, q is 1. In some of the preferred embodiments, R₂₁ and R₂₂ are independently hydrogen, —CH₂—O—(CH₂—CH₂—O)_{z}—Rₜ, —CH₂—O—(CH₂(CH₃)—CH₂—O)_{z}—Rₜ, or a combination thereof wherein z is an integer and the polyethylene oxide or polypropylene oxide (e.g., —O—(CH₂—CH₂—O)_{z}—Rₜ or —CH₂—O—(CH₂(CH₃)—CH₂—O)_{z}—Rₜ wherein Rₜ is hydrogen, alkyl, substituted alkyl, aryl, or substituted aryl) has a molecular weight from about 150 Daltons (Da) to about 8000 Daltons (Da). In particular embodiments, the polyethylene oxide has a molecular weight from about 500 Da to about 600 Da; particularly about 550 Da. In various embodiments, Rₜ is methyl.

Modified polysulfone is a desirable immobilization material because it has good chemical and thermal stability. Additionally, modified polysulfone has advantageous solubility characteristics in polar organic solvents such as N-methylpyrrolidone (NMP) and dioxane. This solubility enables the modified polysulfone beads to be prepared by precipitation in water or lower aliphatic alcohols. Unmodified polysulfone can immobilize and retain an enzyme (e.g., carbonic anhydrase) in the beads. But, the activity of the carbonic anhydrase is reduced and it is hypothesized that the low porosity and thus, the low permeability of unmodified polysulfone beads at the polymer-solvent interface prevents the substrate and product from diffusing to and from the active site of the enzyme. In order to improve the porosity, the polysulfone can be modified to increase the porosity and transport of the substrate and product through the material.

For example, the polysulfone can be modified by adding amine groups to the benzene groups of the polysulfone. By modifying the polysulfone with quaternary amine groups, the hydrophilicity of the polysulfone is affected and in turn the porosity and the transport of carbonate/bicarbonate ions should be increased. Also, the positively charged amine groups can stabilize carbonic anhydrase through electrostatic interactions. This modification of adding a hydrophobic group to a hydrophilic polymer may also form micellar aggregate/pore structures in the polymer. To add amine groups to the polysulfone, the benzene rings of the backbone are chloromethylated followed by the amination of the chloromethyl groups. This process is generally described in Jihua, H.; Wentong, W.; Puchen, Y.; Qingshuang, Z. Desalination 1991, 83, 361 and Park, J.-S.; Park, G.-G.; Park, S.-H.; Yoon, Y.-G.; Kim, C. S.; Lee, W. Y. Macromol. Symp. 2007, 249-250, 174. The general reaction scheme for this transformation is shown in Scheme 1. The average number of chloromethyl groups added per repeat unit can be controlled by manipulating the reactant ratios during the first step as described in Hibbs, M. R.; Hickner, M. A.; Alam, T. M.; McIntyre, S. K.; Fujimoto, C. H.; Cornelius, C. J. Chem. Mater. 2008, 20, 2566.

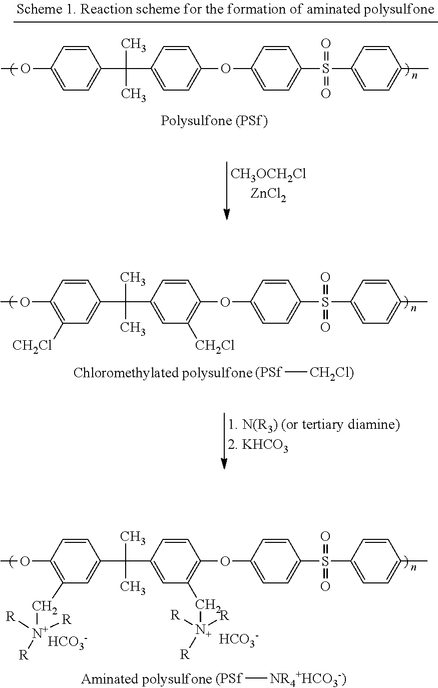

Additionally, the choice of tertiary amine added to the chloromethylated polysulfone (PSf-CH₂Cl) can affect the polysulfone properties. For instance, trimethyl amine can be used to aminate PSf-CH₂Cl, resulting in a quaternary benzyl trimethyl ammonium cation. This benzyl trimethyl ammonium cation has been shown to be more stable with prolonged exposure to elevated temperatures and/or strongly basic solutions. (See Sata, T.; Tsujimoto, M.; Yamaguchi, T.; Matsusaki, K. J. Membrane Sci. 1996, 112, 161.) Tertiary diamines can also be used in this amination step, providing a way of crosslinking polysulfone to improve its mechanical and thermal stability. The addition of diamines to chloromethylated polysulfone solutions crosslinks polysulfone and solidifies the mixture. The solvent can then be exchanged with water or methanol to yield a more porous aminated polysulfone. The initial polymer concentration of the solution can be adjusted to manipulate the porosity in the resulting polysulfone. The exchange of the chloride anions with bicarbonate anions after amination could improve the performance of the immobilized carbonic anhydrase by removing chloride ions that inhibit enzyme activity. Additionally, the incorporation of bicarbonate ions into polysulfone could provide a buffering capacity to protect the enzyme from pH changes.

Further, once the polysulfone is chloromethylated, other modified polysulfone polymers can be prepared. For example, the chloromethyl groups can react with a hydroxyl end group of poly(ethylene oxide) (PEO) to create polysulfone polymers with grafted PEO side chains. (See Park, J. Y.; Acar, M. H.; Akthakul, A.; Kuhlman, W.; Mayes, A. M. Biomater. 2006, 27, 856.) The general reaction scheme is shown in Scheme 2. As described above, the chloromethylation of polysulfone can be manipulated to provide control over the grafting density of the PEO side chains. Additionally, the molecular weight of the PEO side chains can be altered to influence the overall weight loading of PEO in PEO-modified polysulfone; the loading affects the overall mechanical properties of the polymer.

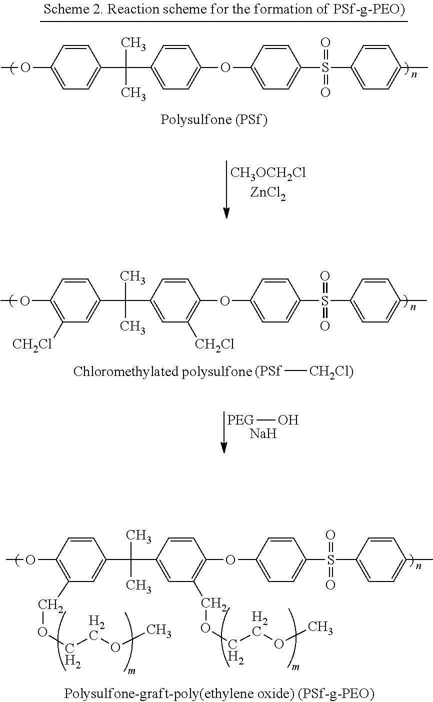

The incorporation of PEO into polysulfone will improve the hydrophilicity of these beads and the transport of carbonate/bicarbonate ions. Additionally, when polyethylene glycol-modified carbonic anhydrase is the enzyme, the PEO-modified polysulfone can provide a hydrophilic PEO layer around the carbonic anhydrase and further prevent the enzyme from leaching. The PEO encapsulation of carbonic anhydrase can also protect the enzyme from effects of drying that may be important for retaining its activity upon immobilization.

Additionally, particular processing conditions can also improve the porosity and the ion transport of the polymers. For instance, it is possible to foam polysulfone through the use of supercritical carbon dioxide to introduce microporous structure into polysulfone polymers. (See Krause, B.; Mettinkhof, R.; van der Vegt, N. F. A.; Wessling, M. Macromolecules 2001, 34, 874.) A similar approach could be used to enable the foaming of modified polysulfone beads. Microporosity can also be introduced into polysulfone by using a freeze-drying process similar to the process used to create microporous chitosan. (See Cooney, M. J.; Lau, C.; Windmeisser, M.; Liaw, B. Y.; Klotzbach, T.; Minteer, S. D. J. Mater. Chem. 2008, 18, 667.) Since polysulfone is not soluble in a water/acetic acid mixture, a suitable solvent for polysulfone that is capable of appreciable sublimation in its solid state under vacuum is required. Menthol is a promising candidate due to its low melting temperature (35° C.) and comparable solubility parameter to dioxane, which suggests that polysulfone could dissolve at high concentrations in menthol at slightly elevated temperatures.

### Modified Polycarbonate

In certain embodiments, the immobilization material has a structure of Formula

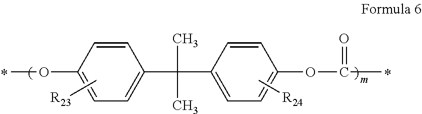

wherein R₂₃, R₂₄, and m are defined above. In various embodiments, R₂₃ and R₂₄ are independently hydrogen, alkyl, or substituted alkyl. In various embodiments, R₂₃ and R₂₄ are independently hydrogen or —(CH₂)ᵤN⁺R₂₆R₂₇R₂₈, wherein R₂₆, R₂₇, and R₂₈ are independently alkyl and u is an integer of 1, 2, or 3; particularly, R₂₆, R₂₇, and R₂₈ are independently methyl, ethyl, propyl, butyl, pentyl, or hexyl; more particularly, R₂₆, R₂₇, and R₂₈ are methyl.

Alternatively, R₂₃ and R₂₄ are independently hydrogen or —(CH₂)ᵤN⁺R₂₆R₂₇R₂₈ wherein R₂₆ and R₂₇ are independently methyl, ethyl, or propyl, R₈ is alkylamino, and u is an integer of 1, 2, or 3. When R₂₈ is alkylamino, preferred alkylamino groups are tertiary alkylamino groups. For example, the alkylamino group can be —CH₂N⁺R₂₉R₃₀R₃₁, —CH₂CH₂N⁺R₂₉R₃₀R₃₁ or —CH₂CH₂CH₂N⁺R₂₉R₃₀R₃₁ wherein R₂₉, R₃₀, and R₃₁ are independently hydrogen or alkyl. In various preferred embodiments, R₂₉, R₃₀, and R₃₁ are independently methyl, ethyl, propyl, butyl, pentyl, or hexyl; more particularly, R₂₉, R₃₀, and R₃₁ are methyl or ethyl.

In other preferred embodiments, R₂₃ and R₂₄ are independently hydrogen or —(CH₂)_{q}-polyether wherein q is an integer of 1, 2, or 3. In some of the preferred embodiments, R₂₃ and R₂₄ are independently hydrogen, —CH₂—O—(CH₂—CH₂—O)_{z}—Rₜ, —CH₂—O—(CH₂(CH₃)—CH₂—O)_{z}—Rₜ, or a combination thereof wherein z is an integer and the polyethylene oxide or polypropylene oxide (e.g., —O—(CH₂—CH₂—O)_{z}—Rₜ or —CH₂—O—(CH₂(CH₃)—CH₂—O)_{z}—Rₜ wherein Rₜ is hydrogen, alkyl, substituted alkyl, aryl, or substituted aryl) has a molecular weight from about 150 Daltons (Da) to about 8000 Daltons (Da). In various embodiments, Rₜ is methyl.

Preferably, R₂₃, R₂₄, or R₂₃ and R₂₄ are alkyl or substituted alkyl wherein the average number of alkyl or substituted alkyl groups per repeat unit is from about 0.1 to about 1.4, from about 0.2 to about 1.4, from about 0.3 to about 1.4, from about 0.3 to about 1.2, from about 0.3 to about 1, from about 0.3 to about 0.8, from about 0.4 to about 1.4, from about 0.4 to about 1.2, from about 0.4 to about 1, from about 0.4 to about 0.8, from about 0.5 to about 1.4, from about 0.5 to about 1.2, from about 0.5 to about 1, from about 0.5 to about 0.8.

Polycarbonate has a structure similar to polysulfone. It also contains benzene rings in its backbone, so it can be functionalized by adding chloromethyl groups in the same manner as described above for polysulfone. These chloromethyl groups can then be aminated or have PEO grafted following the same procedure utilized for polysulfone. Schemes 3 and 4 show the general reaction schemes for both. Similar to polysulfone, polycarbonate can be foamed using supercritical carbon dioxide.

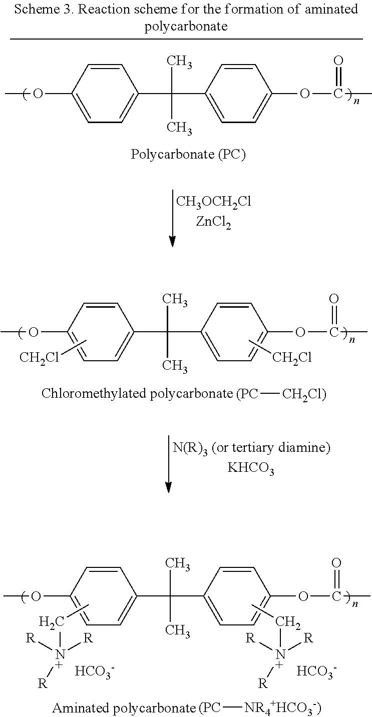

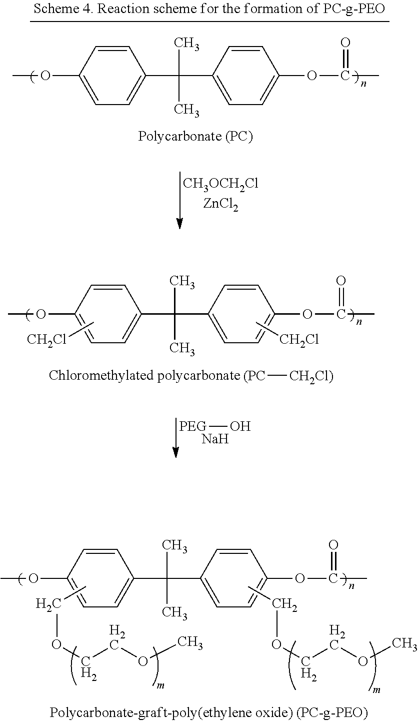

### Modified Poly(Vinylbenzyl Chloride)

In other embodiments, the immobilization material has a structure of Formula 7

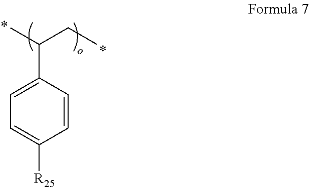

wherein R₂₅ and o are defined above. In various embodiments, R₂₅ is hydrogen, alkyl, or substituted alkyl. In various embodiments, R₂₅ is hydrogen or —(CH₂)_{q}N⁺R₂₆R₂₇R₂₈, wherein R₂₆, R₂₇, and R₂₈ are independently alkyl and q is an integer of 1, 2, or 3; particularly, R₂₆, R₂₇, and R₂₈ are independently methyl, ethyl, propyl, butyl, pentyl, or hexyl; more particularly, R₂₆, R₂₇, and R₂₈ are methyl.

Alternatively, R₂₅ is hydrogen or —(CH₂)ᵤN⁺R₂₆R₂₇R₂₈ wherein R₂₆ and R₂₇ are independently methyl, ethyl, or propyl, R₂₈ is alkylamino, and u is an integer of 1, 2, or 3. When R₂₈ is alkylamino, preferred alkylamino groups are tertiary alkylamino groups. For example, preferred alkylamino groups can be —CH₂N⁺R₂₉R₃₀R₃₁, —CH₂CH₂N⁺R₂₉R₃₀R₃₁ or —C₆H₄N⁺R₂₉R₃₀R₃₁ wherein R₂₉, R₃₀, and R₃₁ are independently hydrogen or alkyl. In various preferred embodiments, R₂₉, R₃₀, and R₃₁ are independently methyl, ethyl, propyl, butyl, pentyl, or hexyl; more particularly, R₂₉, R₃₀, and R₃₁ are methyl or ethyl.

Preferably, R₂₅ is substituted alkyl wherein the average number of substituted alkyl groups per repeat group is at least 0.1, 0.2, 0.3, 0.4, 0.5, 0.6, 0.7, or more.

Poly(vinylbenzyl chloride) (PVBC) is a commercially-available polymer with a chloromethyl group contained in the polymer, so it can be aminated similarly to the synthetic procedure described above for chloromethylated polysulfone or polycarbonate. PVBC, however, lacks the mechanical strength of polysulfone and polycarbonate and is somewhat brittle and has a lower glass transition temperature. However, it is believed that the mechanical and thermal stability of this polymer can be improved by crosslinking PVBC by amination with tertiary diamines. (See Varcoe, J. R.; Slade, R. C. T.; Lee, E. L. H. Chem. Commun. 2006, 1428.) This process incorporates positive charges in the PVBC and these charges can also stabilize the immobilized enzyme through electrostatic interactions. Scheme 5 shows the general scheme for this reaction.

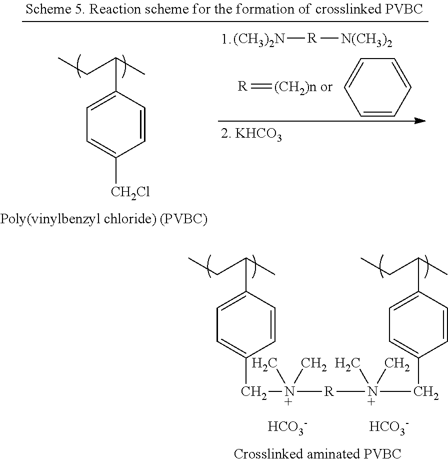

Upon addition of a diamine to a 40 wt. % solution of PVBC in NMP, both a methylene (—CH₂—) and a phenylene (—C₆H₄—) spacer in the diamine produces crosslinked solid films. Diamines having the following structures were selected because they provide long-term stability to these quaternary amines. The use of tetramethyl methanediamine (TMMDA) solidifies this solution quickly (e.g., less than 10 minutes), indicating that the reaction of TMMDA with PVBC is fast. Once solidified, PVBC crosslinked with TMMDA does not swell upon addition of methanol or water. In contrast, the reaction of tetramethyl phenylenediamine (TMPDA) is slower and takes several hours to solidify. Once solidified, PVBC crosslinked with TMPDA swells significantly (but maintains its original shape) upon exposure to either methanol or water. PVBC crosslinked with TMPDA forms a hydrogel material, which could significantly improve the transport of carbonate/bicarbonate ions through the polymer, as compared to polysulfone and polycarbonate that are rigid glassy polymers.

### Modified Polysiloxanes

In various embodiments, the immobilization material has a structure of Formula 10

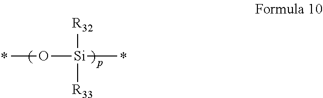

wherein R₃₂ and R₃₃ are independently hydrogen, alkyl, aryl, or substituted alkyl, provided that the average number of hydrogen atoms per repeat unit is at least 0.1.

In various embodiments, R₃₂ and R₃₃ are independently hydrogen, alkyl, aryl, -(substituted alkylene)-acid or a salt thereof, -(substituted alkylene)-base or a salt thereof, —(CH₂)ᵤO—(CH₂—CH₂—O)_{z}—CH₃, —(CH₂)ᵤ—O—(CH₂(CH₃)—CH₂—O)_{z}—CH₃, or a combination thereof, wherein u is an integer of 2, 3, or 4. The acid group can be a carboxylic, a phosphonic, a phosphoric, a sulfonic, a sulfuric, a sulfamate, a salt thereof, or a combination thereof. The base can be an amine base, particularly, a tertiary amine, a quaternary amine, a nitrogen heterocycle, a salt thereof, or a combination thereof. In particular embodiments, R₃₂ and R₃₃ are independently hydrogen, alkyl, aryl, —(CH₂)₃—O—((CH₂)₂—O—)_{z}CH₃, —(CH₂)₂—C(O)—O—(CH₂)₂-imidazolium, —(CH₂)₃—O—CH₂—CH(OH)—N(CH₃)—(CH₂)₂—SO₃Na.

The structure of Formula 8 is prepared starting with a hydrosiloxane, which is a polysiloxane that contains silicon hydride bonds. Examples include poly(methyl hydrosiloxane) (PMHS) homopolymer, poly(phenyl dimethylhydrosiloxy)siloxane (PPDMHS) homopolymer, and copolymers of PMHS or PPDMHS with other polysiloxanes such as poly(dimethylsiloxane) (PDMS) or poly(phenylmethylsiloxane) (PPMS). Specifically, polyalkyl hydrosiloxane (e.g., poly(methyl hydrosiloxane), poly(ethyl hydrosiloxane), poly(propyl hydrosiloxane), polyaryl hydrosiloxane (e.g., poly(phenyl hydrosiloxane), poly(tolyl hydrosiloxane)), poly(phenyl dimethylhydrosiloxy)siloxane, poly(dimethyl siloxane co-methyl hydrosiloxane), poly(methyl hydrosiloxane co-phenyl methyl siloxane), poly(methyl hydrosiloxane co-alkyl methyl siloxane), poly(methyl hydrosiloxane co-diphenyl siloxane), poly(methyl hydrosiloxane co-phenyl methyl siloxane). These polysiloxanes have a desirable CO₂ solubility. Without being bound by theory, it is believed that the elasticity of polysiloxanes increases CO₂ solubility. Using published procedures, these hydride-functional polysiloxanes can be grafted with polyether and/or ionic groups by coupling them with allyl-containing compounds using a platinum catalyst (hydrosilation reaction). The general reaction schemes are shown in Schemes 6-8.

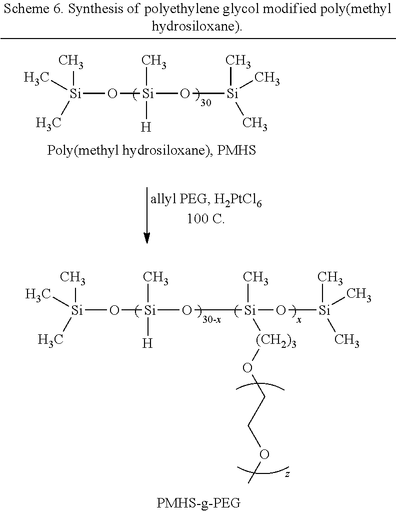

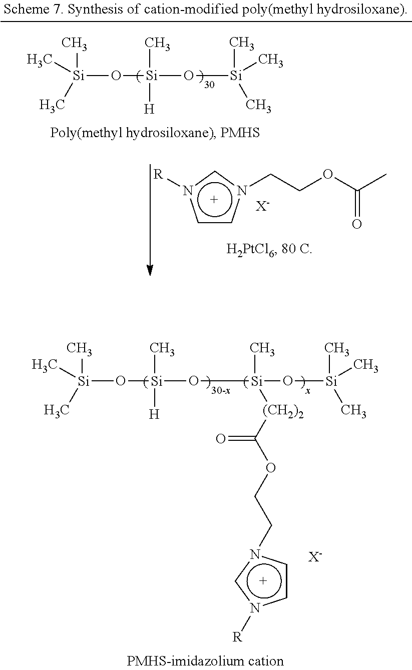

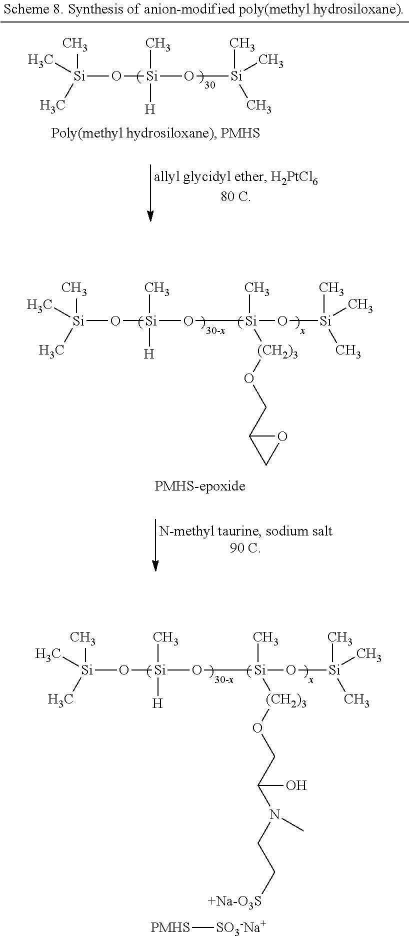

Generally, functionalization of an ionic and nonionic polysiloxane can be manipulated by controlling the amount of polyether or ionic groups added. In particular, functionalization of PMHS can be varied by varying the amount of allyl PEG, allyl glycidyl ether, and/or alkylimidazolium acrylate added to the reaction mixture. Addition of functional sites (e.g., polyether or ionic groups) increases the water solubility of ionic and nonionic polysiloxanes. The water solubility of the polymer depends on the number of functional sites added to the polysiloxane. Further, polysiloxanes can be functionalized with both a polyether and an ionic species by adding a polyether having an allyl group and an ionic compound having an allyl group to the same reaction mixture.

The functionalized PMHS can then be crosslinked into an elastomer having properties similar to a natural rubber by using the remaining Si—H groups via two possible pathways, a hydrosilylation reaction or a dehydrogenative coupling reaction. The hydrosilylation reaction uses a platinum catalyst such as platinum-divinyltetramethyldisiloxane complex and vinyl-functional polysiloxanes as crosslinkers. Examples of vinyl-functional polysiloxanes include divinyl-terminated PDMS or PPMS, poly(vinylmethylsiloxane) (PVMS) homopolymer, and copolymers of PVMS and PDMS or PPMS. The dehydrogenative coupling reaction uses a catalyst wherein the choice of catalyst depends on the coupling mechanism. Tin catalysts are predominately used in dehydrogenative coupling reaction where Si—H couples to Si—OH to form Si—O—Si linkages. Tin catalyst such as di-n-butyldilauryltin are used with silanol-functional polysiloxanes as crosslinkers. In addition to tin compounds, other transition metal complexes based on zinc, iron, cobalt, ruthenium, iron, rhodium, iridium, palladium, and platinum can be used. Specific examples include zinc octoate, iron octoate, and Wilkinson's catalyst (rhodium-based metal salt; (PhP)₃RhCl). Precious metal catalysts (predominately platinum but rhodium as well) are used in hydrosilylation reactions where Si—H reacts with a terminal vinyl bond to form Si—CH₂—CH₂—Si. Free radical initiators (thermal and/or UV generated) can be used to crosslink vinyl, acrylate, or methacrylate containing polysiloxanes. Tin and/or titanium compounds are used to catalyze condensation cure systems where Si—OH groups react with a variety of reactive groups (alkoxy, acetoxy, oxime, enoxy, and amines) to form Si—O—Si bonds. These condensation cure systems are moisture sensitive and will react in the presence of water only, but using titanium and/or tin compounds speeds up that reaction. Examples of silanol-functional polysiloxanes include disilanol-terminated PDMS or poly(trifluoropropylmethylsiloxane) (PTFPMS), disilanol-terminated copolymers of PPMS and PDMS, and silanol-trimethylsilyl modified Q resins. The crosslink density affects the material's properties and enzyme retention in the immobilization matrix.

Other variables to this immobilization procedure include annealing temperature (4° C.-60° C. for BCA or to 80° C. for HCA) and tin catalyst choice and loading. In addition, to dibutyldilauryltin, bis(2-ethylhexanoate)tin, dimethylhydroxy(oleate)tin, and dioctyldilauryltin can be used as the catalyst. As the annealing temperature increases, the amount of tin catalyst needed to maintain a fast reaction rate (solidifying in 30 minutes or less) decreases and ranges from about 0.01 to about 10 vol. %, preferably about 0.2 to about 4 vol. %.

Additionally, PMHS-g-PEG can be crosslinked via a different mechanism (hydrosilylation) using precious metal catalysts and vinyl-containing polysiloxane crosslinkers of various molecular weights. Useful catalysts for this reaction are platinum-divinyltetramethyldisiloxane complex, platinum-cyclovinylmethylsiloxane complex, and tris(dibutylsulfide)rhodium trichloride at loadings of about 0.01 to about 5 vol. %, preferably about 0.02 to about 0.5 vol. %. Examples of vinyl-containing polysiloxane crosslinkers are divinyl terminated poly(dimethylsiloxane), divinyl terminated diphenylsiloxane-dimethylsiloxane copolymer, divinyl terminated poly(phenylmethylsiloxane), poly(vinylmethylsiloxane), vinyl Q resins, vinyl T structure polymers, vinylmethylsiloxane-dimethylsiloxane copolymer, and poly(vinylphenylsiloxane co-phenylmethylsiloxane).

### 5. Electron Mediators

The electron mediator is a compound that can accept or donate electron(s). Stated another way, the electron mediator has an oxidized form that can accept electron(s) to form the reduced form, wherein the reduced form can also donate electron(s) to produce the oxidized form. The electron mediator is a compound that can diffuse into the immobilization material and/or be incorporated into the immobilization material.

In one embodiment, the diffusion coefficient of the electron mediator is maximized. Stated another way, mass transport of the reduced form of the electron mediator is as fast as possible. A fast mass transport of the electron mediator allows for a greater current and power density of the biofuel cell in which it is employed.

The biocathode's electron mediator can be a protein such as stellacyanin, a protein byproduct such as bilirubin, a sugar such as glucose, a sterol such as cholesterol, a fatty acid, or a metalloprotein. The electron mediators can also be a coenzyme or substrate of an oxidase. In one preferred embodiment, the electron mediator at the biocathode is bilirubin.

The skilled artisan, in the practice of this invention will readily appreciate that many different electron transfer mediators, especially transition metal complexes with aromatic ligands, are useful in the practice of this invention. Stated another way, interaction of a transition metal complex having aromatic ligands with a polymer electrolyte membrane (PEM) alters the electronic properties of the PEM to provide a redox polymer.

### 6. Electrocatalyst for an Electron Mediator

Generally, the electrocatalyst (electron transport mediator or redox polymer) is a substance that facilitates the release of electrons at the electron conductor by reducing the standard reduction potential of the electron mediator.

Generally, electrocatalysts according to the invention are organometallic cations with standard reduction potentials greater than +0.4 volts. Exemplary electrocatalysts are transition metal complexes, such as osmium, ruthenium, iron, nickel, rhodium, rhenium, and cobalt complexes. Preferred organometallic cations using these complexes comprise large organic aromatic ligands that allow for large electron self exchange rates. Examples of large organic aromatic ligands include derivatives of 1,10-phenanthroline (phen), 2,2′-bipyridine (bpy) and 2,2′,2″-terpyridines (terpy), such as Ru(phen)₃⁺², Fe(phen)₃⁺²Ru(bpy)₃⁺², Os(bpy)₃⁺², and Os(terpy)₃⁺². In a preferred embodiment, the electrocatalyst is a ruthenium compound. Most preferably, the electrocatalyst at the biocathode is Ru(bpy)₃⁺² (represented by the structure below).

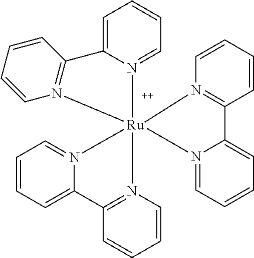

Encapsulated Enzyme Incorporation into Cathode Assembly

In many embodiments, the electrode support fabrication is done prior to enzyme deposition; this process results in two distinct layers. With the spray drying procedure described herein, enzyme immobilized carbon particles can be incorporated into carbon pastes or inks without the typical enzyme activity loss from solvent and temperature-induced denaturation to provide an integrated enzyme/carbon electrode structure. As described for other gas diffusion layer (GDL) formulations, encapsulated enzyme/carbon diffusion electrode supports can be fabricated in a custom tailored fashion to have desirable characteristics for either the anode or biocathode. Preferably, the anode can have a more hydrophilic paste that uses a hydrophilic component as discussed below. Further, the cathode support can have a greater Teflon content to provide higher hydrophobicity while retaining partial hydrophilicity.

Depending on specific requirements for the electrode, various components can provide a range of parameters that can be varied to produce electrodes having desired properties. In particular, the selection of the specific carbon materials (including graphite fibers for rigidity), binder agents, and pore forming agents along with their respective ratios can be varied to provide electrodes with a range of properties. Initial testing illustrated retention of activity and good mechanical stability in half cell configurations.

### Encapsulated Enzyme Fabrication Procedure

Biocatalyst Ink Formulations

As described herein, a method for spray coating immobilized enzyme onto various particles such as carbons, polymers, and metal oxides was developed. This immobilization method allows the preparation of conventional catalyst inks and MEA manufacturing using conventional protocols for regular PEM fuel cell systems. In traditional PEM fuel cells, catalyst inks are painted onto electrode support materials, dried, and hot pressed onto an ion exchange membrane such as Nafion®. When the enzyme is not immobilized, this fabrication method would denature the enzyme due to interaction with the solvent environment or from exposure to heat during hot pressing.

The greater stability of the enzyme in the immobilization material has allowed development of ink formulations that can be directly painted onto commercial electrode supports or electrode supports described herein for use in fuel cell applications. The ink formulation consists of enzyme encapsulated carbon, carbon black filler, and Nafion® solution. The enzyme encapsulated carbon consists of a carbon particle surrounded by enzyme that is entrapped within an immobilization polymer.

Biocathode Catalyst Ink Formulations

Various aspects of the present invention are directed to a particle comprising a core coated with an immobilized enzyme. The core can be a material that provides a support for the immobilized enzyme layer that is coated on the core. The immobilized enzyme layer comprises an enzyme, an enzyme immobilization material, and an optional electron mediator. The components of these particles are described in more detail below.

The particles coated with an immobilized enzyme are prepared by mixing a solution comprising an enzyme with a suspension comprising at least one support particle, an immobilization material, and a liquid medium to form a mixture. This mixture is then spray-dried to produce the coated particles.

The particle produced can include a core, an optional electron mediator, an enzyme, and an enzyme immobilization material (e.g., polymer matrix). The polymer matrix, which functions to stabilize the enzyme and fix it to the support, can be the various enzyme immobilization materials described above. Additionally, various compounds can be added in addition to the enzyme in the matrix that aid enzyme function. For example, electron mediators, cofactors, and coenzymes can be immobilized and will not leach into a liquid upon contact or repeated washes.

In various preferred embodiments, the enzyme is not covalently attached or adsorbed to the core. Further, preferably, the enzyme does not leach from the enzyme immobilization material into a liquid medium that the immobilized enzyme layer contacts. Typically, the immobilized enzyme particles comprise from about 0.1 wt. % to about 25 wt. % of the core and about 0.1 wt. % to about 70 wt. % of the coating and the coating comprises from about 0.1 wt. % to about 29 wt. % of the enzyme, about 0.1 wt. % to about 43 wt. % of the enzyme immobilization material, up to about 29 wt. % of the electron mediator. Typically, the total weight percent of the enzyme and the electron mediator can be up to 57 wt. % of the coating.

Core Component

The core is any particle that provides a support for the immobilized enzyme layer and that can be spray-dried. The core particle can be, for example, a polymer particle, a carbon particle, a zeolite particle, a metal particle, a ceramic particle, a metal oxide particle, a silica particle, or a combination thereof. In some embodiments, the core particle is an inert core particle. In various embodiments, the core particle is not a polymer particle. Preferred core particles do not adversely affect the stability of the enzyme or the chemical transformation involving the enzyme. In some embodiments, the core particles have an average diameter from about 200 nm to about 100 μm, depending upon the intended use of the particles when coated with the immobilized enzyme. The core component can be microporous, mesoporous, and/or nanoporous.

Methods of Preparing Coated Particles

The coated particles are prepared by mixing a solution comprising an enzyme or organelle with a suspension comprising at least one core particle, an immobilization material, and a liquid medium and spray-drying the resulting mixture. The solution, suspension, and spray-drying step are described in more detail below.

An enzyme solution comprising the enzyme and a solvent is used in the coating procedure. The enzyme is combined with a solvent and mixed until a solution is formed. Acceptable enzymes are described in more detail above. The solvent can be an aqueous solution, particularly a buffer solution, such as an acetate buffer or phosphate buffer. The buffer pH is designed to provide an acceptable pH for the particular enzyme to be immobilized. Also, in various embodiments, the enzyme solution can contain an electron mediator as described above.

A suspension is prepared by combining a core particle, the desired immobilization material and a liquid medium. Exemplary core particles and immobilization materials are described above. The liquid medium can be a solvent or buffer, such as an acetate buffer or phosphate buffer. When a buffer is used as the liquid medium, the buffer pH is selected to provide an acceptable pH for the particular enzyme to be immobilized and coated.

Once the enzyme solution and the suspension are prepared, they are combined and mixed well. The resulting mixture is then dried. A preferred drying method is spray-drying because the drying also results in coating of the core particles with the immobilized enzyme layer. Conventional spray drying techniques can be used in the methods of the invention. Alternatives to spray-drying include other conventional processes for forming coated particles, such as fluidized bed granulation, spray dry granulation, rotogranulation, fluidized bed/spray drying granulation, extrusion and spheronization.

In some of the various embodiments, the solution comprises from about 0.1 wt. % to about 15 wt. % of the enzyme and about 85 wt. % to about 99.1 wt. % of a solvent, and the suspension comprises from about 0.1 wt. % to about 50 wt. % of the core particles, from about 4 wt. % to about 10 wt. % of the enzyme immobilization material, and from about 50 wt. % to about 75 wt. % of the liquid medium. Other ways to make the casting solution include mixing the particles and the enzyme together in buffer to form a suspension and then adding solubilized immobilization material to complete the mixture or by combining all of the materials at once to form a suspension.

In various preferred embodiments, a mixture of enzyme, enzyme immobilization material, and optionally, electron mediators can be coated onto supporting particles using a spray coating/drying technique. For example, an airbrush (e.g., Paasche VL series) can be used to generate an aerosol of the components of the mixture and propel them towards a target. The aerosol is generated using compressed nitrogen gas regulated at about 25 psi. The mixture is airbrushed onto a surface such as a polycarbonate shield from a distance of about 40 cm from the tip of the airbrush to the shield. The airbrush can be moved in a raster pattern while moving vertically down the polycarbonate target in a zigzag pattern applying the casting solution. This procedure is used to minimize the coating thickness on the shield and minimize the particle-particle interaction while drying. The casting solution is allowed to dry on the shield for about 20 minutes before being collected by a large spatula/scraper.

### Alternative Anode Materials

The anode 163 comprises a precious metal catalyst, an enzymatic catalyst, or a combination thereof. Various anodes can be prepared using various metals such as platinum, ruthenium, palladium, nickel, iron, cobalt, vanadium, iridium, gold, silver, rhenium, tungsten, or a combination thereof. In some embodiments, the catalyst formulation can be a metal reduced by sodium borohydride, methanol, or hydrazine, directly onto a support, metal catalysts reduced onto carbon, metal oxides, or combinations thereof.

The anode can be prepared by mixing the metal catalyst (preferably on a high surface area electron conductor) with water and sonicating with a sonicating dismembrator. The water is added first to reduce the reaction of the catalyst with the solvent of a polymer (e.g., Nafion®) solution. Next, the polymer (e.g., Nafion®) solution is added and the mixture is sonicated with a sonicating dismembrator and painted with an artist brush onto an appropriately sized piece of nickel foam. The ink mixture is evenly distributed until the entire solution is applied to the foam. Each ink layer is allowed to dry before the next layer is added.

Various other anodes can be used with the air-breathing biocathodes described herein. For example, a zinc anode can be combined with the air-breathing biocathodes described herein. Additionally, a lithium anode can be combined with the air-breathing biocathodes described herein.

The current collectors and electron conductors described for biocathodes above can be used in the anode. In preferred embodiments, the electron conductor can be metal foams, frits, felts, screens, expanded metal packages, or combinations thereof.

### Anion Exchange Membranes

Desirable anion exchange membranes (AEM) provide a physical barrier between the anode and biocathode to prevent electrode contact or shorting and also conduct anions, particularly hydroxide ions, effectively and efficiently at the operating currents for the existing fuel cell setup. In some embodiments, the AEM is capable of hot-press processing at approximately 125° C. during fuel cell construction. Desirable, it should be relatively stable at basic conditions to extend its operation lifetime. Various AEMs having a permanent cation in the polymer that make it a shuttle for hydroxide ions. Various commercial AEMs can be used in the biofuel cell of the invention. For example, alkaline salt doped polybenzimidazole (PBI) materials; DABCO- or DBACO/NEt₃-quaternized epichlorohydrin; ammonium-type AHA; radiation-grafted poly(vinylidene fluoride) (PVDF) and fully fluorinated poly(tetrafluoroethylene-co-hexafluoropropylene) (FEP). Of the latter, PVDF materials, which were adopted from electrodialysis and ion-exchange applications, proved unsuitable for AEMs because of the lack of polymer backbone stability in the presence of high hydroxide ion concentrations.

For the anode-cathode assemblies 815 described below, the referred embodiments, the membrane is polymeric in nature with metal oxides added to hold and fix ionic species or a polymer that can be loaded with electrolyte depending on the application and choice of fuel. Particularly suitable materials for the membrane are polymeric in nature. Exemplary polymeric materials are polysulfone, polysulfone with zirconium oxide, aminated polysulfone, Verkade base functionalized polysulfone, cellophane, aminated cellophane, Verkade base functionalized cellophane, quaternary amine functionalized poly(vinyl alcohol), poly(vinyl alcohol), polyphenylene oxide, aminated polyphenylene oxide, Verkade base functionalized polyphenylene oxide, Verkade base functionalized perfluorinated polymers.

Further, the following AEMs can be used in the biofuel cell of the invention.

### Modified Polysulfone

In some of the various embodiments, the anion exchange membrane has a structure of Formula 5

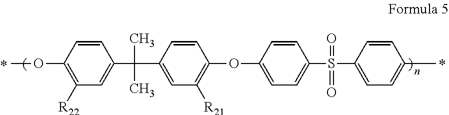

wherein R₂₁, R₂₂, and n are defined above. In various embodiments, R₂₁ and R₂₂ are independently hydrogen, alkyl, or substituted alkyl. In various embodiments, R₂₁ and R₂₂ are independently hydrogen or —(CH₂)_{q}N⁺R₂₆R₂₇R₂₈, wherein R₂₆, R₂₇, and R₂₈ are independently alkyl and q is an integer of 1, 2, or 3; particularly, R₂₆, R₂₇, and R₂₈ are independently methyl, ethyl, propyl, butyl, pentyl, or hexyl; more particularly, R₂₆, R₂₇, and R₂₈ are methyl.

Alternatively, R₂₁ and R₂₂ are independently hydrogen or —(CH₂)_{q}N⁺R₂₆R₂₇R₂₈, wherein R₂₆ and R₂₇ are independently methyl, ethyl, or propyl, R₂₈ is alkylamino, and q is an integer of 1, 2, or 3. When R₂₈ is alkylamino, preferred alkylamino groups are tertiary alkylamino groups. For example, the alkylamino group can be —CH₂N⁺R₂₉R₃₀R₃₁, —CH₂CH₂N⁺R₂₉R₃₀R₃₁ or —CH₂CH₂CH₂N⁺R₂₉R₃₀R₃₁ wherein R₂₉, R₃₀, and R₃₁ are independently hydrogen or alkyl. In various preferred embodiments, R₂₉, R₃₀, and R₃₁ are independently methyl, ethyl, propyl, butyl, pentyl, or hexyl; more particularly, R₂₉, R₃₀, and R₃₁ are methyl or ethyl.

Preferably, R₂₁, R₂₂, or R₂₁ and R₂₂ are alkyl or substituted alkyl wherein the average number of alkyl or substituted alkyl groups per repeat unit is from about 0.1 to about 1.4, from about 0.2 to about 1.4, from about 0.3 to about 1.4, from about 0.3 to about 1.2, from about 0.3 to about 1, from about 0.3 to about 0.8, from about 0.4 to about 1.4, from about 0.4 to about 1.2, from about 0.4 to about 1, from about 0.4 to about 0.8, from about 0.5 to about 1.4, from about 0.5 to about 1.2, from about 0.5 to about 1, from about 0.5 to about 0.8.

Modified polysulfone is a desirable anion exchange membrane because it has good chemical and thermal stability and can be prepared having a range of nitrogen units per repeat unit. Additionally, modified polysulfone has advantageous solubility characteristics in polar organic solvents such as N-methylpyrrolidone (NMP) and dioxane.

Preparation of aminated polysulfone membranes are described above. Immersion of chloromethylated polysulfone in trimethylamine (TMA) aqueous solutions show when the TMA solution is too concentrated (4.5M and 1M), the films dissolve in a few hours. However, at lower TMA concentrations (0.15M), the films remain intact upon soaking overnight. These films swell extensively and become more of a hydrogel material. Thus, in this form they break easily. When soaked in a 1M KOH solution to exchange the chloride anions for hydroxide anions, the membranes retained the ability to be hot pressed upon drying.

The more dilute TMA solutions having a concentration of less than 0.1 M were used to vary the rigidity of the film. As described herein tertiary diamines can also be used to aminate and crosslink the chloromethylated polysulfone.

### Modified Polycarbonate

In certain embodiments, the anion exchange membrane has a structure of Formula 6

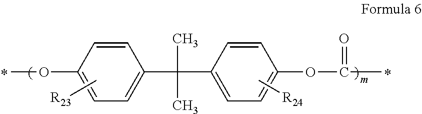

wherein R₂₃, R₂₄, and m are defined above. In various embodiments, R₂₃ and R₂₄ are independently hydrogen, alkyl, or substituted alkyl. In various embodiments, R₂₃ and R₂₄ are independently hydrogen or —(CH₂)_{q}N'R₂₆R₂₇R₂₈, wherein R₂₆, R₂₇, and R₂₈ are independently alkyl and q is an integer of 1, 2, or 3; particularly, R₂₆, R₂₇, and R₂₈ are independently methyl, ethyl, propyl, butyl, pentyl, or hexyl; more particularly, R₂₆, R₂₇, and R₂₈ are methyl.

Alternatively, R₂₃ and R₂₄ are independently hydrogen or —(CH₂)ₚN'R₂₆R₂₇R₂₈ wherein R₂₆ and R₂₇ are independently methyl, ethyl, or propyl, R₈ is alkylamino, and p is an integer of 1, 2, or 3. When R₂₈ is alkylamino, preferred alkylamino groups are tertiary alkylamino groups. For example, the alkylamino group can be —CH₂N⁺R₂₉R₃₀R₃₁, —CH₂CH₂N⁺R₂₉R₃₀R₃₁ or —CH₂CH₂CH₂N⁺R₂₉R₃₀R₃₁ wherein R₂₉, R₃₀, and R₃₁ are independently hydrogen or alkyl. In various preferred embodiments, R₂₉, R₃₀, and R₃₁ are independently methyl, ethyl, propyl, butyl, pentyl, or hexyl; more particularly, R₂₉, R₃₀, and R₃₁ are methyl or ethyl.

Preferably, R₂₃, R₂₄, or R₂₃ and R₂₄ are alkyl or substituted alkyl wherein the average number of alkyl or substituted alkyl groups per repeat unit is from about 0.1 to about 1.4, from about 0.2 to about 1.4, from about 0.3 to about 1.4, from about 0.3 to about 1.2, from about 0.3 to about 1, from about 0.3 to about 0.8, from about 0.4 to about 1.4, from about 0.4 to about 1.2, from about 0.4 to about 1, from about 0.4 to about 0.8, from about 0.5 to about 1.4, from about 0.5 to about 1.2, from about 0.5 to about 1, from about 0.5 to about 0.8.

Preparation of aminated polysulfone is described in more detail above.

Modified Poly(vinylbenzyl chloride)

In other embodiments, the anion exchange membrane has a structure of Formula 7

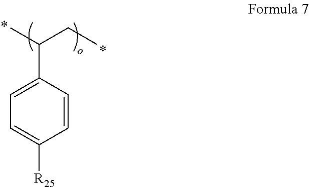

wherein R₂₅ and o are defined above. In various embodiments, R₂₅ is hydrogen, alkyl, or substituted alkyl. In various embodiments, R₂₅ is hydrogen or —(CH₂)_{q}N⁺R₂₆R₂₇R₂₈, wherein R₂₆, R₂₇, and R₂₈ are independently alkyl and q is an integer of 1, 2, or 3; particularly, R₂₆, R₂₇, and R₂₈ are independently methyl, ethyl, propyl, butyl, pentyl, or hexyl; more particularly, R₂₆, R₂₇, and R₂₈ are methyl.

Alternatively, R₂₅ is hydrogen or —(CH₂)ₚN⁺R₂₆R₂₇R₂₈ wherein R₂₆ and R₂₇ are independently methyl, ethyl, or propyl, R₂₈ is alkylamino, and p is an integer of 1, 2, or 3. When R₂₈ is alkylamino, preferred alkylamino groups are tertiary alkylamino groups. For example, preferred alkylamino groups can be —CH₂N⁺R₂₉R₃₀R₃₁, —CH₂CH₂N⁺R₂₉R₃₀R₃₁ or —C₆H₄N⁺R₂₉R₃₀R₃₁ wherein R₂₉, R₃₀, and R₃₁ are independently hydrogen or alkyl. In various preferred embodiments, R₂₉, R₃₀, and R₃₁ are independently methyl, ethyl, propyl, butyl, pentyl, or hexyl; more particularly, R₂₉, R₃₀, and R₃₁ are methyl or ethyl.

Preferably, R₂₅ is substituted alkyl wherein the average number of substituted alkyl groups per repeat group is at least 0.1, 0.2, 0.3, 0.4, 0.5, 0.6, 0.7, or more.

Poly(vinylbenzyl chloride) (PVBC) can be prepared as described above. PVBC crosslinked with TMPDA forms a hydrophilic, high-swelling material, which could significantly improve the transport of hydroxide ions through the polymer, as compared to rigid glassy polymers such as polysulfone.

### Arylated Poly(Phenylene Sulfide) (Pps)

A polymer that is completely arylated, has no β-hydrogens susceptible to Hoffman degradation and no α-carbons susceptible to direct nucleophilic attack in basic conditions (the two main modes of degradation for quaternary cations upon basic exposure) have been prepared. An aryl system should show desirable stability to prolonged exposure to bases. The polymer was prepared by arylating poly(phenylene sulfide) (PPS), a commercially-available polymer. The general reaction scheme is shown in Scheme 9. PPS was arylated using this method, as evidenced by solubility differences of the polymer before and after functionalization. Based on published reports, a maximum arylation of ˜40% of the sulfurs can be expected.

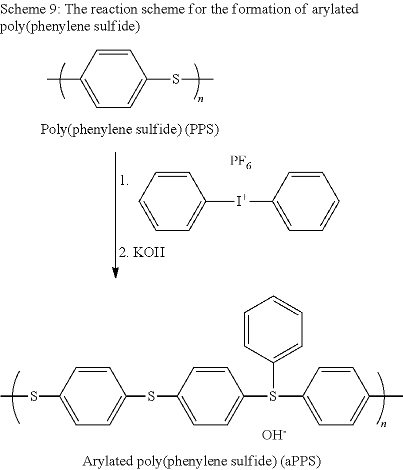

### Quaternized Poly(4-Vinyl Pyridine) (P4VP)

Poly(4-vinyl pyridine) (P4VP) is a commercially-available polymer with good thermal stability (glass transition temperature ˜142° C.). To increase stability in basic solutions, when quaternized this polymer contains no β-hydrogens susceptible to Hoffman degradation. The general reaction scheme is shown in Scheme 10.

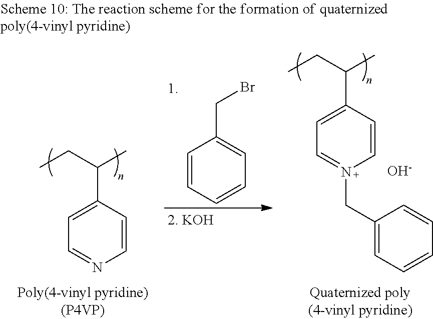

Because the nitrogen is imbedded in a ring, it should be more stabilized than the previously discussed quaternary amines to degradation. Also, it is expected that quaternized P4VP will be soluble in most polar organic solvents. Thus, it can be more easily utilized as an ionomer in the painting of the electrodes. While the quaternized P4VP depicted in Scheme 7 still has an a carbon susceptible to nucleophilic attack, this attack is more sterically hindered due to the presence of the two surrounding rings. Other possible variations include using phenyl bromide (similar to the benzyl bromide shown in Scheme 10 but lacks the methylene spacer). This system would be a completely arylated quaternary amine, but the extent of quaternization might be less due to steric hindrance.

As used herein, an electrode is an anode at which a fuel fluid is oxidized or a biocathode at which an oxidant is reduced.

### Quaternized Poly(Vinyl Alcohol) (QPVA)

In various embodiments, the anion exchange membrane has the structure of Formula 11:

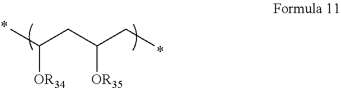

wherein R₃₄ and R₃₅ are independently hydrogen, alkyl, or substituted alkyl, provided that the average number of substituted alkyl groups per repeat group is 0.1. In various embodiments, R₃₄ and R₃₅ are independently hydrogen, -alkylene-N⁺R₂₆R₂₇R₂₈, or -substituted alkylene-N⁺R₂₆R₂₇R₂₈, wherein R₂₆, R₂₇, and R₂₈ are independently alkyl; particularly, R₂₆, R₂₇, and R₂₈ are independently methyl, ethyl, propyl, butyl, pentyl, or hexyl; more particularly, R₂₆, R₂₇, and R₂₈ are methyl.

Poly(vinyl alcohol) (PVA) is a commercially-available polymer that is water soluble. The hydroxide groups in PVA can be functionalized with quaternary amines. The general reaction scheme is shown in Scheme 11.

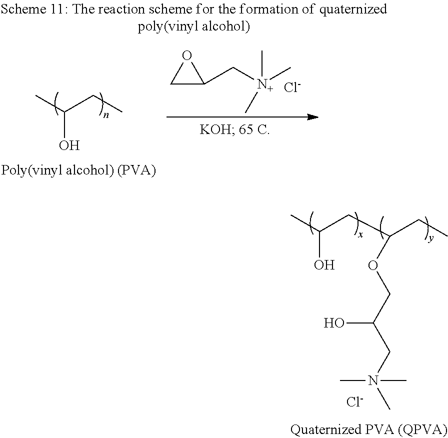

QPVA is also water soluble but can be crosslinked into a non-water soluble membrane by using a dialdehyde (such as glutaraldehyde) crosslinker. These AEMs have methanol permeabilities that decreased with increasing methanol concentration and were always less than that of Nafion 117 (See: Xiong, Y.; Fang, J.; Zeng, Q. H.; Liu, Q. L.; Journal of Membrane Science, 2008, vol 311, pages 319-325). As such, QPVA AEMs have shown promise for inhibited methanol crossover and improved mechanical stability (as compared to quaternized PSf and PPO). Additionally, the degree of functionalization of QPVA, and hence the number of ion exchange sites, can be manipulated by changing the ratio of glycidyltrimethylammonium chloride to PVA as well as the reaction time and temperature. Because the introduction of ion exchange sites and crosslinking into a film occurs in separate steps (instead of a single step as with PSf, PPO, and PVBC), there is more control over the incorporation of ion-exchange sites and the degree of crosslinking in the AEMs. The amount of glutaraldehyde added as well as the annealing temperature during film preparation dictates the degree of crosslinking and thus swellability in an aqueous environment, which will affect the ionic conductivity of these AEMs.

### Fuel Fluid and Oxidant

A fuel fluid that can be oxidized to produce electrons at the anode and an oxidant that can be reduced to produce water at the biocathode are components of the biofuel cell of this invention.

The fuel fluid for the anode is consumed in the oxidation reaction of the electron mediator and the immobilized enzyme. The fuel fluid's molecular size is small enough so the diffusion coefficient through the enzyme immobilization material is large.

Exemplary fuel fluids are hydrogen, ammonia, alcohols (such as methanol, ethanol, propanol, isobutanol, butanol and isopropanol), polyhydric alcohols (such as glycerol and glycol), allyl alcohols, aryl alcohols, glycerol, propanediol, mannitol, glucuronate, aldehyde, carbohydrates (such as glucose, glucose-1, D-glucose, L-glucose, glucose-6-phosphate, lactate, lactate-6-phosphate, D-lactate, L-lactate, fructose, galactose-1, galactose, aldose, sucrose, sorbose and mannose), glycerate, coenzyme A, acetyl Co-A, malate, isocitrate, formaldehyde, acetaldehyde, acetate, citrate, L-gluconate, beta-hydroxysteroid, alpha-hydroxysteroid, lactaldehyde, testosterone, gluconate, fatty acids, lipids, phosphoglycerate, retinal, estradiol, cyclopentanol, hexadecanol, long-chain alcohols, coniferyl-alcohol, cinnamyl-alcohol, formate, long-chain aldehydes, pyruvate, butanal, acyl-CoA, steroids, amino acids, flavin, NADH, NADPH, FADH2, hydrocarbons, amines, hydride complex (such as sodium borohydride), hydronitrogen (such as hydrazine), amine-borane (such as borazane), and combinations thereof. In a preferred embodiment, the fuel fluid is an alcohol, more preferably methanol and/or ethanol. For anode-cathode assemblies 815, in preferred embodiments, the fuel solution is a combination of a metal hydroxide, and a liquid or soluble fuel. Particularly suitable fuels for combination with a metal hydroxide are glycerol, methanol, ethanol, butanol, propanol, glycol, sodium borohydride, hydrazine, borazane, glucose, fructose, sucrose, or a combination thereof. In other systems, the fuel fluid comprises formate.

Using formate as a fuel is advantageous because it is easily oxidized in an alkaline environment, it has minimal depolarization effects on biocathode performance, and improves stack material stability because methoxide is eliminated. The oxidation of formate to carbon dioxide, at a palladium/gold catalyst, is a two electron process and is the last of three steps in methanol oxidation. This could be of importance when comparing to direct methanol fuel cells, in terms of safety and environmental greenness, because the formate system does not have a formaldehyde product. However, because it is only a two electron process and has a solubility limit of 75 wt. %, the energy density of a direct formate fuel cell system is about one-third the energy density of a comparable methanol system. Depending on the characteristics of the application and the desired greenness of the system, this energy density limitation may not be limiting. After testing formate fuel cells, both in single cell and stack configurations, the formate fuel cell had improved fuel utilization, high current densities with an anion exchange membrane in the absence of added base, and the capability of operation using a wide variety of bases while not being limited to using potassium hydroxide.

Direct methanol fuel cells (DMFCs) typically have poor fuel utilization/efficiency due to methanol cross over and subsequent oxidation of the fuel at the cathode electrode. This results in the depolarization of the cell and parasitic utilization of fuel, a serious concern for cathodes with platinum catalyst since platinum can efficiently oxidize methanol. Using an alkaline system and an enzyme as the catalyst in the biocathode, fuel cross over is minimized, but not completely eliminated. The cross over effects are most apparent in stack lifetime testing, where 50% fuel utilization efficiencies are common at methanol concentrations of greater than 30%. Again, as mentioned previously, this is much better than a traditional passive DMFC system that functions very poorly when methanol concentrations at the anode exceed 5%. Without being bound by theory, it is believed that mixed metal phthalocyanines added to the biocathode catalyst layer for increase current densities are responsible for oxidizing methanol at the cathode.

The oxidant for the biocathode is consumed in the reduction reaction of the electron mediator and the immobilized enzyme using electrons supplied by the anode. The oxidant's molecular size is small enough so the diffusion coefficient through the enzyme immobilization material is large. A variety of means of supplying a source of the oxidant known in the art can be utilized.

In a preferred embodiment, the oxidant is gaseous oxygen, which is transported to the biocathode via diffusion. In another preferred embodiment, the oxidant is a peroxide compound.

### Anode and Cathode Fabrication Techniques

Specific procedures used to fabricate the anode and cathode assemblies are described in more detail below in the examples.

### Fuel Cell Power System Electronics and Control

Referring now to FIGS. 7-21, system electronics and control circuitry embodying aspects of the invention provide cell control, hybrid and battery management, connection of the circuit board, and system control functions for a passive alkaline fuel cell system with a bio cathode utilizing laccase. In the embodiment shown in the drawings, the fuel cell device 1 comprises a stack of one or more fuel cells (e.g., four). As described above, each cell including a fuel reservoir 25 and associated anode-cathode assemblies 45, 47. However, it will be understood that the number of such cells can vary from one to any number greater than one.

FIG. 7 illustrates an embodiment of device 1 in block diagram form. As shown, one or more fuel cells 721 are electrically connected to the electronic controller 71 via line 723. The cells 721 may be stacked or otherwise arranged as described above. The line 723 comprises, for example, spring pins 185 or the like providing multiple electrical connections (e.g., two connections per stack) to controller 71. In the illustrated embodiment, controller 71 comprises an Individual Cell Monitoring and Control (ICMC) 727, a fuel cell switching control 729, and a fuel cell DC/DC conversion and monitoring circuit 731. The battery 81 of fuel cell device 1 supplies supplemental power to the load (connected via terminals 733 and for supplying power to the controller 71 itself and to a vibration motor/pump 735. As shown in the block diagram of FIG. 7, controller 71 includes a battery protection circuit 739, a battery charging circuit 741, a battery DC/DC conversion circuit 743, and a vibration motor control 745. In addition, controller 71 includes a battery fuel gauge 747. A power down circuit 751 places fuel cell device 1 in a low power state for extending shelf life of the device. In addition, controller 71 includes an output current monitoring circuit 753.

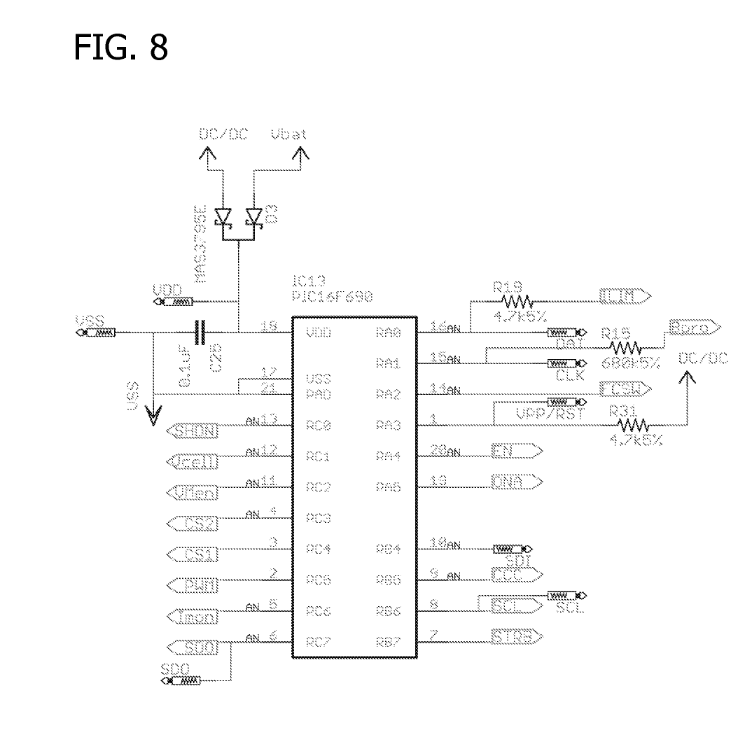

In operation, power flows from the fuel cells to the ICMC 727 via line 723 as well as to the fuel cell switching control 729 via line 757. According to one embodiment, ICMC 727 provides a series of bilateral switches (see Fig. XX) that together with fuel cell switching control 729 control the connection of the individual fuel cells 721 in series. In addition, ICMC 727 provides monitoring of each anode-cathode assembly 45, 47. The fuel cell DC/DC conversion and monitoring circuit 731, which receives fuel cell power via line 759, enables voltage regulation within the system. For instance, fuel cell DC/DC conversion and monitoring circuit 731 constantly monitors the state of the fuel cell voltage against a set reference voltage. A microcontroller (see FIG. 8) or other suitable processor of controller 71 controls the reference voltage set point. As shown in FIG. 7, lines 723, 757, 759, 761, and 763 represent power coming from the fuel cells 721.

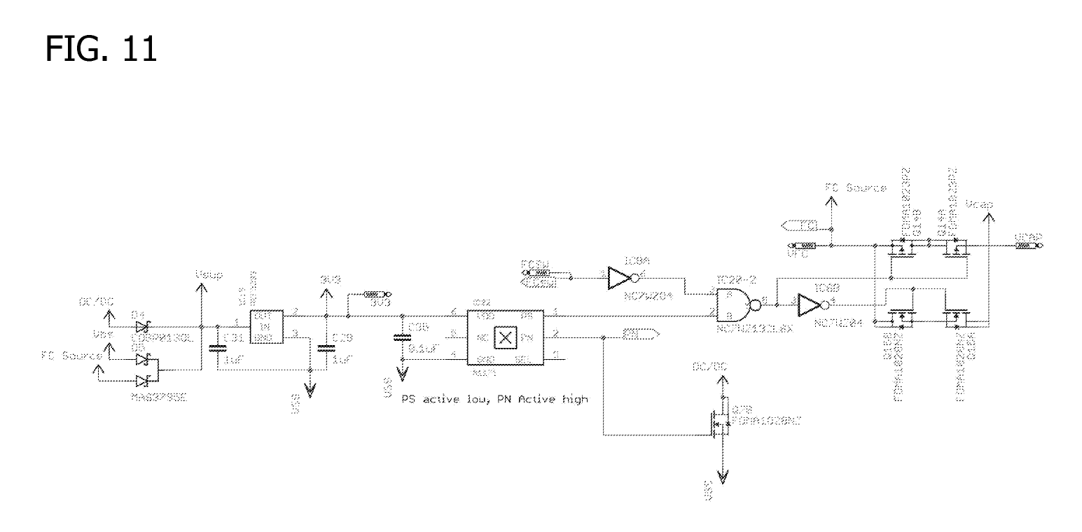

Referring further to the operation of controller 71, the battery 81 supplies power to controller 71 via lines 767, 769, 771, 773, 775, and 777. In addition, the battery charging circuit 741 supplies power to battery 81 via line 779. The battery fuel gauge 747 is connected to battery charging circuit 741 via a control line 783 for determining a level of charge on battery 81. As shown in the block diagram, the power down circuit 751 receives a combination of fuel cell power, battery power, and output power at 785 that is junctioned by diodes (see Vₛᵤₚ of FIG. 11). The power at line 785 is from whichever input voltage is higher after the forward diode drop. The power down circuit 751 in turn provides a control signal to battery protection circuit 739 via a control line 789 and to fuel cell switching control 729 via a control line 791. At 793, the output current monitor 753 measures output load current, which represents the equivalent output power that comes from either the fuel cell DC/DC conversion via line 763 or the battery DC/DC conversion via line 773. In turn, output current monitor 753 provides this information to both the fuel cell DC/DC conversion and monitoring circuit 731 and to the battery DC/DC conversion circuit 743 via control lines 795 and 797, respectively.

FIGS. 8-21 illustrate exemplary circuit schematics for implementing the fuel cell and hybrid power control as well as system control and monitoring capabilities in accordance with aspects of the invention.

The electronic controller 71 controls the output of each cell 721 according to a desired mode of operation. Early developmental data shows that a fuel cell performs better when the stack is oscillated on and off In a first defined operating mode, the cells 721 are electrically connected in series and controller 71 switches them on and off together at a predetermined duty cycle, such as 25% at 1000 Hz. Advantageously, operating cells 721 according to the predetermined duty cycle improves fuel cell performance. In particular, cycling the cells 721 on and off improves stability for long term use as measured by current decay at a set voltage. Moreover, cycling cells 721 in this manner improves the power output of the device 1 by allowing time for cells 721 to go from load to an open circuit condition. In the open circuit condition, cells 721 have a larger reactance available to the catalyst layer without being oxidized, which results in a larger power output when subsequently under load. In a second defined mode of operation, controller 71 controls the output of cells 721 so that one cell is disconnected from load 5 while the remaining cells are connected to load 5 (e.g., one cell off and seven cells on for an eight cell stack). In this embodiment, allowing each cell 721 to periodically be in an open circuit condition while the remaining cells are under load also improves stability and power output and, thus, improves fuel cell performance.

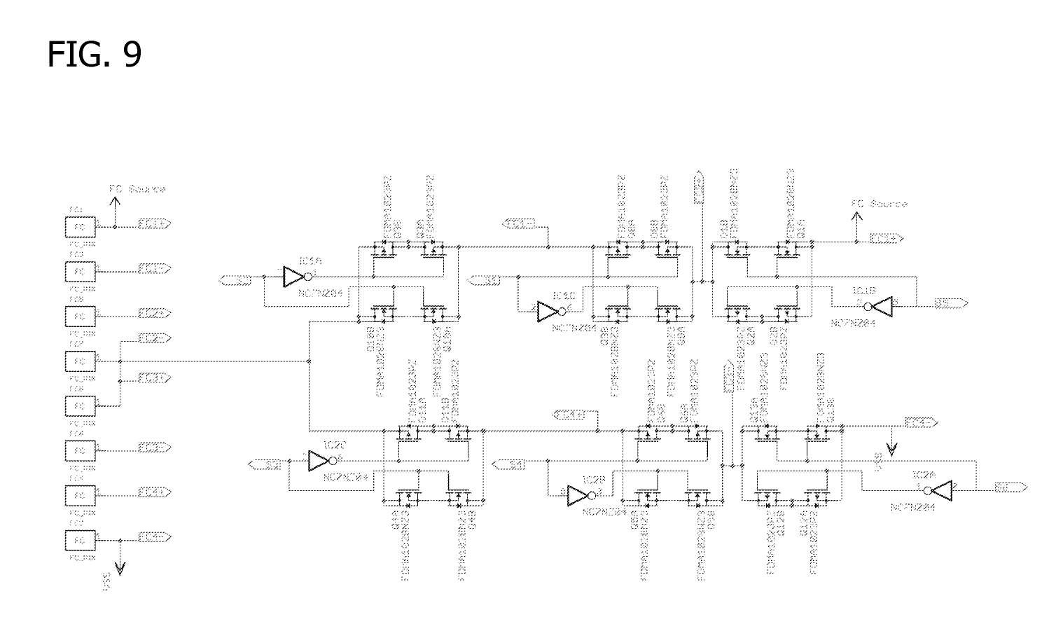

In an embodiment, such as shown in FIG. 9, ICMC 727 includes a series of simple, low resistance, bilateral switches as well as a differential multiplexer followed by operational amplifiers. The bilateral switches control the connection of the individual fuel cells 721 in series. One dual N-channel and one dual P-channel MOSFET (FDMA1028NZ and FDMA10023PZ respectively) are used in conjunction with one inverting gate from either a NC7NZO4 or NC7WZO4 (tri/dual inverter respectively). The switches are set up in such a way that any one cell may be open circuited from the rest of the cells in series (the switches turn four cells in series into 3 cells in series with the fourth open circuited). With the MOSFETs used to implement the bilateral switching action a much lower on-state resistance is able to be achieved compared to discrete bilateral switches allowing far less power loss.

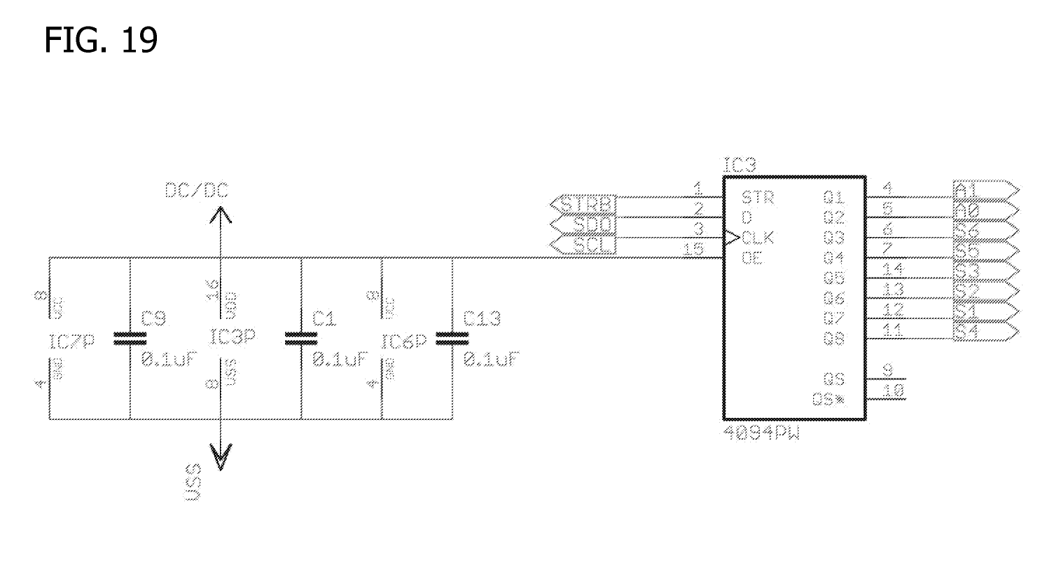

The microcontroller controls switching via a 4094 serial to parallel shift register (see FIG. 19). The nominal state is with all switch signals to be a logic low, which places all four cells in series. Combinations of the six switch signals bypass any one of the four cells 721 while placing the remaining three in series. This is done to bypass a bad/malfunctioning cell during runtime, allowing longer overall stack health and runtime. It also provides the ability to switch out a cell for a period of time in order to relax it by removing the load from it.

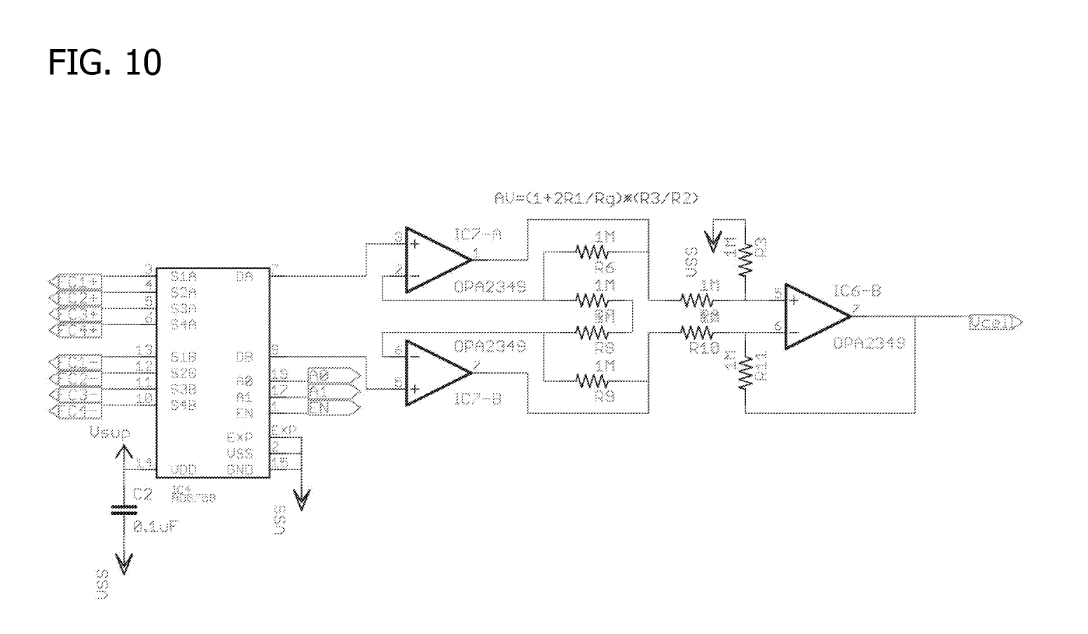

For the monitoring portion of ICMC 727, FIG. 10 illustrates each anode and cathode connected to a corresponding differential input to an ADG759 4 channel differential multiplexer. The differential output of which is connected to an instrumentation amplifier with Aᵥ=2. After passing through the instrumentation amplifier, the differential voltage is now referenced to Vₛₛ and is fed to the microcontroller for conversion. The multiplexer channel selection is determined the same way in which the ICMC 727 control is, in that the microcontroller selects the channel via the same 4094 serial to parallel shift register. The microcontroller makes decisions based on the voltage of one cell in relation to the other cells. If one cell has a far lower voltage than the others, for example, then it may be bypassed.

Referring now to FIG. 11, in the illustrated embodiment, controller 71 executes fuel cell switching control 729 via a bilateral switch such as used in ICMC 727 as shown in FIG. 9. The output of a dual NAND gate NC7WZ132 controls this bilateral switch. One input of the NAND is an inverted signal from the microcontroller of controller 71 while the other input is the PS output from a Hall Effect sensor. When either input is low, the switch is disabled (in the “open” position). An inverter NC7WZO4 powered through the Vₛᵤₚ supply bus inverts the signal from the microcontroller. This is because when the microcontroller is in a powered down state or an insufficient voltage state, the input to the inverter is a logic low, which results in the input of the NAND being a logic high. The logic high of the NAND in conjunction with the appropriate signal from the Hall Effect sensor enables the bilateral switch. This ensures proper start-up by acting as a pull-up on the input of the NAND gate.

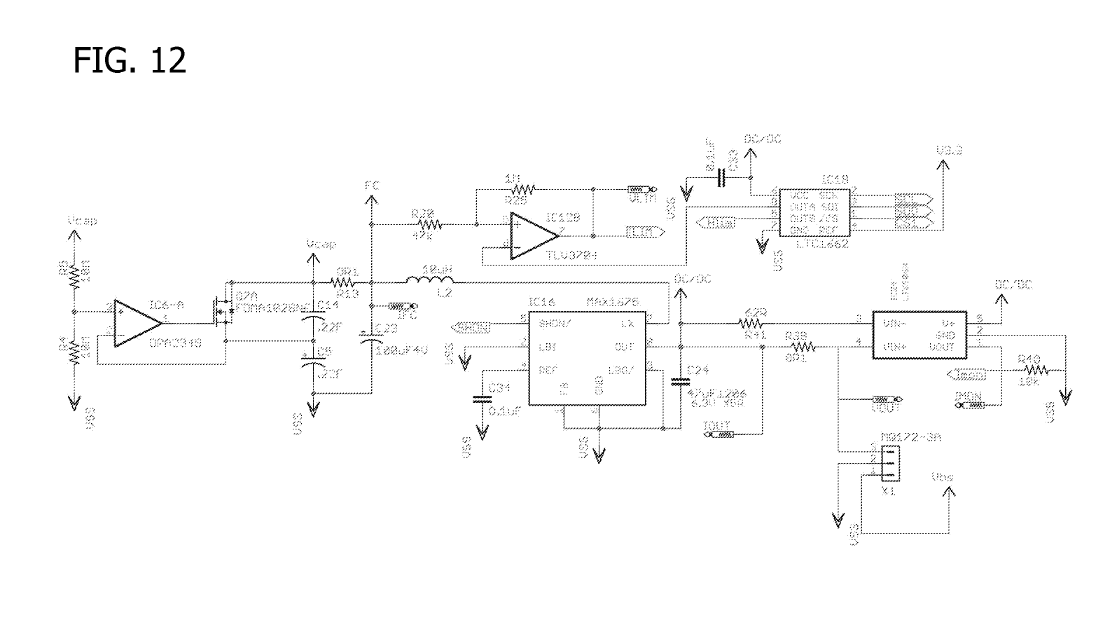

As shown in the exemplary schematic diagram of FIG. 12, once activated, the bilateral switch connects the fuel cell power to V_{cap}. The voltage V_{cap} is the voltage at the storage super capacitor, which buffers the load seen by the fuel cell and, thus, allows the fuel cell to provide more of a steady state power instead of varying transients that a load would typically require. Two 0.22 F super capacitors (e.g., KS series from PowerStor) are used in series to accommodate the potential voltage of the fuel cell stack. A charge balancing circuit ensures proper balance of charge for maintaining maximum lifetime of the super capacitors. Two 10 M resistors the voltage at V_{cap} and feed the voltage into a non-inverting operational amplifier with negative feedback from the junction of the two super capacitors. The output of the op-amp is connected to a FDMA1028NZ MOSFET that is connected across C14. This circuit ensures an equal voltage is seen by each of the capacitors to maximize the capacitors' lifetime (the capacitors are rated to 3.3V with recommended operating voltages that are much lower). A current sense resistor connects V_{cap} to the input of the fuel cell DC/DC converter (Vfc). This resistor is used for testing purposes of monitoring the fuel cell current draw only and may be replaced with a wire jumper for production purposes.

FIG. 12 also illustrates an embodiment of fuel cell DC/DC conversion and monitoring circuit 731, which enables voltage regulation within the system. The fuel cell switching voltage V_{fc} described above is the power source for the fuel cell DC/DC converter 731 (embodied by, for example, a MAX1675 DC/DC converter used within the manufacturer recommendations as far as inductor selection and input/output capacitor selection is concerned). The input capacitor is a low ESR T520 series organic tantalum. The inductor is a 10 μH EPL2014 with a saturation current comparable to the maximum current associated with the dc/dc converter. The output capacitor is a 47 μF MLCC. A maximum output current of about 100 mA is possible with the nominal output of the fuel cell operating at about 2 V with a high efficiency. The converter is set to have a 5V output when enabled. The enable control comes from the output current monitoring 753. When the SHDN signal is high, the conversion process is enabled and as long as there is sufficient input voltage and not an excessive load, the output onto V_{dc/dc} will be 5 V. When SHDN goes low, the DC/DC converter is put into a shut down/low power state.

Referring further to FIG. 12, a TLV3704 comparator constantly monitors the state of the fuel cell voltage against a set reference voltage. A LTC1662 digital to analog converter controlled by the microcontroller sets the reference voltage set point. This set point is the threshold for the comparator and acts as a lower limit for the fuel cell voltage to reach. When this threshold is crossed, a logic low is sent to the microcontroller and held until the fuel cell voltage recovers. The microcontroller acts upon this signal to enable battery hybridization and to disable the fuel cell in order to rest the stack in case of long runtime or in case of excessive load that the current monitoring failed to detect. This low voltage threshold is controllable and adjustable according to system needs. The ability to instantly change over to battery hybridization allows for much longer run times by maximizing the fuel utilization of the fuel cell.

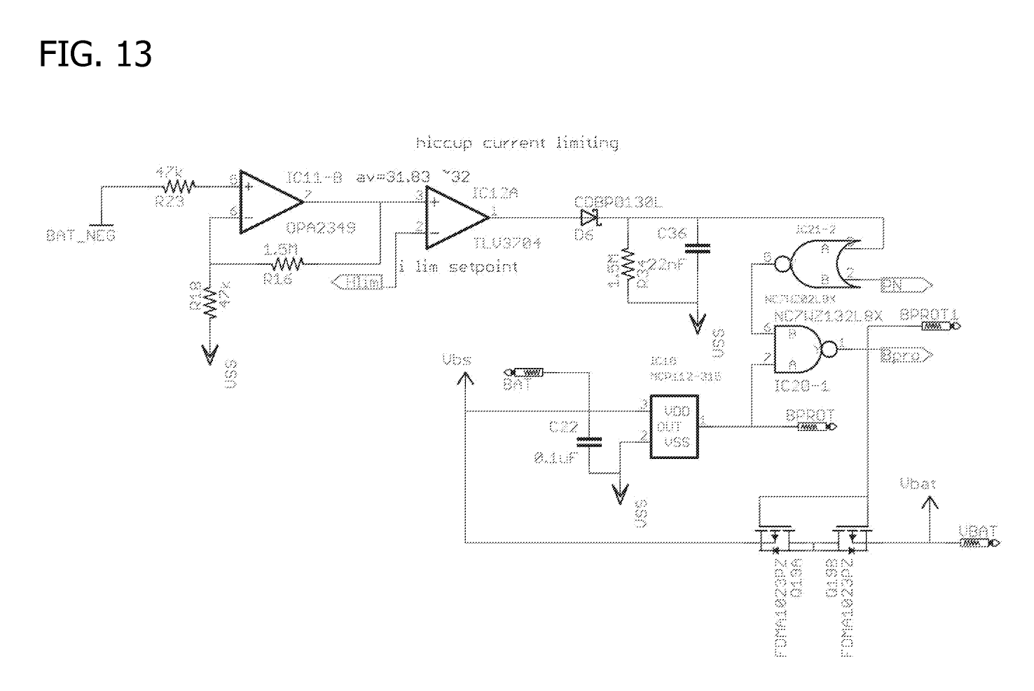

In an embodiment, the controller 71 of fuel cell device 1 also includes battery protection circuit 739. Battery protection consists of three separate parameters; current limiting, over discharge monitoring, and over charge monitoring. If any of these parameters is tripped, a protection method is engaged. Referring first to current limiting and over discharge monitoring, FIG. 13 provides an exemplary schematic diagram of battery protection circuit 739. Discharge rate control is implemented through hiccup current limiting. A current sense resistor monitors the current used for the coulomb counting (see battery charging circuit 741). This resistor indicates the current into and out of the battery 81 (e.g., a Leopro LLP-453048600P LiPo). The voltage developed across this resistor is amplified with an operational amplifier then fed into a TLV3704 comparator. A LTC1662 digital to analog converter sets this set point. If the instantaneous current out of the battery 81 exceeds the scaled voltage of the set point, then the output of the comparator goes high, instantly charging a capacitor through a Schottky diode. This signal is fed into and held at the battery control logic gates. If tripped, the logic high is maintained until the resistor in parallel with the capacitor discharges the capacitor enough to indicate a logic low to the control logic gates. Even if the current draw error event during is very minute, the safety measure is implemented for the time, or duration, of the fault condition plus the time of the capacitor discharge.

Referring further to FIG. 13, the control logic gates consists of a NOR and a NAND gate that control a pair of FDMA1023PZ P-channel MOSFETs arranged drain to drain in a switch configuration in order to prevent unauthorized current backflow into or out of the battery. The NOR gate is a dual input NC7WZ02. One input comes from the PN output of the Hall Effect sensor (see power down circuit 751) and the other comes from the hiccup limiting circuit of FIG. 13. The output of the NOR feeds into one of the NAND (NC7WZ132) inputs. The other NAND input comes from the output of a MCP112-315 voltage detector, which is placed across the battery 81. This voltage detector maintains a low output if the input voltage is below the threshold of approximately 3 V. This is used to indicate if the battery voltage drops below the recommended safe operating range of 3 V-4.2 V. The output of the NAND then controls the pair of P-channel FETs. These logic gates are powered through Vₛᵤₚ (see FIG. 11) since the PN signal is used as an enable for the battery control logic (see power down circuit 751). If the control circuit is triggered for any reason (e.g., current limiting, PN signal, or under voltage), the pair of FETs disconnects V_{bs} from V_{bat}, which disconnects battery 81 from the DC/DC converter 743 and any other potentially high drain loads serving to protect and/or power down the circuit.

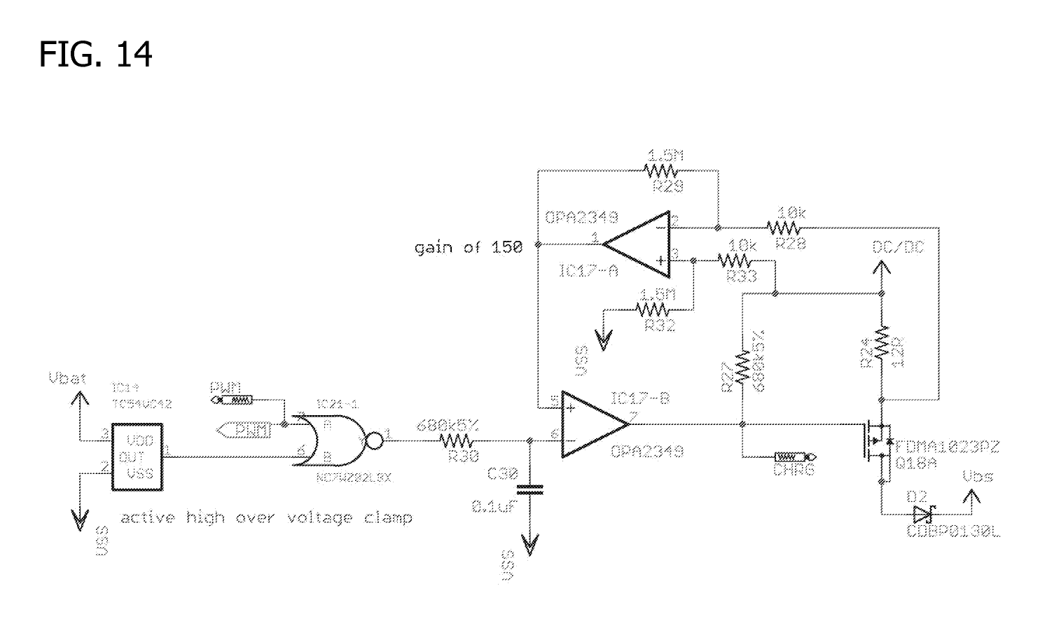

FIG. 14 shows exemplary circuitry embodying battery charging circuit 741 in accordance with aspects of the invention. The battery charging function is implemented through the microcontroller and a pair of op-amps with safety over voltage protection. A TC54VC42 voltage detector is placed across the battery 81 with the output connected to one input of a NC7WZO2 NOR gate and the PWM output of the microcontroller connected to the other. The voltage detector acts as an enable for the PWM signal. If the battery voltage is below 4.2 V, then the PWM is allowed to pass through the NOR gate only inverted. This signal is then smoothed through a low pass RC filter. The filtered signal then goes into the inverting terminal of one of the op-amps. The non-inverting terminal input comes from a differential op-amp that monitors the voltage across the current limiting charge resistor. The differential amp has no gain and references the voltage to Vₛₛ.

The referenced voltage is then compared to the inverted PWM signal. The output of the op-amp controls a FDMA1023PZ P-channel FET in the charge current path. The charge current path starts with V_{dc/dc} and travels through the charge resistor. Next it flows through the before mentioned MOSFET which acts as a variable resistor, and finally through a Schottky diode into the battery's positive terminal. This diode is to prevent any flow from the battery back to the V_{dc/dc} bus when in the shut down mode.

As described above, battery 81 provides power to supplement the normal output of device 1, as needed. This is particularly useful during conditions in which the load draws a greater amount of current, such as when starting, or powering up, an electronic device. In the illustrated embodiment, controller 71 monitors the voltage output of cells 721 and executes a comparator for comparing the voltage output to a minimum output reference voltage. If the monitored voltage output falls below this threshold, controller 71 switches on a battery assist, or hybrid, circuit for supplementing the output power. In this embodiment, battery 81 (e.g., a rechargeable lithium ion or lithium ion polymer battery), provides power to controller 71 to supplement the output of cells 721. Although illustrated as part of controller 71, it is to be understood that supplemental power circuitry may be a separate circuit connected to battery 81 and controller 71.

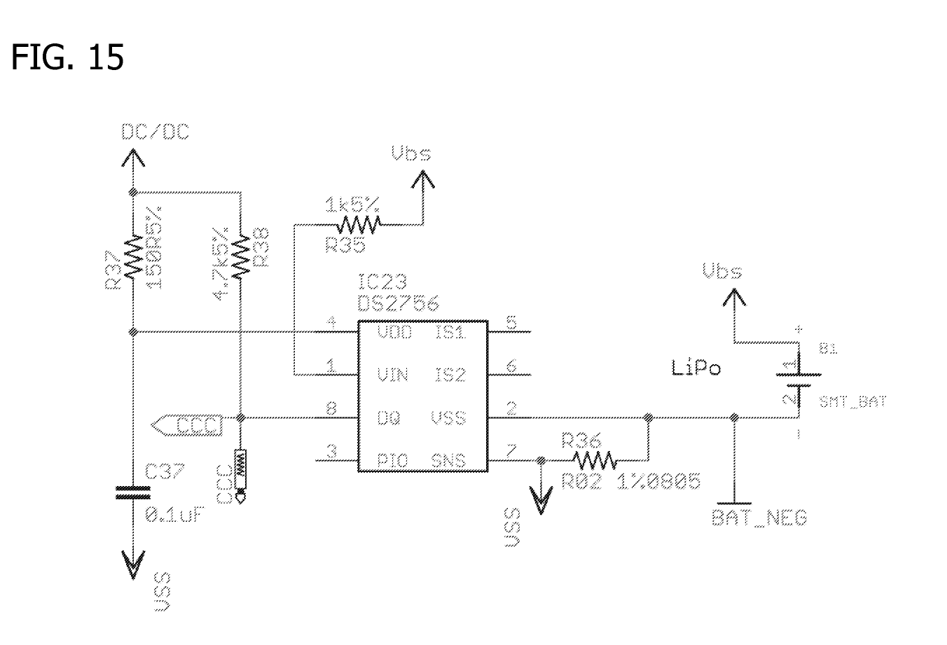

In a third defined operating mode, the microcontroller controls and monitors the charging of the battery. The microcontroller detects when ONA (see FIG. 8) is set high and discontinues the PWM signal to stop the charging. This is due to the increased load on the fuel cell 721, allowing power used to charge battery 81 to be diverted to the load. Also the microcontroller monitors the total charge and voltage of battery 81 via the DS2756 fuel gauge IC. FIG. 15 illustrates an exemplary embodiment of fuel gauge circuit 747. The DS2756 measures the temperature, battery voltage, battery charge/discharge current, and coulomb counts. Based on this information, the microcontroller can adjust the charging of battery 81 through the PWM signal.

The microcontroller also monitors various voltages and signals of the system and can override or make adjustments based on the readings. ONA and SHDN signals may be overridden, individual cell voltages are monitored, Iₘₒₙ can be read by the microcontroller allowing a load profile to be evaluated. The microcontroller is also signaled when there is a battery protection implemented or a fuel cell under voltage is detected. Based on these inputs, the microcontroller can override ONA and SHDN signals in order to maintain the output when either the fuel cell converter or the battery converter is incapable of providing the load based on insufficient input power. In general, the microcontroller controls system and hybridization functions relating to voltage monitoring, battery charging, current sensing, fuel cell pulse control, DC/DC converter control, ICMC control, vibration/pump control, and DAC control.

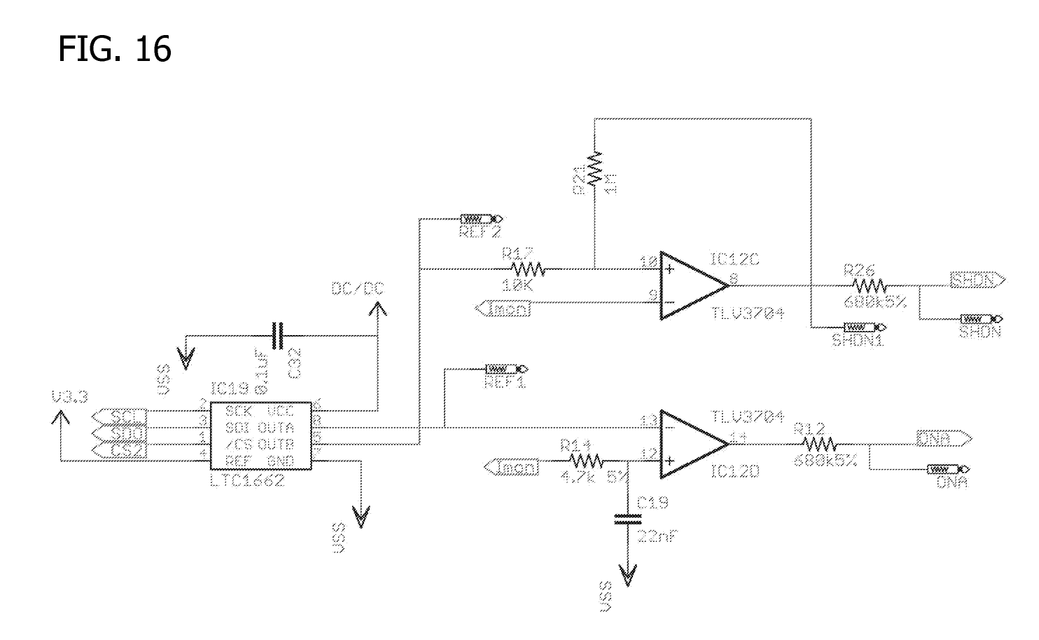

In addition, aspects of the invention involve output current monitoring circuit 753. An LT6106 (see FIG. 12), for example, monitors the output current to the load at 733. The LT6106 monitors the voltage created from the flow of current from V_{dc/dc} to the load across a current sense resistor and outputs an analog voltage according to the monitored voltage with a gain set by two resistors. Referring now to the exemplary schematic diagram of FIG. 16, this output voltage (Iₘₒₙ) is then fed into two TLV3704 comparators. On one comparator, Iₘₒₙ is fed directly into the inverting input; on the other comparator, the Iₘₒₙ voltage is first fed through a low pass RC filter to smooth the signal and remove any small instantaneous current transients before going into the non-inverting input. Set points for these comparators are generated using a LTC1662, one output per comparator.

The comparator of FIG. 16 with the low pass filter on the Iₘₒₙ input is a direct comparator since the low pass filter provides some amount of hysteresis; the output of which goes through an isolating resistor and becomes the microcontroller's ONA signal, which is active high. The isolating resistor is used because the ONA signal is also connected to the microcontroller which can override the signal as needed. In cases where the microcontroller overrides the signal, the resistor prevents shorting out of the comparator output or the microcontroller output. When not being overridden, the microcontroller puts the port pin into a high impedance state in order to not affect the signal.

The comparator with Iₘₒₙ on the inverting input has additional hysteresis added in order to prevent fast rate switching for voltages of Iₘₒₙ that are close to the threshold. The output of this comparator is also fed through an isolation resistor for the same reasons. This signal is an active low signal call SHDN.

The signal ONA is an active high signal used to enable the battery's DC/DC converter 743. The signal SHDN is an active low signal that also enables the battery's DC/DC converter 743, an active low signal that will disable the fuel cell DC/DC converter 731, and is also tied to a FDMA1023PZ P-channel FET on the output of the battery's DC/DC converter 743. Since the set points are controlled via a DAC, adjustments can be made based on known load values or measured loads. The purpose of monitoring the output current is to implement some automated hybridization of the fuel cell device 1 and its battery 81. The fuel cells 721 pick up and handle the low power steady state loads seen by the supply, while battery 81 will kick in and handle the high current draws when heavy load transients occur. This allows for a wider variation in load profiles that can be powered.

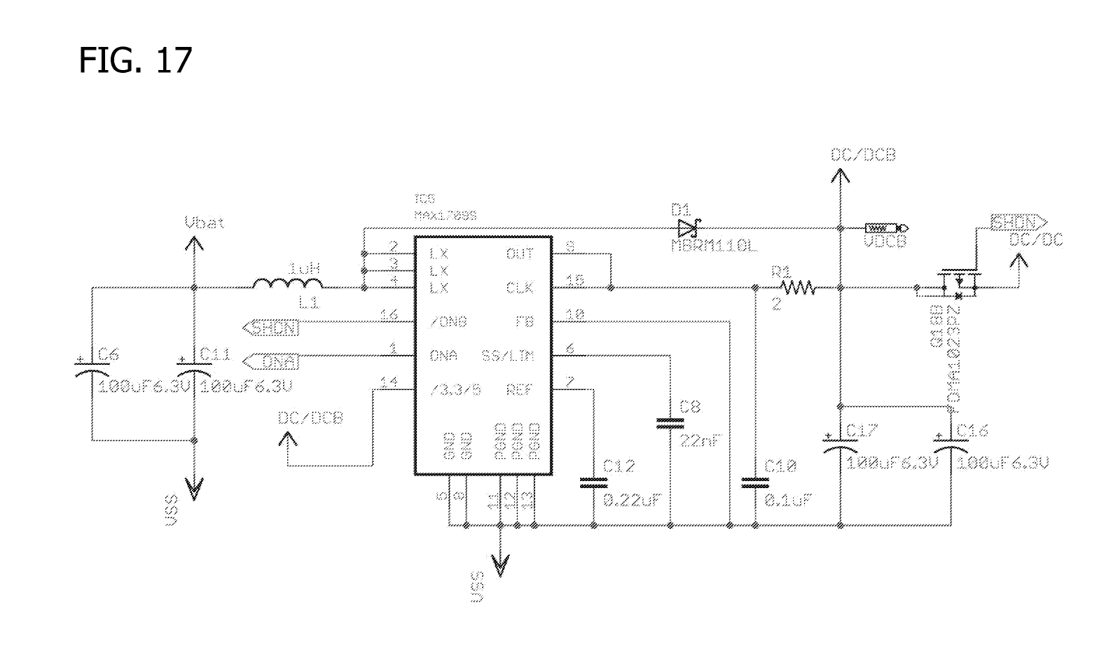

As described above, aspects of the invention include regulating the output of cells 721 (or the hybrid output of cells 721 and battery 81) provided to the output at 733. Regulated in this manner, fuel cell device 1 supplies a relatively constant voltage at its output that can be used on a variety of load specifications. It is to be understood that the output terminals 733 may be hard-wired to the load and connected to fuel cell device 1 via a plug or the like, or vice versa. As an example, a DC-DC converter circuit provides boost functionality. The battery DC/DC converter 743 is shown in FIG. 17 as a MAX1709 high power converter. A 1 μH high current power inductor is selected to handle heavy loads. The input and output capacitors are T520 series organic tantalum with low ESR. Two are placed in parallel on the input and the output in order to maintain a low profile for the completed PCBA. The diode is an MBRM110L Powermite Schottky diode able to handle high currents with a low forward voltage drop helping overall efficiency. Other discrete components are selected according to manufacturer's specifications as is familiar to one skilled in the art. The feedback and voltage select pins are set such that the output of the converter 743 is set to 5 V when the converter is enabled.

To enable converter 743, either ONA needs to be pulled high or SHDN needs to be pulled low. As described above with respect to output current monitoring circuit 753, both ONA and SHDN are used on the converter. The purpose for both of the enable controls being used is because the startup time for the converter is approximately 4-5 mS. This is enough time for the output to drop out when switching between the fuel cell converter 731 and the battery converter 743. The way the battery's converter 743 is set up, the ONA set point in output current monitor 753 is lower than the SHDN set point. When an intermediate load is observed, ONA is set high, enabling the battery's converter 743. However, there is a FDMA1023PZ P-channel FET on the output of the converter 743 with the gate connected to SHDN. Therefore, ONA will enable the converter and start the conversion process; however, the output is blocked from V_{dc/dc} and the load via the FET. Once the load transitions to a higher state, SHDN is set low disabling the fuel cell converter 731 and at the same time allowing the already enabled battery converter 743 to output to the load though the FET. This bypasses the startup time needed for the converter. SHDN is still connected to the battery converter 743 in case there is an instantaneous load transition that does not allow enough time for ONA to get the converter up and running (basically acts as a back up to the ONA signal).

As described above, aspects of the present invention in power down circuit 751. Referring again to the exemplary schematic diagram of FIG. 11, the active part of the power down circuit 751 is an A1171 Hall Effect sensor. This sensor in conjunction with a ¼″× 1/16″ NdFeB rare earth magnet with a Br Max of 12,800 Gauss puts the system into either a standby low power state (off) or an active state (on). This system allows long shelf life in a powered down state compared to a constantly on state. The Hall Effect sensor is powered through a low power 3.3 V voltage reference REF3333 (see FIG. 12). The 3.3 V reference voltage is within the operating parameters of the IC as well as high enough to trigger logic state changes in a 5V system. The voltage reference receives power from one of three sources depending on which is greatest. The three sources are directly from the battery 81, from the fuel cells 721, or from the output from the DC/DC converters 731, 743 (5 V). These sources are multiplexed through low current Schottky diodes in order to provide isolation between the sources with a minimal amount of forward voltage drop (typically 0.1 V-0.2 V at the quiescent currents drawn by the on/off control). This multiplexed source supply bus is denoted as Vₛᵤₚ and is used through various other parts of the system to power the control circuitry associate with power down and power up to ensure proper shut down and start up.

The outputs, PS and PN (active low and active high respectively) of the Hall Effect sensor, go to three circuits; the PS output acts as an enable of the circuit for the turning on of the fuel cell throughput, the PN output act as an enable of circuit for the battery protection, the PN output also goes to a MOSFET that when enabled shorts V_{dc/dc} to Vₛₛ. Operation of the fuel cell and battery enable actions are described above with respect to the fuel cell switching control 729 and battery protection circuit 739, respectively. The shorting of V_{dc/dc} to Vₛₛ prevents stray charges from accumulating on the V_{dc/dc} bus. In earlier fuel cell devices, these charges would accumulate to a magnitude that a significant voltage would appear on the bus which would then power up assorted integrated circuits with an improper voltage creating a high current draw circumstance. This is alleviated by shorting the minute stray charges to Vₛₛ before they create any hazardous voltages.

On/Off control is achieved by the position of the magnet with relation to the Hall Effect sensor. The magnet resides in a switch located just above the back of the battery. When the magnet is present above the Hall Effect sensor, activating the sensor, the system goes in to the “off” mode. Likewise, when the magnet is not present directly above the sensor the system is turned on by enabling both the fuel cell switching control and the battery protection circuitry. In one embodiment, the on/off switch 83 is machined on a TAIG 3-Axis CNC mill out of acrylonitrile butadiene styrene (ABS). The switch 83 consists of two pieces that are glued together. The top piece, which can be seen on the outside of the case, has the on/off label and the protrusion that is through the track. The bottom piece contains the magnet, which is pressed into a 0.25″ diameter hole that is 0.0625″ deep. The depth of the bottom piece is adjusted so there is approximately an 8 mm gap between the magnet and the Hall effect sensor on the circuit board 73. A track is machined into the stereolithography (SLA) case to guide the on/off switch 83 for a 180° rotation of the magnet. The track has two locked positions, on and off, which are achieved by having a pinch point at both ends of the track.

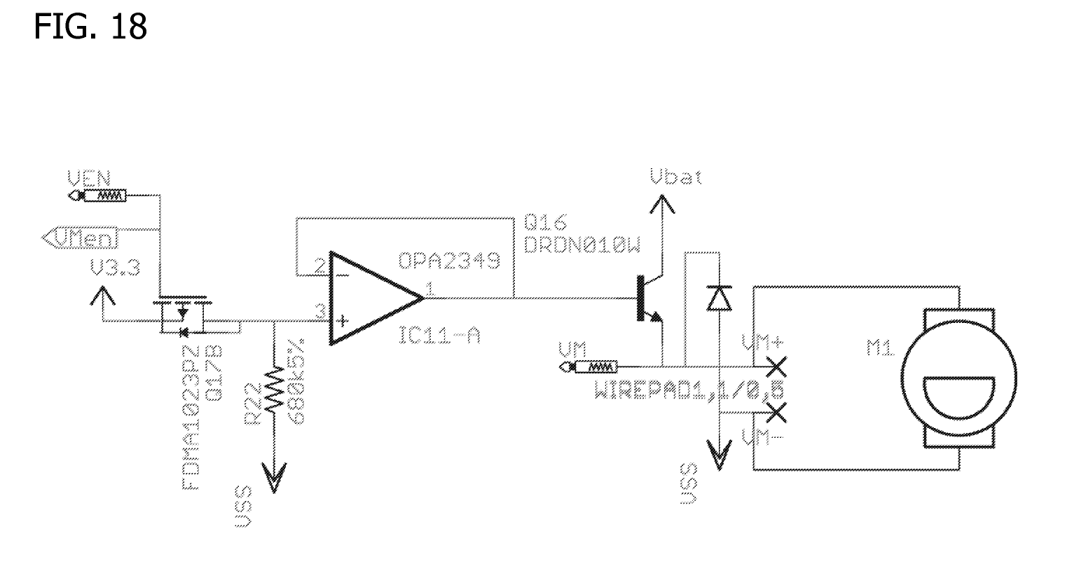

Referring now to FIG. 18, controller 71 achieves vibration motor control 745a circuit consisting of one FET of a dual FDMA1023PZ P-channel MOSFET, an operational amplifier and DRDN010W BJT transistor. An enable signal from the microcontroller turns on the P-channel FET, which connects the output of a 3.3 V voltage reference to the non-inverting input of the impedance buffer op-amp. The output of the op-amp is then connected to the base of the transistor, the collector connected to the protected battery bus V_{bat}, and the emitter connected to the positive terminal of the motor (the other terminal of the motor connected to Vₛₛ). The internal diode that is paired with the transistor in the DRDN010W is connected across the terminals of the motor to shunt inductive spikes that may occur. The base signal of the transistor is 3.3 V, which dictates that the emitter also be approximately 3.3 V in a voltage follower configuration. The base signal of 3.3 V is within the specifications for the vibration motor 735 (e.g., motor Z4KL2B0280001). When the enable signal is not present the input of the impedance buffer is pulled low through a resistor connected to Vₛₛ to ensure the vibration motor remains disabled.

It is to be understood that the vibration motor control circuitry 745 and concept can also be applied to a pump for the fuel, making the fuel cell device 1 an active system. Although there may be some variance of the circuit to supply a pump, the concept of running a pump and running the vibration motor are very similar in desired benefit to the fuel cell as well as the implementation of the control circuitry.

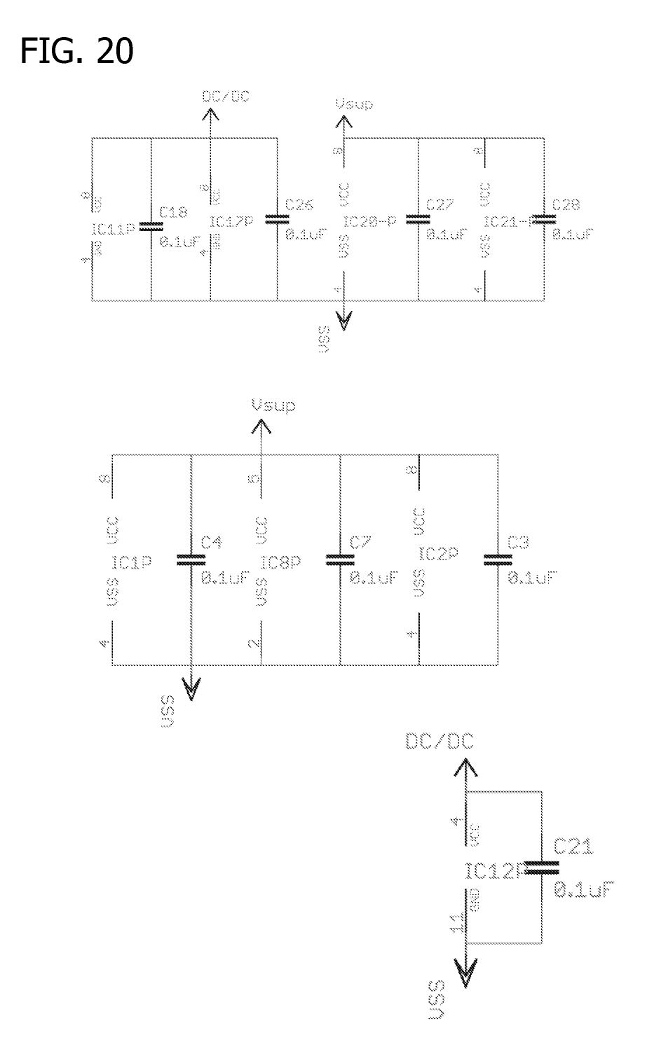

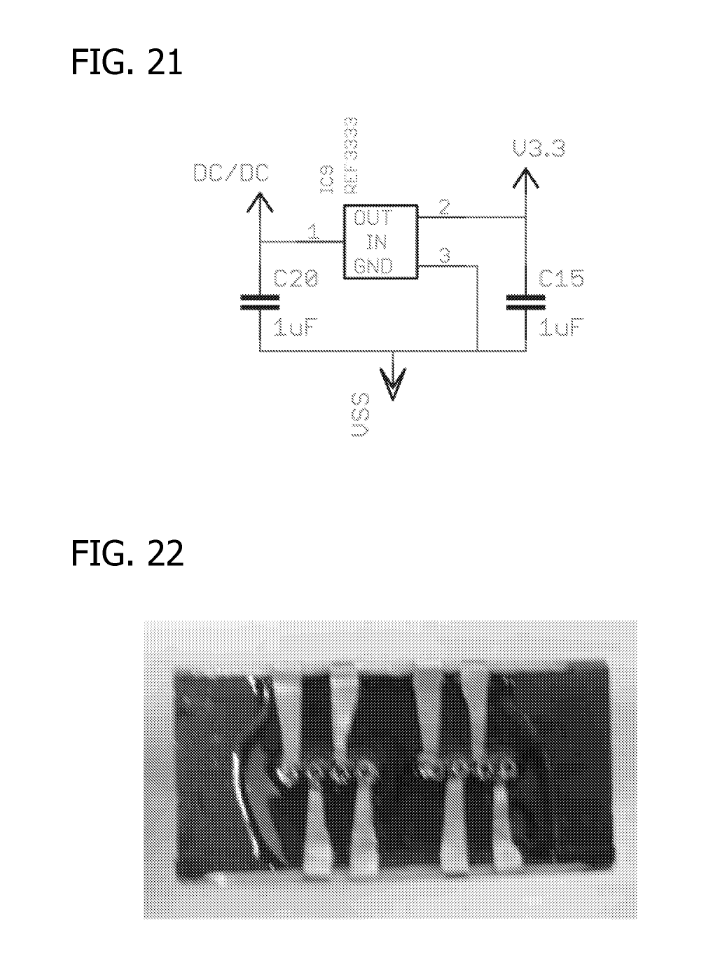

FIG. 20 illustrates exemplary power blocks for the microcontroller of FIG. 8 in the form of a schematic diagram. FIG. 21 illustrates an exemplary voltage reference for the DAC of FIG. 16 in the form of a schematic diagram.

The operating modes described above, including the duty cycles, are exemplary and those skilled in the art will recognize that other operating modes may be defined without deviating from the scope of the invention depending on the requirements of the load and the physical construction (e.g., the number of cells) of fuel cell device 1.

In one embodiment, fuel cell device 1 makes its electromechanical interconnections via spring pins, as shown in FIG. 22. Spring pins provide the electrical and mechanical connection between the printed circuit board (PCB) 73 and the fuel cell (FC) stack 721. Spring pins having diameters of, for example, 0.0625″ provide adequate structural support for the mechanical interface preventing board movement, allowing adequate work room for assembly of the FC housing 91, and to ensure ample current conducting capabilities. The spring pins are assembled into the FC housing 91. Controlled depth holes are predrilled into the housing 91. After the stacks 45, 47 are attached to the housing 91, nickel shim leads for each of the cells are trimmed down and inserted into the holes. After insertion of the nickel shim, the spring pins are placed into the holes. The holes in the housing are drilled such that the spring force of the pin presses the shim against the wall of the hole ensuring good electrical contact as well as good mechanical contact. As shown in FIG. 22, the nickel shim from the electrodes as well as the base of the spring pins are then covered with, for example, Dow Corning 1-2577 conformal coating to reduce the risk of salts wicking up the shim to the board 73. In one embodiment, the spring pins are secured into the housing.

The drill depth of the holes is such that the top of the pins will flush mount with the top of the PCB 73 once assembled; the overall goal being to either flush mount the board onto the stack or to position the output connector of the printed circuit board assembly (PCBA) with the corresponding port of the enclosure. The spring pin order is arranged such that the electrode stacks are uniform and exchangeable for either side of the reservoir, as shown in FIG. 22. This allows for a single design of the electrode stack to be needed as well as allowing the PCBA to be mounted in either direction. Also the pins are alternated between cells of opposite sides of the reservoir to reduce the risk of shorting out a cell with such close placement.

Referring further to FIG. 22, a top-view of stacks 45, 47 shows a conformal coating and alternating current collector configuration. Corresponding holes are located on the PCB 73 to complete the electromechanical assembly of the PCBA to the completed FC assembly. The PCB 73 plated holes are dimensioned to 0.0064″, for example, to account for tolerances of the spring pin as well as the completed hole width of the PCB manufacturing process. The PCB 73 is mounted to the fuel cells 721 such that the top/exposed end of the spring pins are flush with the bottom side of the PCB 73 (i.e., the top of the assembly). This allows a slim profile with the Lithium Polymer (LiPo) battery 81 to lay flush on the backside of the PCB 73 in the allotted space.

### Housing

The housing 91 is desirably of multi-part construction to facilitate assembly and disassembly of the fuel cell device 1. In one embodiment (FIGS. 2-4), the housing comprises first and second parts 91A, 91B which, when combined, form an enclosure having a volume sufficient to snugly receive the stacked components of the fuel cell device 1. The two parts are secured 91A, 91B together in a releasable manner by one or more fasteners (e.g., hex head bolts 275) or other mechanical means. A gasket or other sealing device (not shown) seals the joint between the two parts 91A, 91B when they are secured together. The housing 91 has at least one opening 277 for allowing delivery of fuel fluid from a fuel source to the inlet 29 of the manifold. The housing may be molded, machined or otherwise fabricated from a suitable material such as acrylic.

As illustrated in FIGS. 3 and 13, projections 285 on the inside surfaces of the housing parts 91A, 91B provide support for the electrode structure of the fuel cell device, i.e., the fuel manifold 15 and anode-cathode assemblies 45, 47 to provide proper support and positioning of these components inside of the housing. Some of these projections 285 may also define locations, e.g., compartments 289, 291, for receiving the electronic controller 71 and power circuit 81. Alternatively or in combination, recesses may be formed in the interior surfaces of the housing to receive these components.

### Closed System Carbon Dioxide Venting

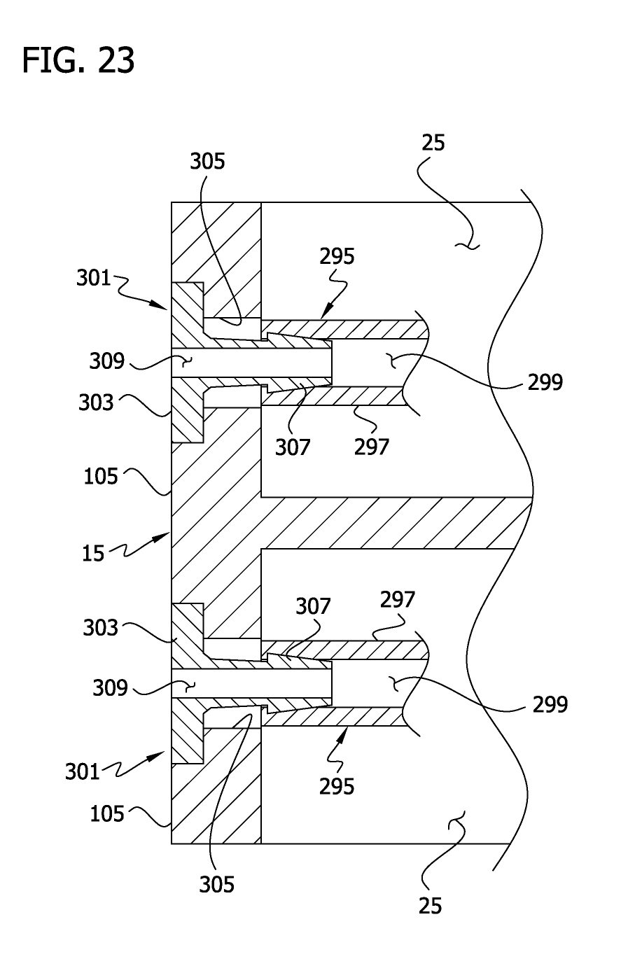

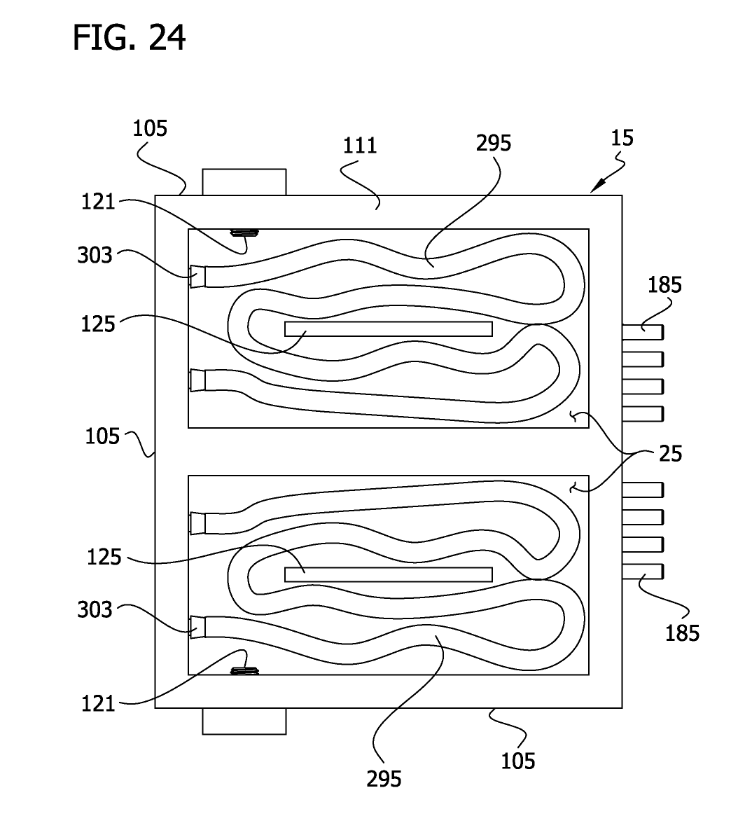

During operation of a fuel cell device 1 involving the use of precious metal based anode catalyst, such as Pt Ru on carbon, methanol in the fuel reservoir 25 will be oxidized to carbon dioxide gas at the anode 163. The manifold 15 is equipped with a system for venting any such carbon dioxide. As illustrated best in FIGS. 23 and 24, this system comprises vent tubing 295 in each fuel reservoir. The vent tubing 295 comprises a tubing side wall 297 defining an interior space 299. The tubing 295 has opposite ends communicating with a pair of vent ports 301 in the manifold, such as in a side wall 105 of the manifold 15. The tubing 295 is of a material which is permeable to carbon dioxide gas but impermeable to the fuel in the reservoir 25 so that carbon dioxide passes through the side wall 297 of the tubing into the interior space 299 of the tubing and exits the vent ports 301 for exhaust to atmosphere or other location for disposal. The length of the tubing 295 in each reservoir should be sufficient to remove carbon dioxide gas generated during operation of the fuel cell device 1 under normal operating conditions. By way of example but not limitation, the tubing may be of silicon, such as tubing sold under the trade designation Tygon having a wall thickness of about 0.018 in. and an outside diameter of about 0.065 in., or tubing sold under the trade designation Versilic SPX-50 having a wall thickness of about 0.031 in. and an outside diameter of about 0.094 in. Calculations indicate that Tygon silicon tubing having a length of about 13.5 cm per fuel reservoir 25 or Versilic SPX-50 tubing having a length of about 6.6 cm per fuel reservoir 25 is sufficient to remove carbon dioxide gas generated at actual fuel cell operating conditions (15 mA constant load per stack) with a pressure differential of 0.5 psi.

The configuration of the vent tubing 295 in a fuel reservoir 25 can vary. By way of example, the vent tubing 295 can be one continuous length of integral tube looped or otherwise configured to fit the fuel reservoir, as shown in FIG. 23. Alternatively, the tubing 295 may comprise multiple separate tubes traversing the fuel reservoir 25, each tube having its own set of vent ports 301 in the fuel reservoir housing wall. Still further, the tubing in a particular fuel reservoir 25 may be closed at one end and open at an opposite end for communication with a vent port 301 in the fuel reservoir housing wall. Other venting configurations are possible.

In the embodiment of FIG. 24, each vent port 301 comprises a vent port fitting 303 received in a countersunk bore 305 through a respective side wall 105 of the manifold 15. The fitting has a barbed end 307 which fits inside a respective end of the vent tubing 295 to secure the tubing to the fitting 303. The fitting 303 is solvent welded or otherwise suitably attached to the manifold 15 to seal the bore 305. Carbon dioxide gas in the vent tubing exhausts through a vent passage 309 extending through the fitting 303 from one end of the fitting to the other. Other vent port configurations are possible.

### Operation of Device

In operation, fuel is delivered to the fuel cell device 1 from the source 9 by suitable means (e.g., a syringe or pump) until the fuel reservoirs 25 are filled and the fuel fluid contacts respective anodes 157. As in a standard electrochemical cell, the anode is the site for an oxidation reaction of a fuel fluid with a concurrent release of electrons and protons. The electrons are directed from the anode through an electrical connector to some power consuming device. The protons move through the fuel fluid and polyelectrolyte membrane to the biocathode. The electrons move through the device to another electrical connector, which transports the electrons to the biofuel cell's biocathode where the electrons are used along with the protons to reduce an oxidant (in this case oxygen from air) to produce water. In this manner, the biofuel cell of the present invention acts as an energy source (electricity) for an electrical load external thereto. To facilitate the fuel fluid's redox reactions, the electrodes comprise a current collector, a electron conductor, optionally an electron mediator, optionally an electrocatalyst for the electron mediator, a catalyst (at least one of the cathode or anode catalyst comprises an enzyme), and an enzyme immobilization material when the catalyst comprises an enzyme.

At the anode, the fuel fluid reacts with the catalyst to produce the oxidized form of the fuel fluid and the catalyst releases electrons to the anode to generate electricity.

At the biocathode, electrons originating from the anode flow into the cathode's current collector and electron conductor. There, the electrons contact an enzyme capable of gaining electrons from the electron conductor and reacting with an oxidant to produce an oxidized form of the enzyme and water.

### Passive Fluid Management System

Referring to FIGS. 2 and 5, the fuel cell device 1 includes a passive fluid management system 501 in the housing 91 for controlling at least one of moisture and temperature conditions inside the housing, and desirably both moisture and temperature conditions inside the housing. It has been found that controlling such conditions may substantially increase the efficiency of the fuel cell device 1. While the device 1 has four cells, it will be understood that the passive fluid management system 501 can be used with a fuel cell device having any number of cells.

In general, the passive fluid management system 501 includes a number of air holes 503 in the housing 91 and an air-permeable layer 507 positioned between each anode-cathode assembly and an adjacent wall of a respective part 91A, 91B of the housing 91. Two such layers 507 are shown in FIGS. 2 and 5, a first or front layer between the front wall of the housing 91 and the two front anode-cathode assemblies or stacks 45 and a second or back layer between the back wall of the housing and the two back anode-cathode assemblies or stacks 47. The layers 507 desirably have moisture barrier properties (e.g., moisture impermeability) for retaining moisture inside the housing in the environment adjacent the biocathodes to prevent or at least inhibit deterioration of the device due to low humidity conditions. In this regard, low humidity conditions can result in the formation of salt crystals on the biocathodes leading to reduced efficiency or even failure of the fuel cell device. By retaining moisture in the environment adjacent the biocathode, the relative humidity (“RH”) in these areas is maintained at a relatively high level, e.g., desirably at least about 40% RH and even more desirably at least about 50% RH. As a result, the run-time of the fuel cell device is increased substantially (a 400% increase in one instance). In addition, or alternatively, the layers 507 have thermal barriers properties for insulating the internal components of the fuel cell device from temperature changes in the environment surrounding the housing 91.

In the embodiment of FIGS. 1-5, the two layers 507 are thin (e.g., 0.009 in.-thick) layers of an air-permeable, moisture-impermeable material such as melt-blown polypropylene. Desirably, the layers 507 are also impervious to alkali exposure. Other suitable air-permeable, water-impermeable materials may be used.

The layers 507 may be secured, as by adhesive, to the anode-cathode assemblies 45, 47. Alternatively, the layers 507 may be secured to inside surfaces (e.g., projections 285) of the housing. To achieve good moisture retention on the biocathodes, the layers 507 should be positioned on or closely adjacent respective biocathodes. In particular, the gap between each layer and a respective biocathode is desirably in the range of 0-100 mils. Even more desirably, this gap is no larger than a drop of water collecting on the surface of a biocathode. While each layer 507 is shown as being a one-piece layer spanning two cathode assemblies 145, it will be understood that the layer 507 could be divided into separate pieces for separately covering each cathode assembly 145.

In general, the air holes 503 allow air to circulate in the housing for proper functioning of the anode-cathode assemblies or stacks 45, 47. However, it is desirable to limit the number of air holes 503 in the housing 91 to help insulate the internal components of the housing from temperature variations and to help retain moisture in the housing. In one embodiment, each air hole is centered over a respective stack 45, 47 and has a flow area of about 0.02 cm² compared to a biocathode area of about 8.7 cm². These areas can vary. Also by way of example but not limitation, the number of air holes 503 in the housing may be limited to no more than two air holes per biocathode 177. In the embodiment of FIGS. 1-5, only one air 503 hole is provided for each biocathode 177. The air holes 503 are desirably evenly distributed on the housing 91 over respective biocathodes 177.

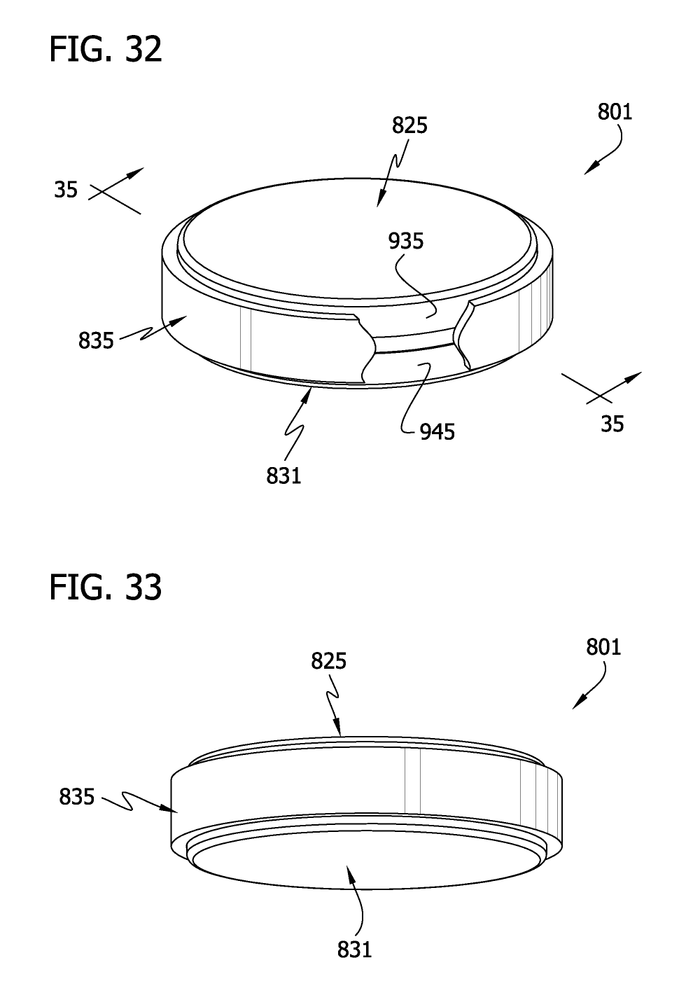

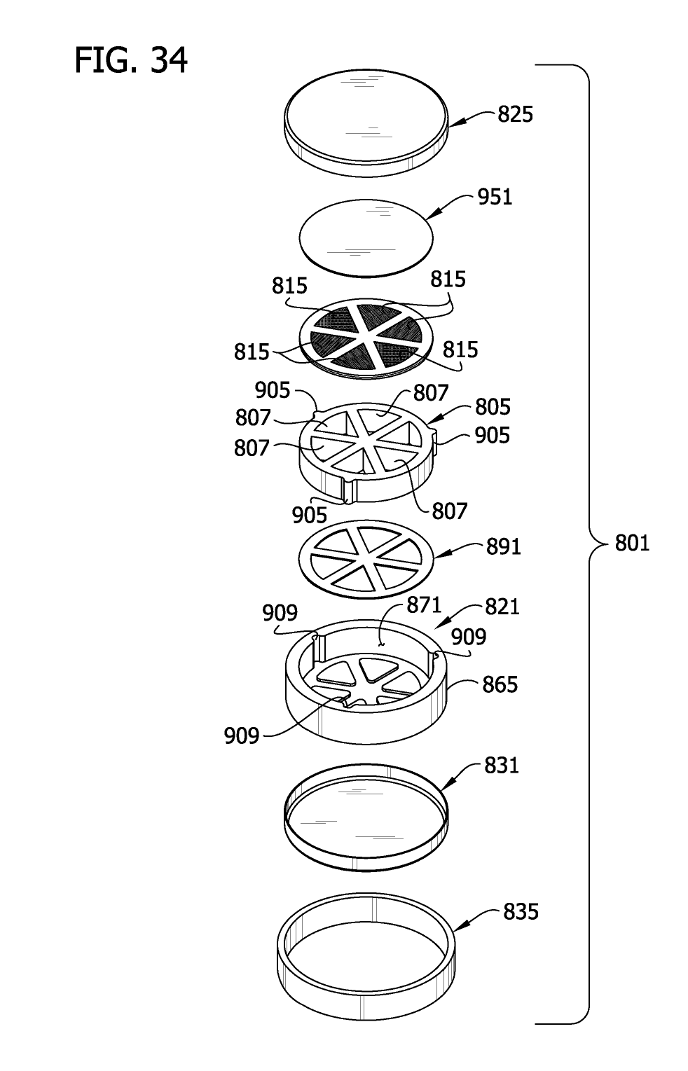

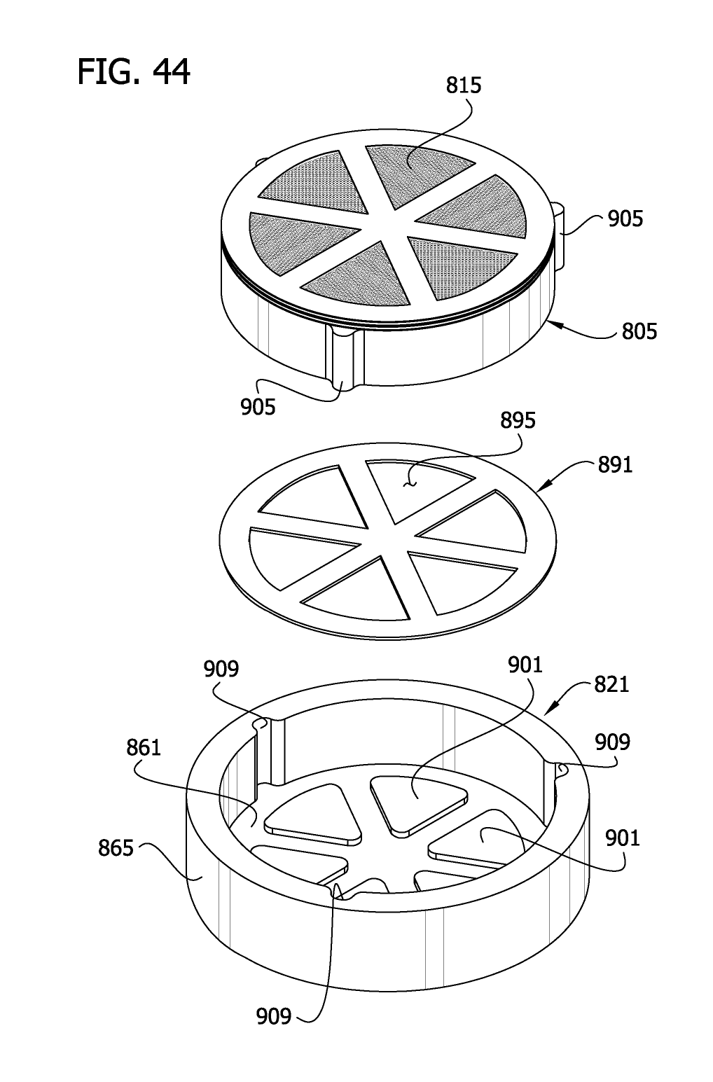

FIGS. 32-53 show a biofuel coin cell device, generally designated 801, for generating electrical current. The device 801 is intended to be used in the same manner as conventional coin cell (button cell) batteries. In general, the coin cell device 801 comprises a reservoir body 805 defining at least one reservoir 807 adapted for containing biofuel, and at least one anode-cathode assembly 815 on the reservoir body. The anode-cathode assembly 815 comprises at least one anode positioned for contact with fuel fluid in the reservoir 807 and at least one biocathode positioned for flow of fuel fluid through the anode to the membrane (or separator). In the illustrated embodiment, the reservoir body 805 includes a plurality of reservoirs 807 (e.g., six reservoirs) and a plurality of anode-cathode assemblies 815 (e.g., six assemblies), one for each reservoir, but this number may vary. The coin cell device 801 also includes a reservoir end cap 821, an external cathode terminal 825 and an external anode terminal 831. A retaining ring 835 holds the various components in assembly, as shown in FIG. 34. Each of these components is described in more detail below.

The construction of the anode-cathode assemblies 815 is similar to the construction of the anode-cathode assemblies 45 described above, and corresponding parts are designated by corresponding reference numbers. The materials described in the “Alternative Materials for Biocathodes” and the “Alternative Materials for Anodes” sections above are appropriate for use in the anode-cathode assemblies 815 described below.

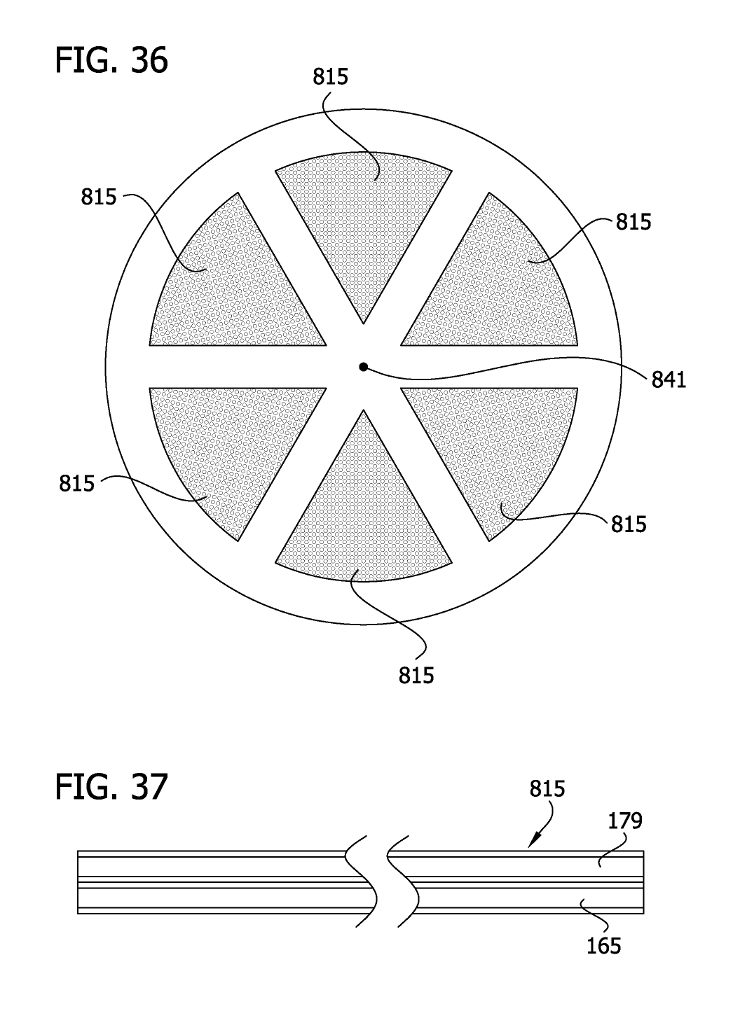

In the illustrated embodiment, the anode-cathode assemblies 815 are arranged in a generally planar circular array around a central axis 841 (FIG. 36), with each assembly 815 having a shape generally matching a sector of a circle, similar to a piece of pie. The number of assemblies 815 in the array and the shape of the array may vary without departing from the scope of this invention. Desirably, the anode-cathode assemblies 815 are mechanically integrated to form a single structural unit. In particular, the biocathodes 177 of the assemblies are mounted on a common cathode frame 179, and the anodes 163 of the assemblies are mounted on a common anode frame 165, and the two frames are joined together as previously described to form a unitary structure (FIGS. 36 and 37). Alternatively, the anode-cathode assemblies 815 may be formed as separate mechanical structures.

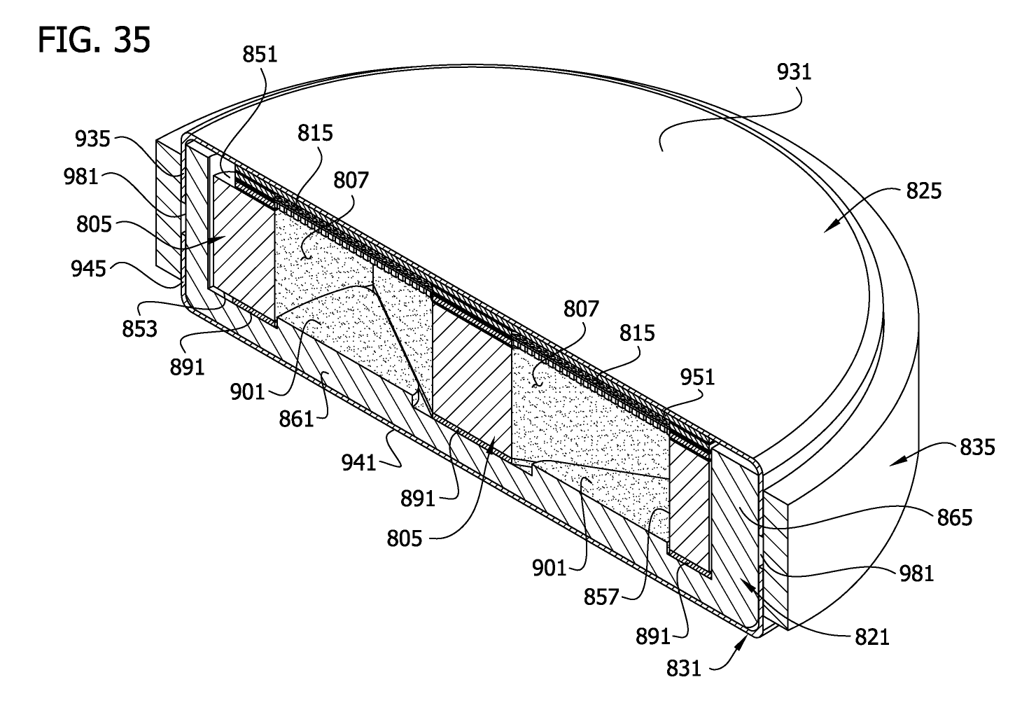

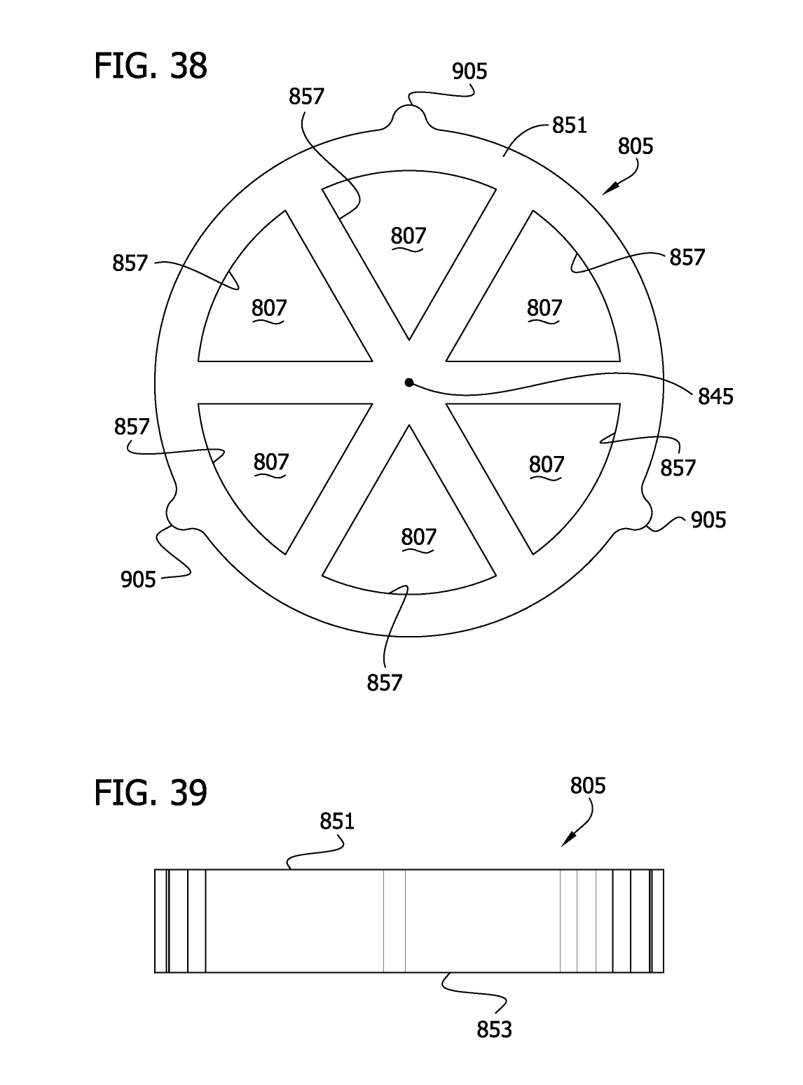

As shown in FIGS. 38 and 39, the reservoir body 805 is generally cylindrical and has a central axis 845 substantially coincident with the axis 841 of the circular array of anode-cathode assemblies 815. The reservoir body 805 has a first end face 851 facing the cathode terminal 825 and a second end face 853 facing the anode terminal 831. The reservoirs 807 in the body 805 are formed by openings 857 extending axially through the body from the first end face 851 of the body 805 to the second end face 853 of the body 805. Each reservoir 807 has a size and shape generally corresponding to the size and shape of a respective anode-cathode assembly 815 (i.e., sector-shaped in the illustrated embodiment). The anode-cathode assemblies 815 are disposed on the first end face 851 of the reservoir body with the anode of each assembly in contact with fuel in a respective reservoir (see FIG. 35). The anode-cathode assemblies 815 are affixed in place to the first end face 851 of the reservoir body 805 by suitable means, such as adhesive or a solvent weld (e.g., tetrahydrofuran). The reservoir body 805 may have other sizes and shapes within the scope of this invention. In one embodiment, the biofuel coin cell device 801 has six reservoirs 807, each having a corresponding anode-cathode assembly 815 for defining a “cell.” For example, each cell has an electrochemically active area of approximately 0.360 cm² with a fuel reservoir containing 0.15 cm3 fuel solution. Electrically connecting the cells in series increases the voltage across the cathode and anode terminals.

In use, the reservoirs 807 are filled with a suitable fuel solution. This fuel solution serves as the primary source of fuel and an electrolyte. In order to have the electrolyte, a fuel is mixed with a metal hydroxide maintaining an alkaline environment. Some desirable characteristics of the fuel are low toxicity, shipping ease, and safety. The fuel solution can be a metal hydride, hydrocarbon, alkanols, or combinations thereof. In certain embodiments, the fuel solution is a combination of a metal hydroxide, and a liquid or soluble fuel. Particularly suitable fuels are glycerol, methanol, ethanol, butanol, propanol, glycol, sodium borohydride, hydrazine, borazane, glucose, fructose, and sucrose. In one suitable embodiment using palladium-ruthenium directly reduced onto nickel foam via sodium borohydride, a zirconium doped polysulfone membrane, and a mixed metal phthalocyanine and laccase cathode, glycerol concentrations of 20% and 50% were tested with 20% potassium hydroxide, in a passive air breathing configuration. The biofuel coin cell device 801 demonstrated full voltage addition in series with an open circuit approximately approaching 5.0V.

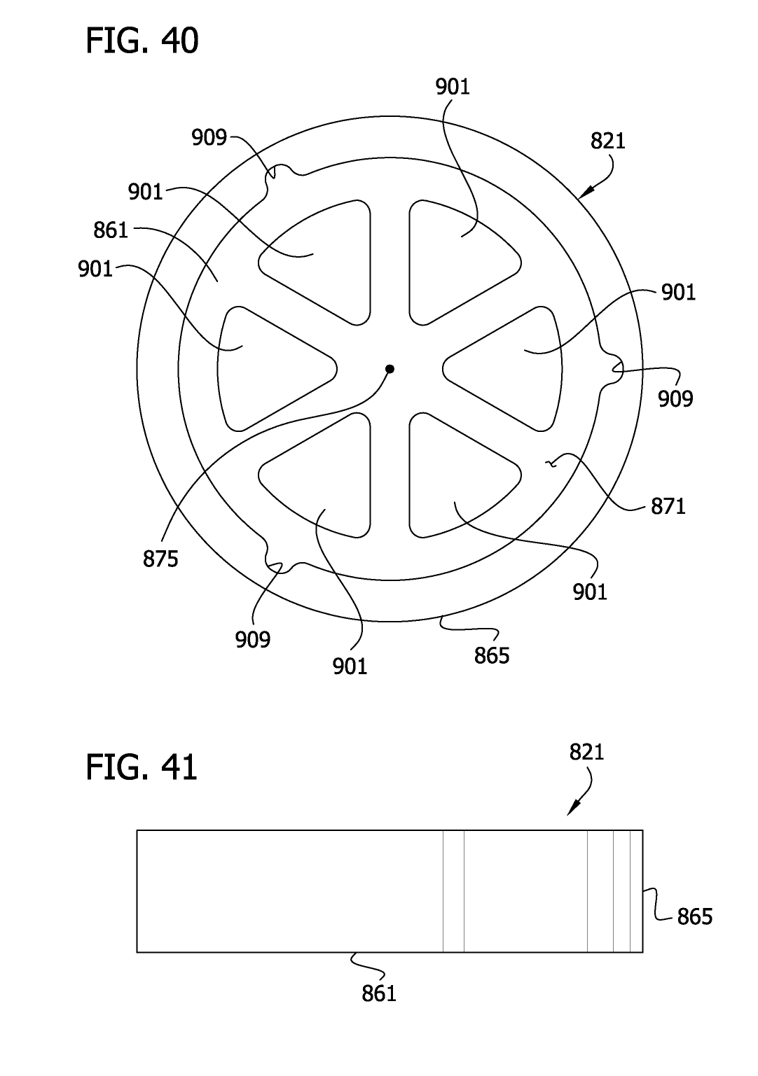

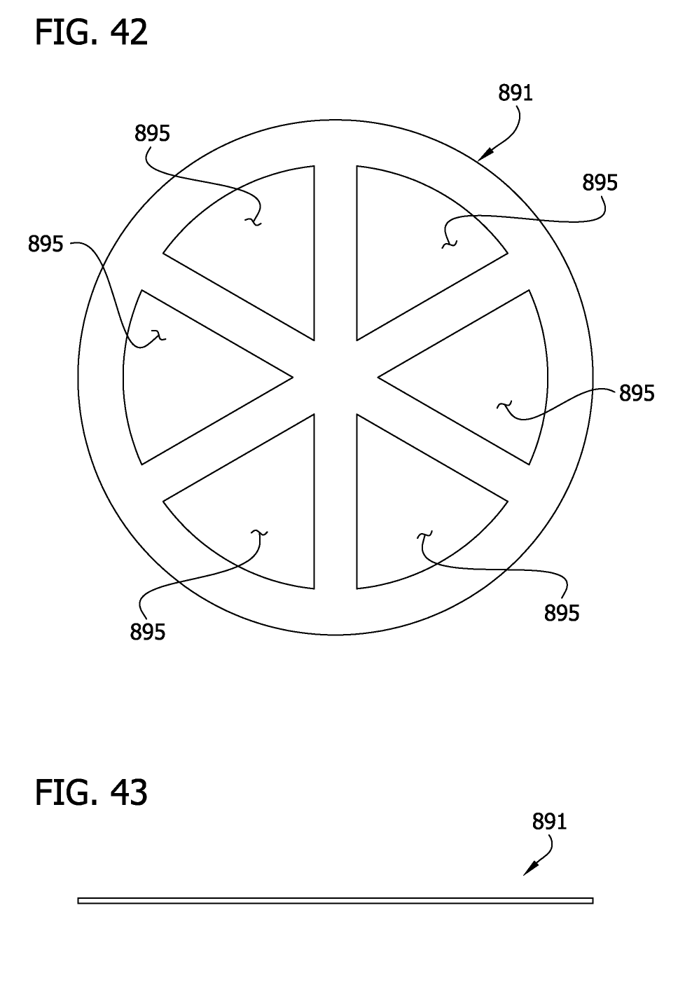

Referring to FIGS. 40-44, the reservoir cap 821 comprises an end wall 861 adjacent the anode terminal and a circumferential side wall 865 extending from the periphery of the end wall 861 to define a cavity 871 for receiving the reservoir body. In this embodiment, the side wall 865 is generally annular (cylindrical) in shape and has a central axis 875 generally coincident with the axis 845 of the reservoir body 805. The fit of the reservoir body 805 in the cavity 871 is a relatively close clearance fit. A sealing member 891 (FIGS. 42 and 43) is provided inside the cavity 871 in a position between the end wall 861 of the reservoir cap 821 and the second end face 853 of the reservoir body 805. The sealing member 891 is also sized for a relatively close fit in the reservoir cap 821 and has a plurality of openings 895 corresponding in number, size and shape to the reservoir openings 857. The sealing member 891 is compressed between the end wall 861 of the reservoir cap 821 and the second end face 853 of the reservoir body 805 and functions to seal the separate reservoirs 807 from one another, thus preventing the leakage of fuel from one reservoir to another and from the reservoir cap. A number of bosses 901 project from the inside surface of the end wall 861 of the reservoir cap 821 through the openings 895 in the sealing member 891 to hold the sealing member in position during assembly (see FIG. 35). To insure proper alignment between the reservoir 821 cap and the reservoir body 805, a number of alignment members 905 project laterally out from the reservoir body 805 for reception in axial grooves 909 in the annular wall 865 of the reservoir cap 821. Other alignment mechanisms may be used. With the alignment members 905 in the grooves 909, the reservoir body 805 is moved into the cap 821 to a position in which the sealing member 891 is compressed to form a tight seal. In this position, the bosses 901 on the end wall 861 of the cap 821 may extend a short distance into the reservoir openings 857. The reservoir body 805 and cap 821 are then affixed to one another, as by friction lock, solvent weld, mechanical hardware, adhesive, and/or sonic welding or other suitable means. Desirably, the fit of the alignment members 905 in the grooves 909 is a relatively tight press fit, which assists in maintaining compression of the sealing member 891 until the reservoir body 805 and cap 821 are secured to one another.

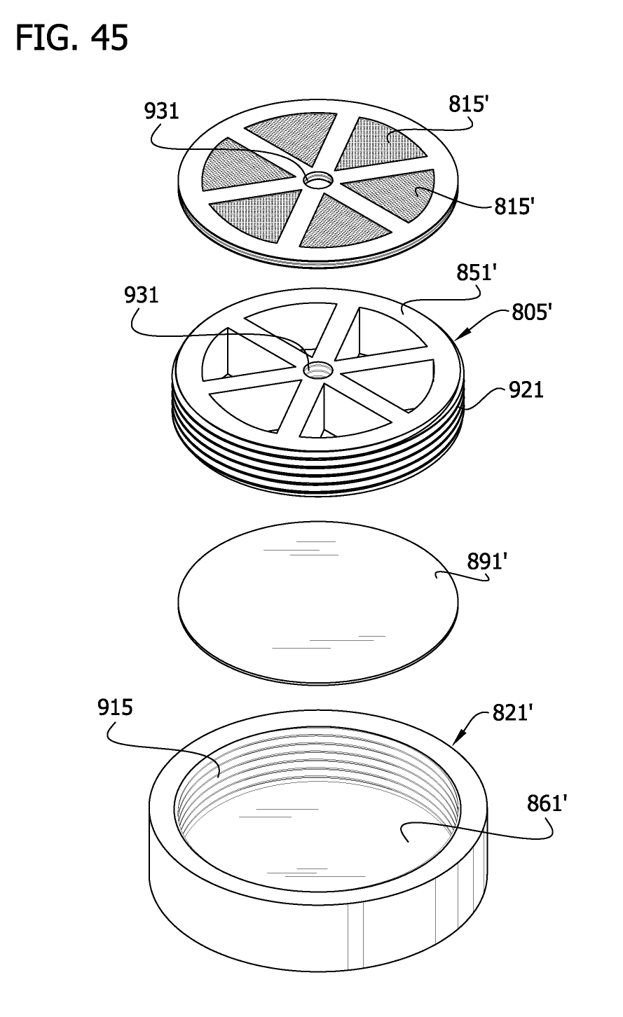

FIG. 45 illustrates a second embodiment in which the reservoir cap 821′ and reservoir body 805′ have mating threads indicated at 915 and 921, respectively. In this embodiment, the sealing member 891′ is compressed by threading the reservoir body 805′ into the reservoir cap 821′ using a suitable tool such as an Allen wrench fitted into a recess 931 extending through the center of the array of anode-cathode assemblies 815′ into the first end face 851′ of the reservoir body. The outside surface of the end wall 861′ of the reservoir cap 821′ may be slotted (not shown) to hold the cap against rotation as the reservoir body 805′ is turned. An advantage of using threads is that a significantly higher compressive force can be maintained on the sealing member 891′ separating the fuel reservoirs for the individual cells. One disadvantage is that a threaded system may require larger components.

The reservoir body 805, 805′, reservoir cap 821, 821′ and sealing member 891, 891′ are of a suitable dielectric (electrically non-conductive) material that is chemically resistant to and compatible with the fuel being used. In an exemplary embodiment, the sealing member 891, 891′ is a membrane of PTFE material, such as the type sold under the trade designations Mupor® or Porex®.

The reservoir cap 821, 821′ provides structural support for the sealing member 891, 891′ to effectively seal the fuel in the reservoir(s) 807. In other embodiments, the structural support needed may be provided by structure other than the reservoir cap 821, 821′ described above. In still other embodiments, such support may not be needed.

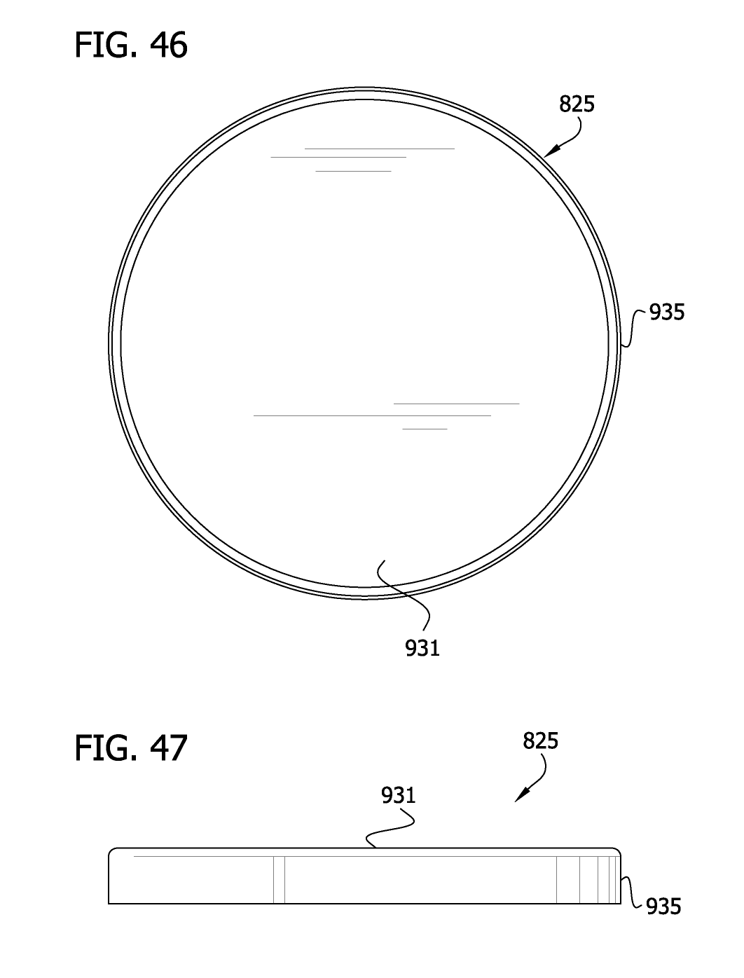

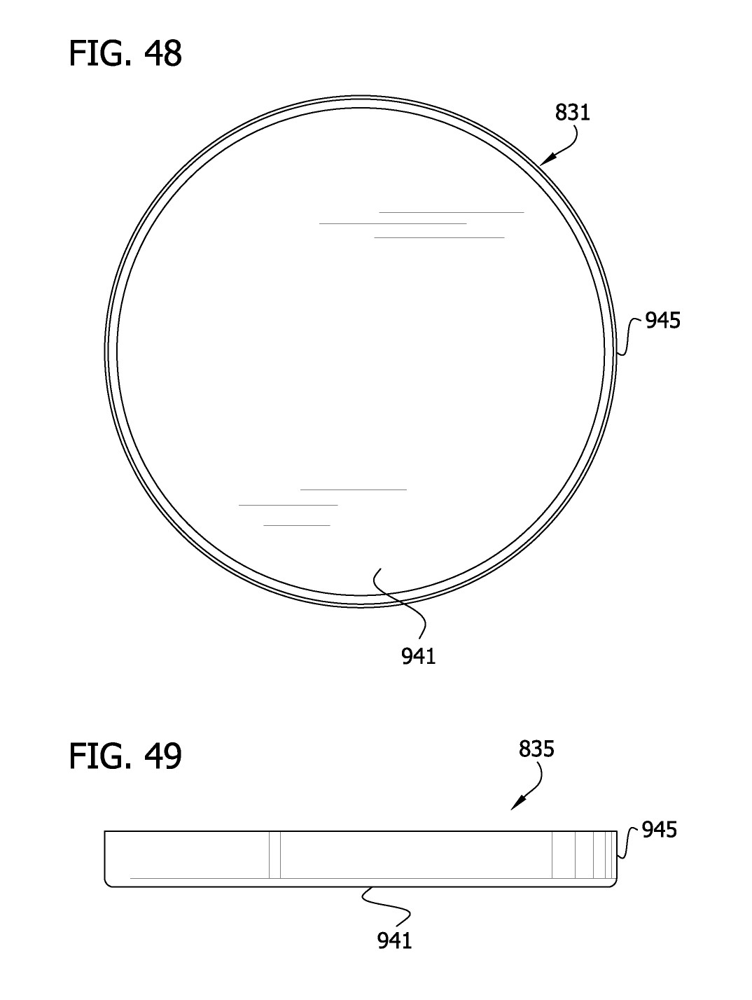

The external cathode terminal 825 is of an electrically conductive (or semi-conductive), air-permeable, liquid-impermeable material, such as expanded stainless steel. As shown in FIGS. 46 and 47, the terminal 825 comprises an end wall 931 and a circumferential side wall 935 extending from the end wall toward the anode terminal 831. Similarly, the anode terminal 831 (FIGS. 48 and 49) comprises an end wall 941 and a circumferential side wall 945 extending from the end wall toward the cathode terminal 825. In the illustrated embodiment, the anode terminal 831 is of an electrically conductive (or semi-conductive), air-impermeable, liquid-impermeable material, such as stainless steel. Alternatively, the material may be air-permeable, like the cathode terminal. Other materials may be used.

An air-permeable, liquid-impermeable membrane 951 is positioned between the array of anode-cathode assemblies 815 and the end wall 931 of the cathode terminal 825. The membrane 951 functions as a moisture barrier (like the barrier 507 described above in previous embodiments) for retaining moisture inside the coin cell device in the area of the biocathode(s) to prevent or at least inhibit deterioration of the device due to low humidity conditions.

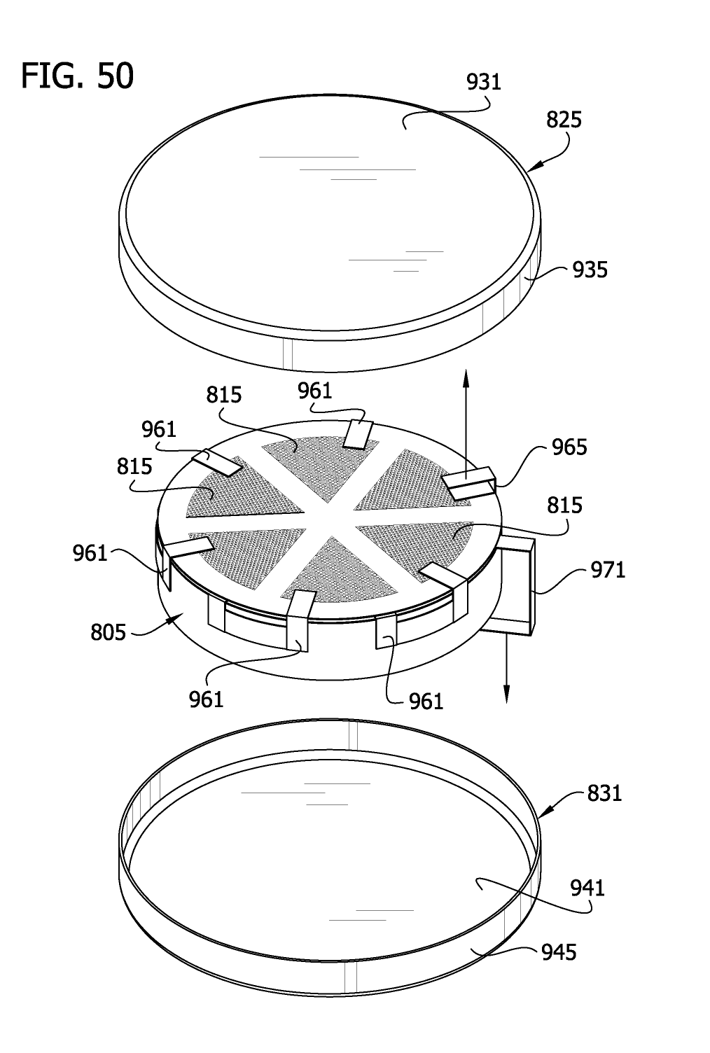

As described above, the biofuel coin cell device 801 in one embodiment has a generally circular design with a plurality of sector-shaped cells. Individual cells are electrically connected in series around the circumference of the circle. Referring now to FIG. 50, the anode-cathode assemblies 815 are electrically connected one to another in series by any suitable electrically conductive means. In the illustrated embodiment, metal tabs 961, or leads, connect the anode of one anode-cathode assembly 815 to the biocathode of an adjacent anode-cathode assembly 815. The electrical connection of the anode-cathode assemblies 815 of the biofuel coin cell device 801 to the two external terminals 825, 831 (one supply and one return path) is also through the use of metal tabs, or leads. For example, a cathode lead 965 electrically connects at least one of the biocathodes of the anode-cathode assemblies 815 to the cathode terminal 825 and an anode lead 971 electrically connects at least one of the anodes of the anode-cathode assemblies to the anode terminal 835. The external anode and cathode terminals 825, 831 are constructed from a metal that provides good electrical conductivity as well as has good structural integrity. Such metals include but are not limited to stainless steel, steel, nickel, silver, gold, aluminum, and copper. As will be understood by one of ordinary skill in the art, each of the leads 965, 971 from the anode-cathode assemblies 815 is soldered or spot welded to the corresponding external terminal. Similarly, tabs 961 and leads 965, 971 are constructed from a good electrical conductor. As an example, nickel shims are suitable tabs 961 and leads 965, 971.

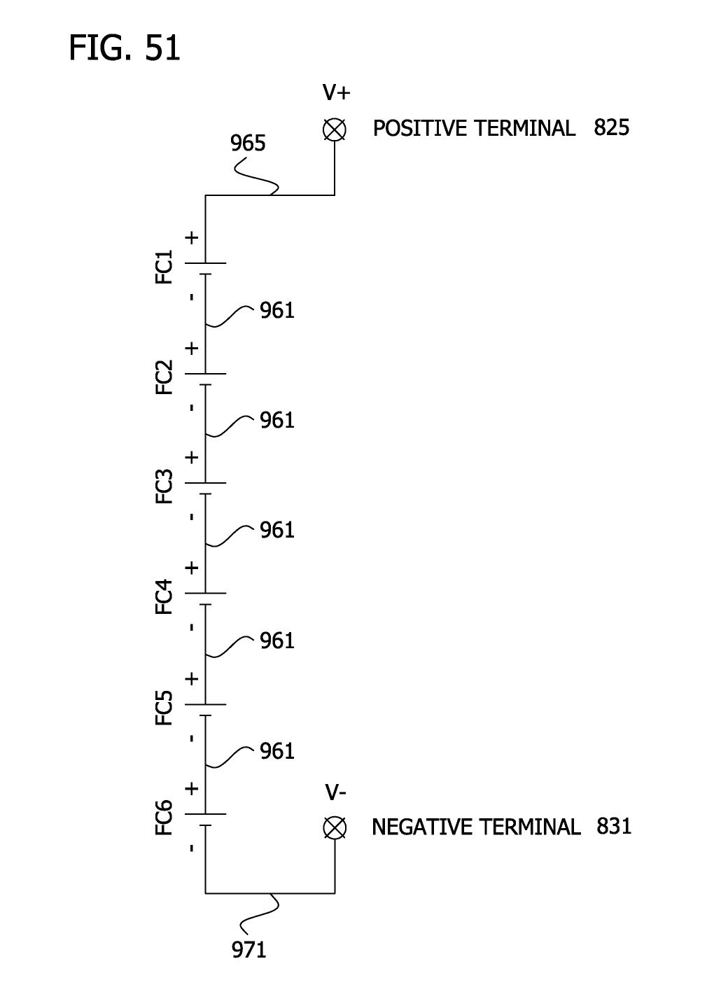

FIG. 51 shows an exemplary series connection of the cells (i.e., reservoirs 807 and corresponding anode-cathode assemblies 815).

According to an exemplary manufacturing process, two pieces of 10 mil thick PEI frames (see frames 179, 165) are cut using a frame die cutter. Two pieces of hot melt are placed on one side of frame 165, which is then placed in a hot press at 125° C. and 1000 lbs between two steel plates for 10 seconds. Excess hot melt is then trimmed off. The same step is repeated for the other side of the frame 165. The frame 165 is then placed such that the side that has two pieces of hot melt faces down. An electrode corresponding to each anode of the anode-cathode assemblies 815 are placed facing up and hot pressed at 125° C. and 1000 lbs for 10 seconds. Again, excess hot melt is trimmed off. This is repeated with frame 179 for the electrodes corresponding to the biocathodes of the anode-cathode assemblies 815. Using a membrane/current collector die cutter, for example, a polysulfone anion exchange membrane is cut for each cell of the biofuel coin cell device 801. A piece of hot melt is allowed to soften on the anode-side electrode facing up and one of the membranes is then placed over each electrode. The cathode frame 179 is then placed on top of the anode frame 165 with catalyst side facing down carefully aligning each electrode. This stack is then placed in the hot press at 125° C. and 1000 lbs for 10 seconds and allowed to cool. Excess hot melt is again trimmed off.

Referring further to the exemplary manufacturing process, two current collectors are cut out for each cell using the membrane/current collector die cutter. In an embodiment of the biofuel coin cell device 801 having six cells, twelve current collectors are used. As an example, nickel expanded metal is a suitable current collector. Referring further to the six-cell example, seven nickel shims (see tabs 961 and leads 965, 971) are spot welded on or otherwise electrically connected to separate current collectors. In one embodiment, the nickel shims are 0.125 inch wide×0.003 inch thick trimmed to 0.050 inch wide and having a length of 0.680 inches. One of the two-piece assemblies (current collector and shim) is placed over a corresponding one of the six anode electrodes and they are hot pressed at 125° C. and 1000 lbs for 10 seconds. Once the anode current collectors are secured, five of the nickel tabs 961 are folded over to electrically connect the anode current collector of one cell to the cathode current collector of an adjacent cell in series, as shown in FIG. 50. The remaining lead 971 extending from the anode-side of the anode-cathode assemblies provides a means for connecting the assemblies to the external anode terminal. The remaining five current collectors are placed onto the cathode electrodes with the folded over tab 961. The final two-piece assembly (current collector and lead) is then placed on the remaining cathode electrode (without a folded tab) and hot pressed at 125° C. and 1000 lbs for 10 seconds to form lead 965.

In this example, two pieces of hot melt are placed on surface 851 of the fuel reservoirs 807 and melted using a heat gun. Once the hot melt has formed a glue bead, the final stack assembly is placed on top (cathode side up) and is manually pressed together. The hot melt is then allowed to cool.

The electrical connections of the biofuel coin cell anode-cathode assemblies 815 to the external terminals 825, 835 can be made with any electrically conductive/semi conductive material that allows the power generated by the fuel cell to be passed to the external terminals without deviating from the scope of the invention. This includes but is not limited to soldering, spot welding, welding, pressure connections, and the fabrication of one solid piece of material that forms both the path for the power from the anode-cathode assemblies and the external terminals.

Referring further to FIG. 50, the biofuel coin cell device 801 in one embodiment has a plurality of sector-shaped cells electrically connected in series. It is to be understood that alternatively the cells may be connected in any combination of series and/or parallel configurations. The connections between cells are preferably made during manufacturing such that final fabrication involves making one connection to each of the external terminals.

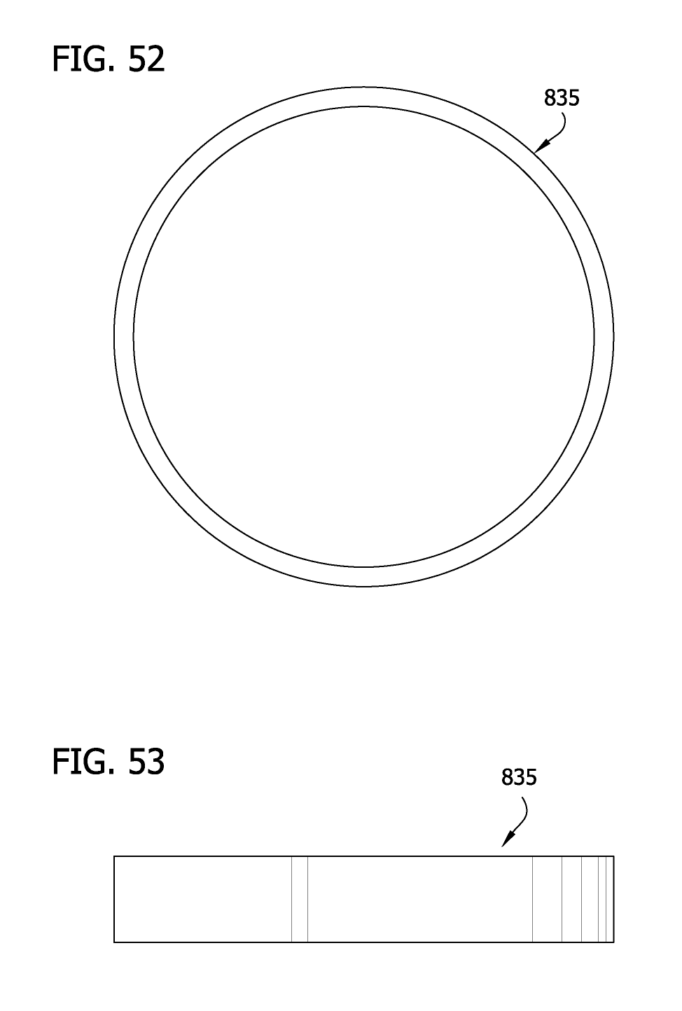

FIGS. 52 and 53 illustrate one embodiment of the retaining ring 835. The external cathode and anode terminals 825, 831 are held in assembly with the internal components of the coin cell device 801 (i.e., the array of anode-cathode assemblies 815, reservoir body 805, reservoir cap 821 and membrane 951) by the retaining ring 835. The ring 835 extends circumferentially around the annular side walls 935, 945 of the terminals 825, 831 and bridges any gap (axial space) between the two side walls. An exemplary gap is indicated at 981 in FIG. 35. The ring 835 retains the terminals 825, 831 in position relative to one another, and seals the interior of the device. The retaining ring 835 is of an electrically non-conductive material, such as a suitable plastic, and has compressive press fit with the side walls 935, 945 of the terminals. The retaining ring 835 may be additionally secured in place by suitable means such as friction lock, solvent weld, mechanical hardware, adhesive, and/or sonic welding or other suitable means. By way of example, after the parts of the coin cell device 801 have been assembled, a solvent weld (e.g., tetrahydrofuran) can be applied to the seams between the retaining ring and the external terminals. To insure that the solvent does not come in contact with the anode-cathode assemblies, a paint brush can be utilized to paint the solvent onto exterior surfaces of the device.

An activation component may be provided to prevent air from reaching the air-breathing biocathodes of the device prior to use of the device by an end user. In one embodiment, this component comprises a removable air-impermeable cover (not shown) positioned over the air-permeable external cathode terminal 825, e.g., at the time the device is manufactured. When the device is ready for use, the end user simply removes the cover to allow the passage of air through the terminal. If both terminals are air-permeable, then an air-permeable removable covers can be placed over both terminals.

Storage of the biofuel cell device 801 (i.e., the entire coin cell device) for short and/or long term durations can be performed by enclosing the biofuel cell device 801 in a gas and liquid impermeable membrane, partially or fully evacuating the air from the enclosure, and then sealing the membrane. In one embodiment, the membrane is configured like a bag. After the biofuel cell device 801 is placed in the bag, air is evacuated from the bag and then the bag is heat sealed. The preferred storage method for the biofuel cell device 801 is with the membrane (e.g., the bag) hydrated through but not limited to the washing with water and draining of the fuel cell, fuel sealed in the reservoir, or water added to the reservoir.

The fuel cell being stored under vacuum conditions prevents the fuel cell from reacting, thus preserving the life of the cell and preventing carbonate from forming in the electrodes. Storage in a membrane enclosure under hydrated conditions has shown to prevent damage to the fuel cell through the buildup of salts. Fuel cells that have been vacuum sealed under hydrated conditions and then air transported have shown no detriment to the performance of the fuel cells.

Having described the invention in detail, it will be apparent that modifications and variations are possible without departing from the scope of the invention defined in the appended claims.

### EXAMPLES

The following non-limiting examples are provided to further illustrate the present invention.

### Example 1

### Biocathode in Cathode Assembly

The biocathode was fabricated in three configurations: (1) with a tetrabutylammonium bromide modified Nafion® immobilized laccase enzyme on Printex 95 carbon black and cocatalysts, (2) with cocatalysts only, and (3) with a tetrabutylammonium bromide modified Nafion® immobilized laccase enzyme on Printex 95 carbon black only. The transition metal phthalocyanine particles were mechanically mixed into the catalyst ink along with enzyme immobilized on carbon black and painted onto an electron conductor.

### Example 1A

Copper phthalocyanine (20 mg), 20 mg iron phthalocyanine, 20 mg nickel phthalocyanine, 20 mg cobalt pthalocyanine, 20 mg 15% tetrabutylammonium bromide modified Nafion® encapsulated laccase on Printex 95 carbon black, 400 mg Monarch 1400 carbon black, and 1.4 mL 5% Nafion® solution were combined, and sonicated with a sonicating dismembrator. The metal phthalocyanines were not treated by pyrolysis or any other pretreatment before being mixed into the ink solution. The ink was then painted onto a 25 cm² electrode support structure and allowed to dry in an open air environment.

### Example 1B

Copper phthalocyanine (20 mg), 20 mg iron phthalocyanine, 20 mg nickel phthalocyanine, 20 mg cobalt phthalocyanine, 400 mg Monarch 1400 carbon black, and 1.4 mL 5% Nafion® solution were mixed and a catalyst ink was prepared using the process in Example 1A. This catalyst ink was painted onto a 25 cm² electrode support structure and allowed to dry in an open air environment.

### Example 1C

Tetrabutylammonium bromide modified Nafion encapsulated laccase on printex 95 (80 mg; 15 wt. % laccase), 400 mg Monarch 1400 carbon black, and 1.4 mL 5% Nafion® solution were mixed and a catalyst ink was prepared using the process in Example 1A. This catalyst ink was painted onto a 25 cm² electrode support structure and allowed to dry in an open air environment.

The immobilized laccase in TBAB modified Nafion on Printex 95 was prepared as follows. Printex 95 carbon black (1 g), 166 mg laccase, 7.0 mL 0.5M phosphate buffer solution at pH 7.2, and 1.33 mL of 15% tetrabutylammonium bromide modified Nafion® were used to prepare the immobilized laccase. Laccase enzyme was dissolved in phosphate buffer solution (pH 7.2, 0.5 M) and then mixed with 1 g of Printex 95 carbon black. This enzyme/carbon slurry was vortexed with 6 ZrO beads (3 mm diameter) for 5 minutes. Then, tetrabutylammonium bromide modified Nafion® solution (15 wt. % in ethanol) was added and vortexed with 6 ZrO beads (3 mm diameter) for 5 minutes. This mixture was spray dried at room temperature (open to ambient air) and allowed to dry for 2 hours.

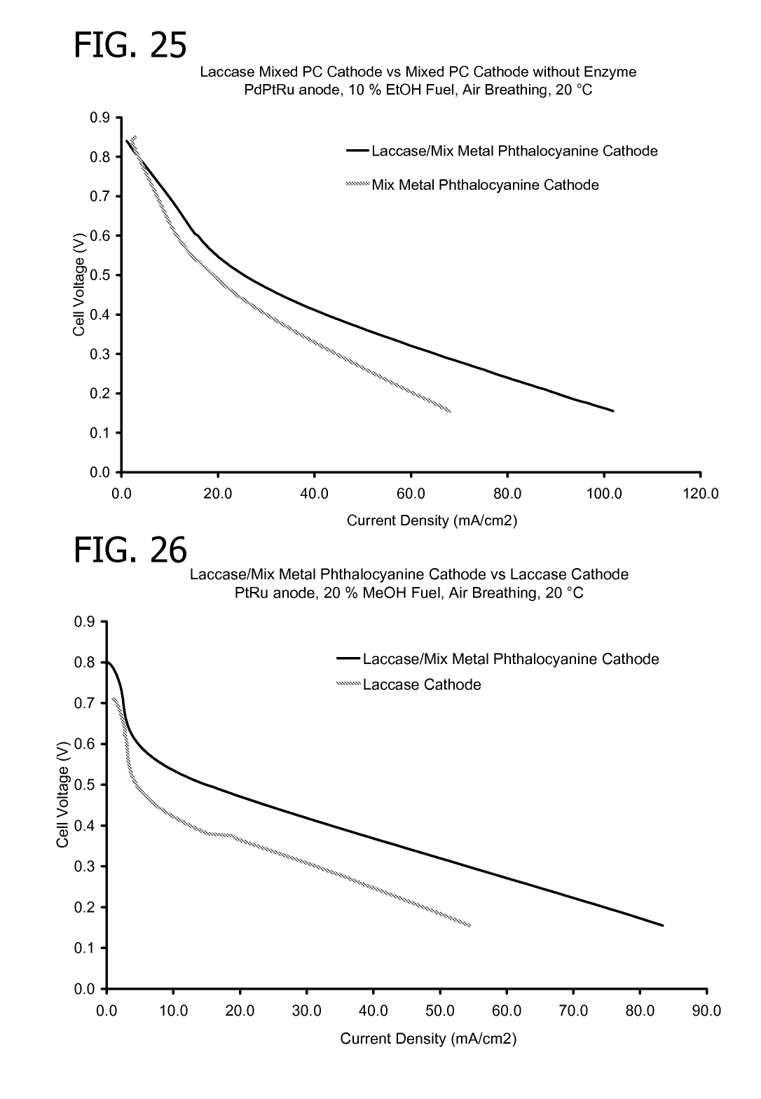

The biocathodes described in Examples 1A-1C were tested using a zirconium oxide doped polysulfone alkaline exchange membrane prepared as described in Example 2. When the fuel was methanol, a platinum ruthenium anode was used. When the fuel was ethanol, a palladium platinum ruthenium anode was used. A comparison of the biocathodes of Example 1A and Example 1B is shown in FIG. 25. The graphs show that higher current densities were obtained when two or more catalyst having different open circuit potentials were used. In the mixed metal phthalocyanine portion of each biocathode, the phthalocyanines were chosen for their differing oxidation/reduction potentials that create a stair stepping effect to achieve catalytic response across the entire operating voltage of the fuel cell.

A comparison of the electrodes described in Example 1A and Example 1C is shown in FIG. 26. The laccase and cocatalyst cathode gave the better current density yield. In this case an increased open circuit was observed due to the higher oxidation/reduction potential of the metal phthalocyanine in comparison to the laccase. The fuel used for the experiment shown in FIG. 25 was 10% ethanol and the fuel used for the experiment shown in FIG. 26 was 20% methanol. Thus, when combined with an alkaline exchange membrane, the cocatalyst cathode can be used in a fuel cell using ethanol or methanol.

The platinum-ruthenium anodes (5.13 cm²) were prepared as follows. Platinum-ruthenium (50 wt. %) nominally on high surface area carbon (0.1 g), 0.2 mL 18 M-ohm deionized water, and 0.2 mL 5 wt. % Nafion® solution in ethanol were used to prepare the PtRu anode. First, water was added to the catalyst or catalyst mixture and sonicated with a sonicating dismembrator. The water was added first to reduce the reaction of the catalyst with the solvent of the Nafion® solution. Next, the Nafion® solution was added and the ink was sonicated with a sonicating dismembrator and painted with an artist brush onto the 5.13 cm² nickel foam. The ink was evenly distributed until the entire solution was applied and each ink layer was allowed to dry before the next layer was added.

The Palladium Platinum Ruthenium Anode (5.13 cm²) was prepared as follows. Platinum-ruthenium (50 wt. %) nominally on high surface area carbon (0.75 g), 0.75 g palladium black, 0.2 mL 18 M-ohm deionized water, and 0.2 mL 5 wt. % Nafion® solution in ethanol were used to prepare the PdPtRu anode. The procedure described in for the platinum-ruthenium anode was used wherein the platinum-ruthenium and palladium black was mixed with water before the Nafion® solution was added.

### Example 2

### Potassium Hydroxide doped Zirconium Oxide embedded Polysulfone Anion Exchange Membrane Preparation

A 20 wt. % polysulfone in N-methylpyrrolidone (NMP) mixture was prepared by heating the mixture to 100° C. using a metal stir bar in a 250 mL pyrex graduated reagent bottle. Zirconium (IV) oxide (20 grams) was combined with 20 grams of 20 wt. % polysulfone in NMP and was mixed by short pulses using the sonic dismembrator wand. The mixture was allowed to sit for 1 hour. The zirconium oxide embedded mixture (4 mL) was placed onto a dry mirror-finished 12 inch×12 inch aluminum plate. Using a glass rod the solution was rolled to form a 5 inch by 5 inch, 8 mm thick membrane. The membrane was then rinsed off with deionized water and soaked in deionized water for 1 hour. The membrane was then dried using paper towels and was further pressed between two: steel plates, EPDM rubber sheets, and teflonized sheets at conditions of 3 tons at 125° C. for 2 minutes to achieve the desired 3 mm thickness. The thinner membrane was then soaked for 24 hours in 50% KOH solution. Typical performance of this membrane with 20 wt. % KOH in the fuel solution is shown in FIG. 27, also shown in this Figure is a membrane with an aminated polysulfone as a permanent replacement of the zirconium oxide.

### Example 3

### Aminated Polysulfone AEM

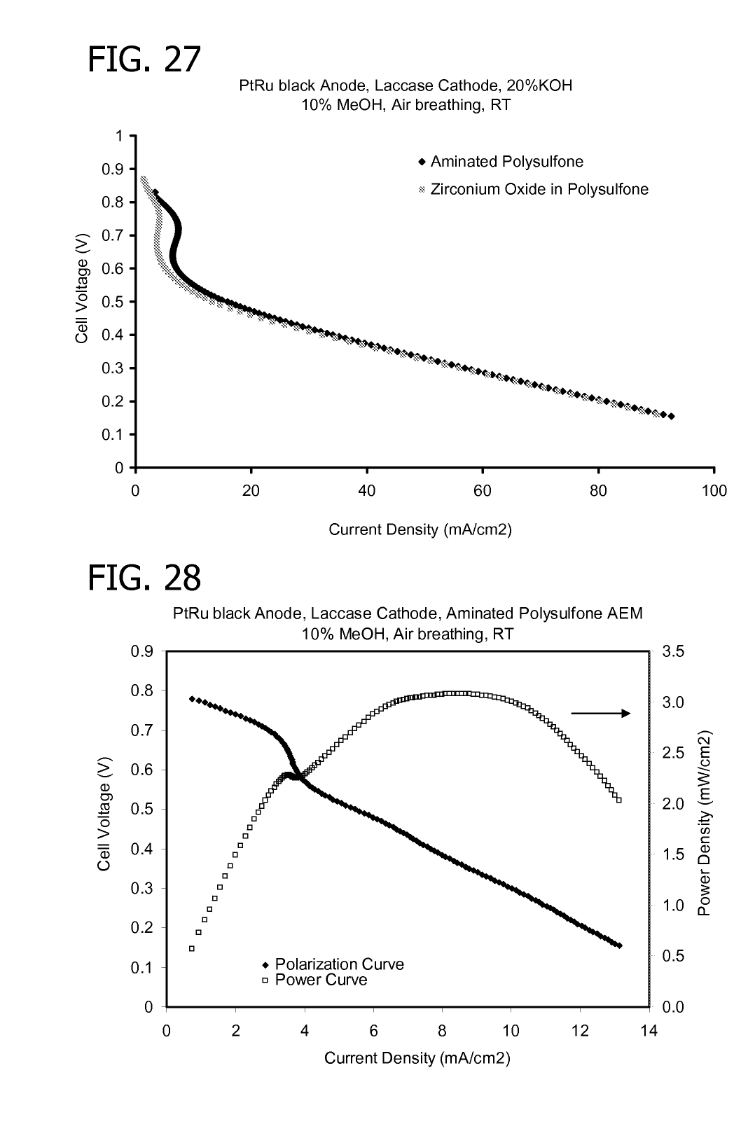

Polysulfone (10 g) and 40 mL of 1,2-dichloroethane are placed in a 3-neck 250 mL round bottom flask, and the solution was stirred with a teflon stir bar to dissolve polysulfone. Once homogenized, 20 mL chloromethyl methyl ether and 2 g zinc chloride (ZnCl₂) were added to the flask. The flask was equipped with a thermometer, a condenser, and a rubber septum to cover the third opening. The reaction mixture was then heated to 40° C. while stirring and reacted for 4.5 hours. The solution was then cooled to room temperature and precipitated into 1.2 L of methanol. The crude chloromethylated polysulfone was collected and dried in the vacuum oven overnight at room temperature. This polymer was then redissolved in 200 mL 1,4-dioxane and reprecipitated into 1.2 L of methanol. The purified chloromethylated polysulfone was then collected and dried in the vacuum oven overnight at room temperature. 1H NMR results indicate that 33% of the benzene rings in the polysulfone backbone were chloromethylated, corresponding to an average of 1.3 chloromethyl groups per repeat unit. A 20 wt. % chloromethylated polysulfone in N-methylpyrrolidone (NMP) by weight mixture was prepared by stirring with a teflon stir bar in a glass vial. Once the polymer was fully dissolved, 2 mL of the solution was placed onto a dry mirror finished 12 inch×12 inch aluminum plate. The solution was rolled out using a glass rod to form a 3 inch×3 inch 10 mil membrane. The membrane was then rinsed off first with methanol and then deionized water and soaked in deionized water for 1 hour. The membrane was then soaked in 0.035M solution of trimethylamine in deionized water for 24 hours. The membrane was then soaked in deionized water for 0.5 hours to remove any excess trimethylamine and subsequently placed in 1M potassium hydroxide solution in deionized water for 24 hours. Fuel cell performance of this membrane operating on just a methanol fuel, free of added KOH, is shown in FIG. 28. Although the current density of this cell was much less than when KOH was added to the fuel solution, the cell demonstrated stable performance from run to run indicating that the functional sites were retained and exchange anions across the membrane.

### Example 4

### Synthesis of Aminated Polycarbonate

Polycarbonate (10 g, PC) and 80 mL of 1,2-dichloroethane were placed in a 3-neck 250 mL round bottom flask, and the solution was stirred with a teflon stir bar to dissolve polycarbonate. Once homogenized, 20 mL chloromethyl methyl ether and 2 g zinc chloride (ZnCl₂) were added to the flask. The flask was equipped with a thermometer, a condenser, and a rubber septum to cover the third opening. The reaction mixture was then heated to 40° C. while stirring and reacted for 4.5 hours. The solution was then cooled to room temperature and precipitated into 1.2 L of methanol. The crude chloromethylated polycarbonate was collected and dried in the vacuum oven overnight at room temperature. This polymer was then redissolved in 200 mL 1,4-dioxane and reprecipitated into 1.2 L of methanol. The purified chloromethylated polycarbonate (PC—CH₂Cl) was then collected and dried in the vacuum oven overnight at room temperature. ¹H NMR results indicated that only 5% of the benzene rings in the polycarbonate backbone were chloromethylated, corresponding to an average of 0.1 chloromethyl groups per repeat unit. A 20 wt. % solution of PC—CH₂Cl in N-methylpyrrolidone (NMP) was prepared by stirring with a teflon stir bar in a glass vial.

Amination via trimethylamine. Beads of PC—CH₂Cl were prepared by precipitating the 20 wt. % PC—CH₂Cl in NMP solution into a beaker with 500 mL deionized water. The beads were then stirred in the deionized water with a teflon stir bar for 30 minutes. The beads were then collected and soaked in a solution of 0.04M trimethylamine in deionized water for 24 hours. They were then collected, rinsed with deionized water, and soaked in a 1M potassium hydroxide or potassium bicarbonate aqueous solution for 24 hours to exchange the chloride anions for either hydroxide or bicarbonate ions.

Amination via a tertiary diamine. A tertiary diamine (such as N,N,N′,N′-tetramethyl-1,6-hexanediamine, TMHDA) was added to the 20 wt % PC—CH₂Cl in NMP solution at an equimolar ratio of chloromethyl groups to tertiary nitrogens (equivalent to a 1:0.5 ratio of chloromethyl groups to diamine). For instance, 0.04 mL of TMHDA was added to 5 mL of a 20 wt. % solution of PC—CH₂Cl described above (0.1 chloromethyl groups per repeat unit). The mixture was stirred for several minutes until noticeably more viscous. Beads were then prepared by precipitating this mixture into a beaker with 500 mL deionized water. The beads were then stirred in the deionized water with a teflon stir bar for 30 minutes. They were then collected and soaked in a 1M potassium hydroxide or potassium bicarbonate aqueous solution for 24 hours to exchange the chloride anions for either hydroxide or bicarbonate ions.

### Example 5

### Synthesis of Crosslinked Poly(Vinylbenzyl Chloride)

A 33 wt. % solution of poly(vinylbenzyl chloride) (PVBC) in dioxane was prepared by stirring with a teflon stir bar in a glass vial. The choice of tertiary diamine or tertiary diamine mixture utilized to simultaneously aminate and crosslink PVBC affects the resulting chemical and mechanical properties of the beads and must be optimized for best performance. The use of two different diamine crosslinkers is described below.

Crosslinking with N,N,N′,N′-tetramethyl-methanediamine (TMMDA). TMMDA (0.74 mL) was added to 5 mL of 33 wt. % PVBC dioxane solution (corresponding to an equimolar ratio of chloromethyl groups to nitrogens). The mixture was stirred for 3 minutes until noticeably more viscous. Beads were then prepared by precipitating this solution into a beaker with 500 mL deionized water. The beads were then stirred in the deionized water with a teflon stir bar for 30 minutes. They were then collected and soaked in a 1M potassium hydroxide or potassium bicarbonate aqueous solution for 24 hours to exchange the chloride anions for either hydroxide or bicarbonate ions.

Crosslinking with N,N,N′,N′-tetramethyl-phenylenediamine (TMPDA). TMPDA (0.89 g) was added to 5 mL of 33 wt. % PVBC dioxane solution (corresponding to an equimolar ratio of chloromethyl groups to nitrogens). The mixture was stirred for 1 hour until noticeably more viscous. The reaction of PVBC with TMPDA was much slower than its reaction with TMMDA, so these solutions were stirred longer before bead formation. Beads were then prepared by precipitating this solution into a beaker with 500 mL deionized water. The beads were then soaked in the deionized water for 30 minutes. These beads were not stirred in water after precipitation because these beads were hydrogel-like materials that can break apart with strong agitation. They were then collected and soaked in a 1M potassium hydroxide or potassium bicarbonate aqueous solution for 24 hours to exchange the chloride anions for either hydroxide or bicarbonate ions.

### Example 6

### Stack and Housing Engineering

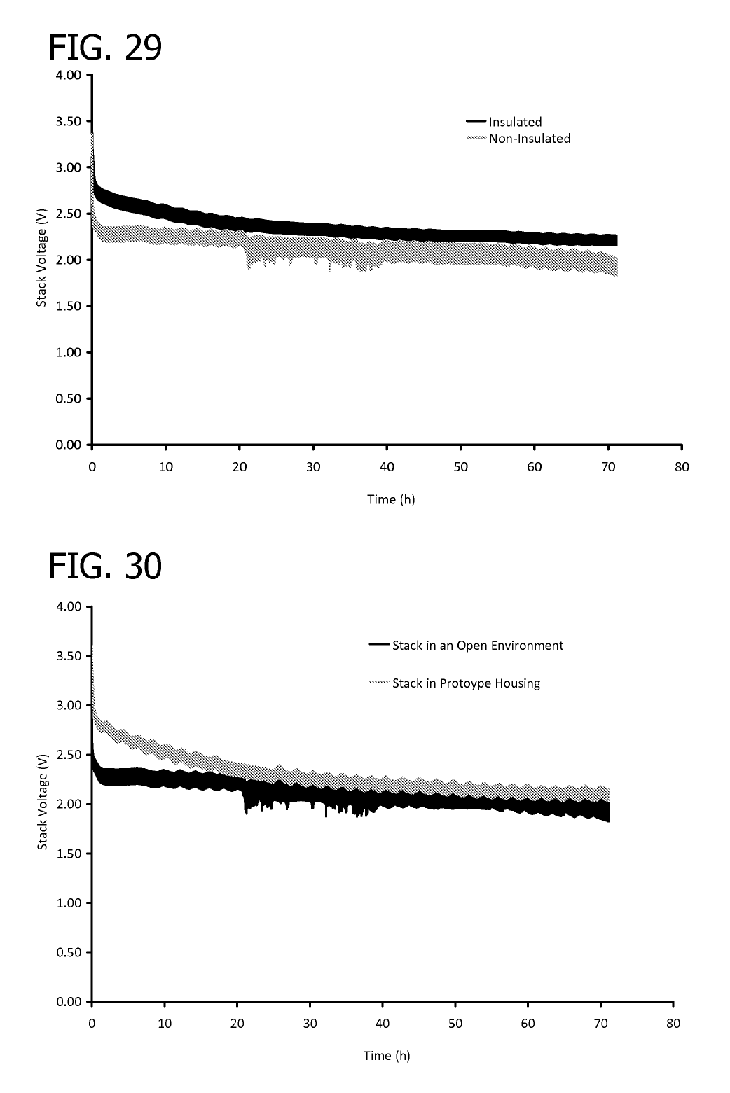

It was determined that temperature and humidity variations affected the runtime of the stack. In order to minimize these effects, the stacks were tested inside ventilated polystyrene foam coolers to insulate them from the temperature and humidity variations. Once the temperature and humidity variations were controlled, the runtime increased as shown in FIG. 29. In order to better pinpoint the causal advantage of this insulation effect, environmental testing with varying temperature and humidity was initiated. A baseline test of the stack was run at ambient, bench top conditions with a temperature and humidity sensor/logger (Omega) monitoring environmental conditions. A simulated environment was created with a 50 mL beaker of water in a cooler to help increase the relative humidity (RH) but maintain relative room temperature while minimizing temperature fluctuations. Low RH testing was initiated with 2 stacks that had previous runs documented under ambient bench top conditions, a stack with 60 wt. % methanol and a stack with 40 wt. % methanol. The 60 wt. % methanol stack had a shorter run time than the 40 wt. % methanol stack when run just inside of a cooler with no alterations made. When the temperature reached 51.2° C. inside the cabinet and the RH was down between 24 and 35%; these conditions caused the mechanical failure of the stacks after 15 hours of operation. Further tests were developed to run the fuel cell stack in different modified housings to see if the environment of a closed cooler could be simulated. Modifications to the housing included reduction in air holes to one per cell and the use of air permeable polypropylene separator material between the cathodes and housing wall to insulate the stack from temperature variations and help retain moisture. Initial observations suggested high RH and higher temperatures were better for runtime.

Passive fluid management. In order to incorporate/simulate the air and humidity control of the simulated closed environment reported in FIG. 29, several changes and additions were added to the general stack housing. The additions to the design included two 0.009″ melt blown polypropylene battery separators (forming layers 507) added to the exterior of the cathode electrodes and the reduction in the number of air breathing holes 503 in the housing 91 to a single hole per electrode as described above. These changes resulted in significant improvements to the runtime of over 400% for the fuel cell system. An example of this improved lifetime is shown in FIG. 30.

### Example 7

### Fuel Electrolyte

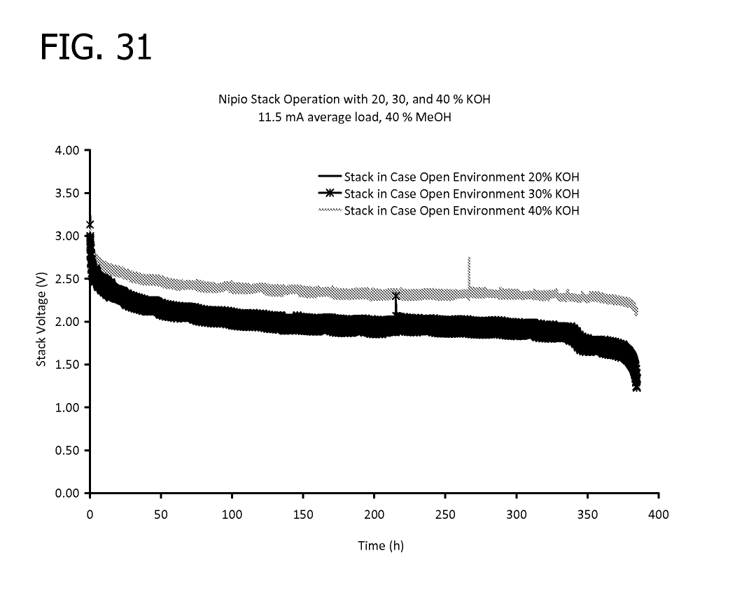

It was determined that the major failure mode of the stack was carbonate build up in the membrane and electrolyte that caused the stack to lose conductivity or to mechanically separate if carbonate precipitate formed. To increase the carbonate solubility, the potassium hydroxide concentration was increased. As illustrated in FIG. 31, the runtime for the fuel cell stack increased with increasing potassium hydroxide concentration from 20 to 30 wt. %. When the concentration of the electrolyte was increased to 40 wt. %, the runtime stayed the same as at 30 wt. % KOH, but the power output increased by 20%. The experiment was run by fabricating three equivalent stacks, all exposed to open environment but placed inside the prototype housing, and filled with a single electrolyte fueling, where the methanol concentration was held constant and only the potassium hydroxide concentration was changed.

### Example 8

### Biocoin Cell

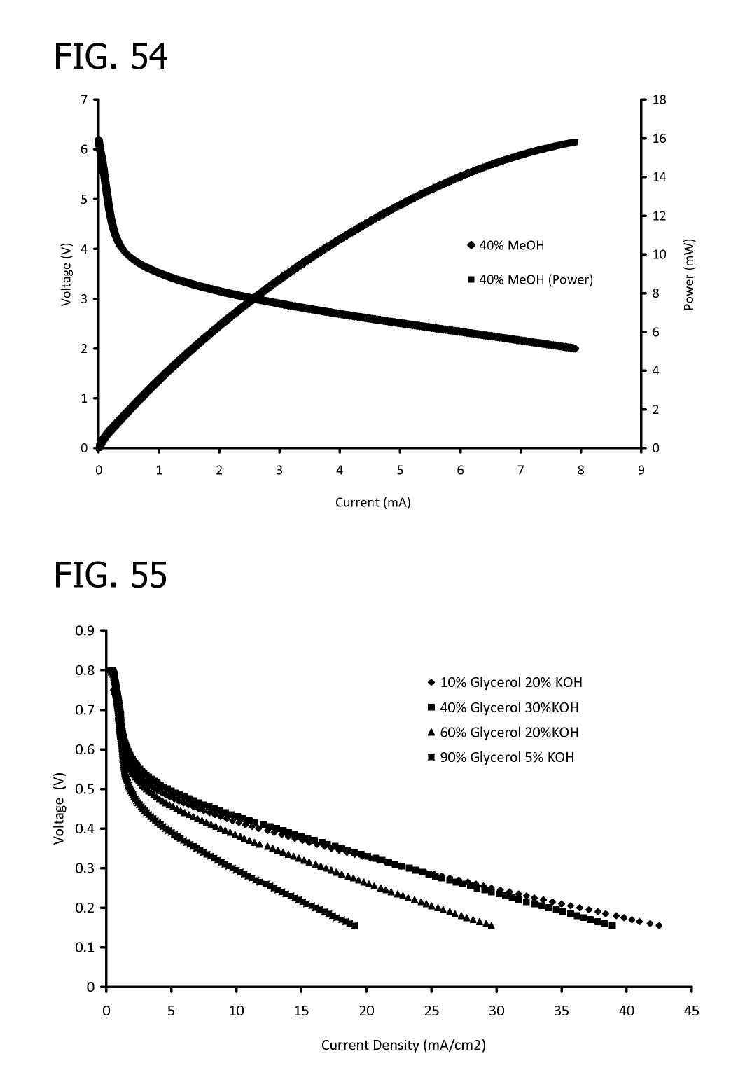

A biocoin cell having an anode with 14 mg/cm² of 1:1:1 Pt:Pd:Au catalyst on a nickel foam current collector and a laccase immobilized in TBAB modified Nafion® on a Elat carbon cloth electron conductor with 16 mg/cm² carbon, 0.4 mg/cm² laccase, and 1.6 mg/cm² of mixed metal phthalocyanine The metal phthalocyanines mixture contains 0.4 mg/cm² each of copper phthalocyanines, nickel phthalocyanines, cobalt phthalocyanines, and iron phthalocyanines. The coin cell had a zirconium oxide doped polysulfone membrane that was soaked in 50% potassium hydroxide. The fuel solution consisted of 20% potassium hydroxide and 40% methanol. For evaluation, linear sweep voltammetry was run on the stack from open circuit to 2.0 V at a 2 mV/s scan rate to verify that an adequate load could be pulled from the thin film stack. The resulting IV curve and power curve are given in FIG. 54.

### Example 9

### Cell Using Glycerol Fuel

An example of the preferred embodiment is the use of nickel foam for the anode electrode catalyst support. Since high concentrations of a glycerol fuel are preferred, because glycerol is a highly viscous liquid, a more open electrode support structure was desired. When utilizing a more open structure, such as an expanded metal package or carbon cloth, the amount of catalyst that can be loaded on the anode is greatly decreased. When using higher surface area electrodes such as nickel foam and carbon felt, up to an eight-fold increase in the palladium loading was observed. The ink formulation used was made up of 7.5 mL 2.5% palladium chloride and 7.5 mL 25 mg/mL ruthenium chloride. The data, shown in FIG. 55, was collected from single cell testing using a single cell test fixture. The same anode was used for all concentrations of glycerol. Palladium-ruthenium was loaded onto nickel foam via sodium borohydride reduction method for a loading of 6.1 mg/cm², 3.05 mg/cm² of palladium. The biocathode used was a mixed phthalocyanines with laccase formulation on carbon cloth. The biocathode catalyst layer was prepared by mixing the enzyme, carbon, and metal phthalocyanine powders with a 5% Nafion® suspension in a lower aliphatic alcohol mixture prior to painting onto the carbon cloth. The metal phthalocyanines mixture contains 0.4 mg/cm² each of copper phthalocyanines, nickel phthalocyanines, cobalt phthalocyanines, and iron phthalocyanines for total loading 1.6 mg/cm². The membrane a zirconium oxide doped polysulfone. The data showed acceptable current density even at higher glycerol concentrations reaching near 20 mA/cm² for 90% glycerol fuel concentration while using the nickel foam for the catalyst layer support.

### Example 10

### Cell Having a Gold-Platinum-Palladium Anode Catalyst

In this example, a catalyst formulation having gold, platinum, and palladium was used. The gold-platinum-palladium was deposited onto nickel foam via sodium borohydride reduction in a 1:1:1 ratio. A metal foam electrode support was dipped into the gold, platinum, and palladium ink solution, and then reduced with sodium borohydride. The process was repeated four times. The catalyst formulation was 20 mL 8% chloroplatinic acid, 0.5 mg gold chloride, 0.5 mg palladium chloride, and 30 mL 5% hydrochloric acid.

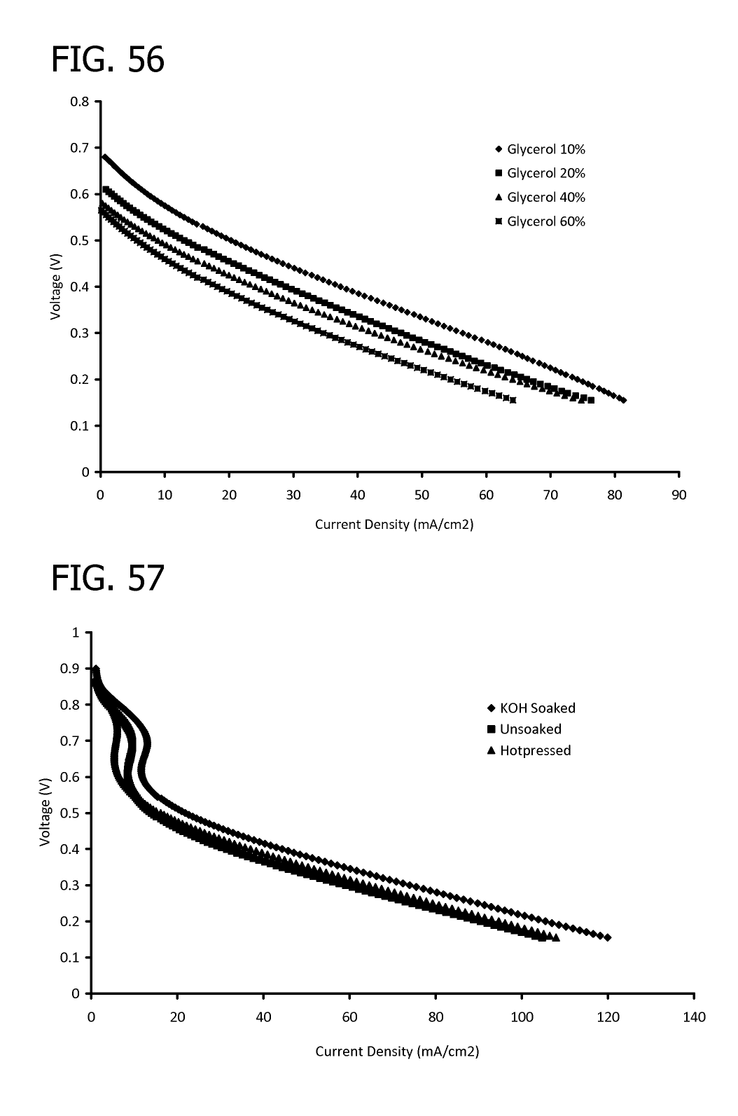

The data given in FIG. 56 was generated by testing the 1:1:1 gold:palladium:platinum electrode with 10%, 20%, 40% and 60% concentrations of glycerol with 20% potassium hydroxide. The anode and cathode electrodes were separated by a cellophane membrane. The biocathode was a laccase with metal phthalocyanines cathode painted onto an ELAT support. The metal phthalocyanines mixture contains 0.4 mg/cm² each of copper phthalocyanines, nickel phthalocyanines, cobalt phthalocyanines, and iron phthalocyanines for total loading 1.6 mg/cm². The immobilization material is a tetraethylammonium bromide modified Nafion®. The cell produced over 80 mA/cm² at 0.15V at low concentrations of glycerol (10%) with low mass transport constraints. The cell produced 60 mA/cm² of performance at 0.15V at high concentrations of glycerol (60%) with higher mass transport limitations.

### Example 11

### Cell with Cellophane Membrane (or Separator)

For the cellophane tests, 20 mg/cm² of platinum:ruthenium:carbon (2:1:1) catalyst ink solutions using Nafion® as binder were painted onto nickel foam, and mixed metal laccase cathodes were prepared. The metal phthalocyanines mixture contains 0.4 mg/cm² each of copper phthalocyanines, nickel phthalocyanines, cobalt phthalocyanines, and iron phthalocyanines for total loading 1.6 mg/cm². The immobilization material is a tetraethylammonium bromide modified Nafion®. The tests were run in 20% potassium hydroxide and 20% methanol. The initial treatment of the cellophane membrane (or separator) was to soak it in 50% potassium hydroxide for one minute, and then soak in 18 M-ohm deionized water for at least 20 minutes. An untreated cellophane membrane (or separator) was also tested for comparison. Finally, the cellophane was hot pressed at 125° C. and 1000 pounds for 30 seconds to verify heat stability. After the first press, a second identical press was used to fix the anode and biocathode onto the membrane (or separator). The three treatments are plotted in FIG. 57. The cellophane membrane performed similarly across all three of the treatment options.

### Example 12

### Six Cell Button Cell

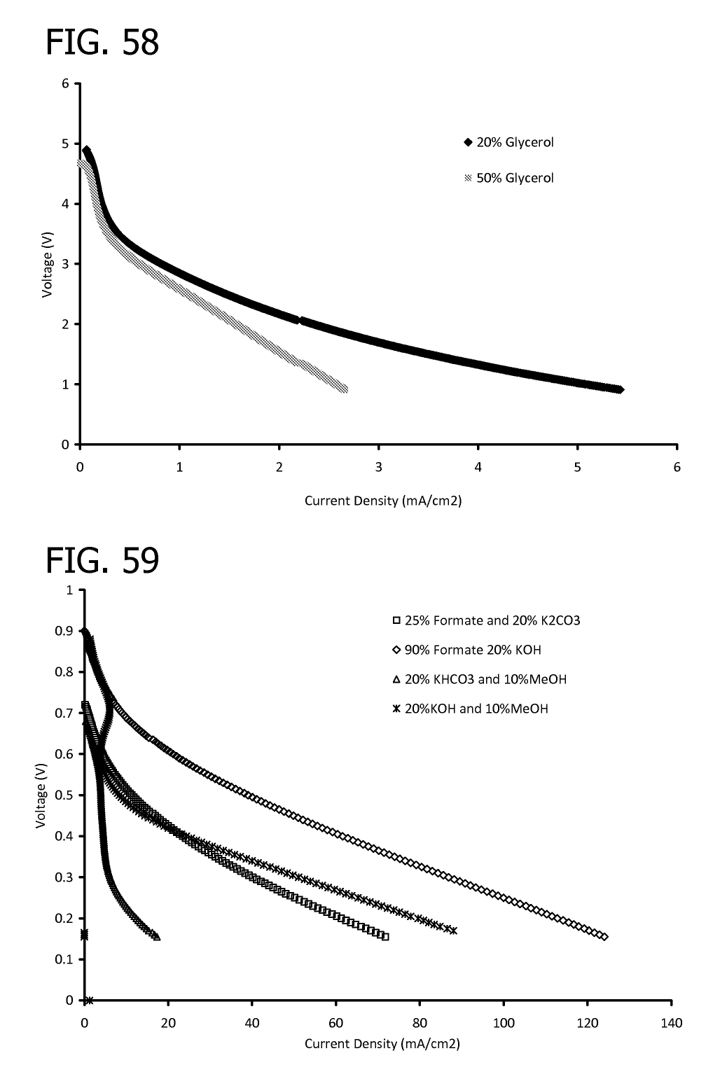

A six cell button cell was fabricated. It had a palladium-ruthenium directly reduced onto nickel foam via sodium borohydride in the anode with a loading of 7 mg/cm² palladium and 4 mg/cm² ruthenium, a zirconium doped polysulfone membrane, and a mixed metal phthalocyanine and laccase biocathode, glycerol concentrations of 20% and 50% were tested with 20% potassium hydroxide, in a passive air breathing configuration. The metal phthalocyanines mixture contains 0.4 mg/cm² each of copper phthalocyanines, nickel phthalocyanines, cobalt phthalocyanines, and iron phthalocyanines for total loading 1.6 mg/cm². The immobilization material is a tetraethylammonium bromide modified Nafion®. As shown in FIG. 58, the stack demonstrated full voltage addition in series with an open circuit approximately approaching 5.0V.

### Example 13

### Formate Fuel Cells

For each fuel cell using formate fuel, the anode catalyst was palladium gold directly reduced onto nickel foam via sodium borohydride. The palladium to gold ratio was 3:1. The palladium loading was 7.5 mg/cm² and the gold loading was 2.5 mg/cmwa.cathode formulation. The cathode formulation was 0.8 mg/cmwa copper phthalocyanine, 0.8 mg/cmwa iron phthalocyanine, 0.8 mg/cmwa nickel phthalocyanine, 0.8 mg/cmwa cobalt pthalocyanine, 0.8 mg/cmwa 15% tetrabutylammonium bromide modified nafion encapsulated laccase on printex 95, 16 mg/cmwa Monarch 1400, 2.8 uL/mg 5% Nafion solution.

Less fuel cross over was observed when formate was used, as shown in FIG. 59. The single cells in FIG. 59 had similar biocathodes and anion exchange membranes (AEMs), but a Pd/Au anode for formate and a Pt/Ru anode for methanol. Small depolarization effects were observed for the formate system in both KOH and K₂CO₃ at formate concentrations of 90% (w/v) as compared to methanol fuel cells. With lower alkalinity electrolytes, a higher amount of formate crosses over to the cathode because of the lower osmotic drag gradient; this is shown by the higher current densities for formate in 20% potassium carbonate versus methanol run in 20% potassium carbonate (<20 mA/cm² to >70 mA/cm²).

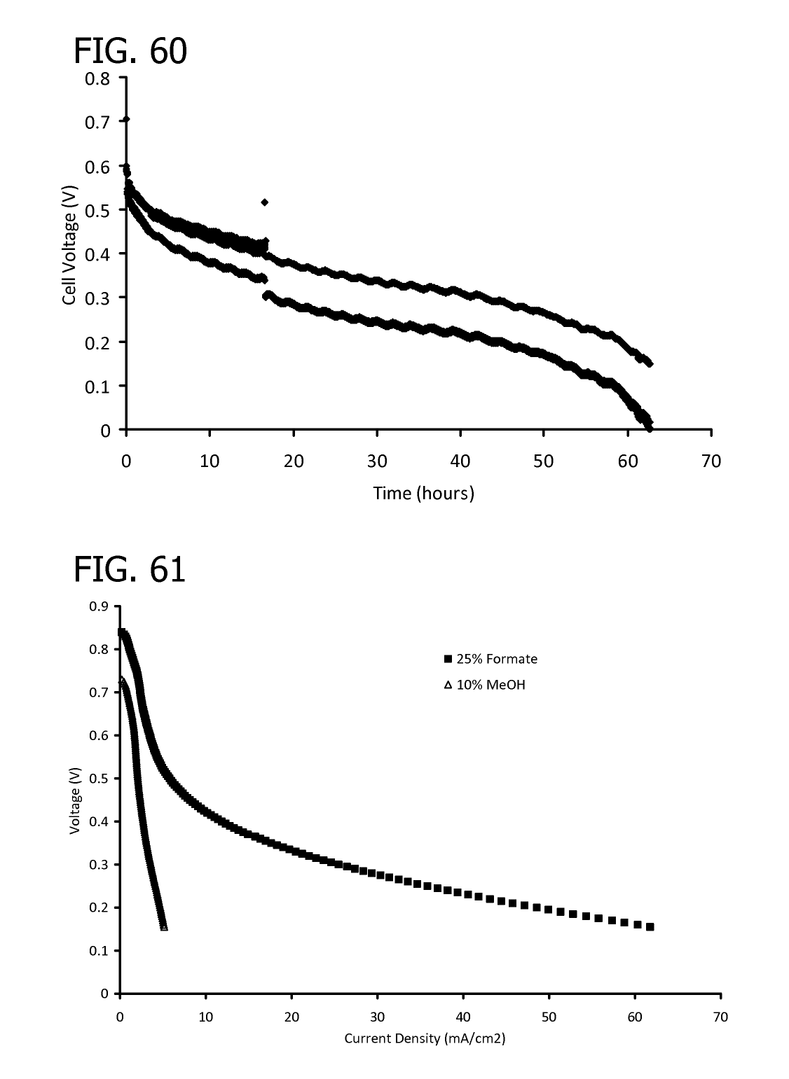

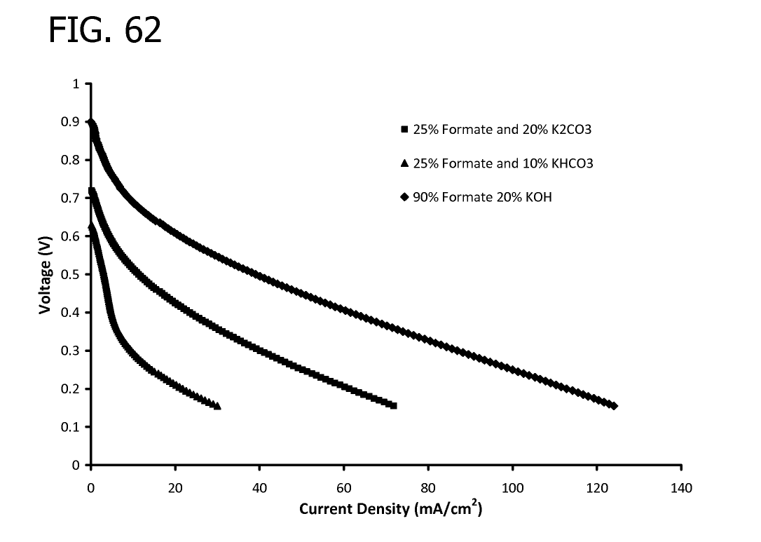

As shown in FIG. 60, a single fueling of 25% formate with 20% potassium carbonate (˜13 mL reservoir) in a passive compression cell configuration demonstrated nearly 63 hours of runtime. This represented almost 70% fuel utilization of the theoretical runtime. In comparison to similar experiments conducted using methanol and potassium hydroxide, a sharp drop was observed around 0.25V that dropped the voltage to 0V in a short period. The relatively linear voltage drop corresponded with decreasing pH and formate concentration. The average load applied to the cell was 22.5 mA and the anode was made from palladium and gold directly reduced onto nickel foam via sodium borohydride. The cathode was DS ELAT painted with mixed metal phthalocyanines and laccase. When running methanol with potassium hydroxide for constant load testing in the compression cell test fixture, typical test durations was 15 hours. The initial test was set up for 60,000 seconds, but since the fuel cell still had a voltage above 0.3V, the test was continued with a longer sample size. This stopping and restarting resulted in the jagged portion of FIG. 60 at approximately 15 hours.

The performance of the anion exchange membrane (AEM) was increased using formate as a fuel as compared to methanol in a solution free of added base. The pH of 25% formate solution in water was about 8.4, which was sufficiently basic for a working alkaline system, whereas a methanol solution was slightly acidic. Initial evaluation of a QPVA based anion exchange membrane in a formate fuel cell was performed using potassium formate that was purchased from Sigma and used as received. The membrane was tested using a 25% formate aqueous solution and then compared to a similar system using 10% methanol as the fuel. The formate fuel solution was tested with a palladium gold anode catalyst layer that was directly deposited onto nickel foam via sodium borohydride reduction, resulting in the elimination of a binder and ionomer. The methanol fuel solution was tested with a platinum ruthenium anode catalyst layer painted onto nickel foam utilizing Nafion® as ionomer and binder. The cathode was the mixed metal phthalocyanines with laccase painted onto DS ELAT. The electrodes were tested in the compression cell test fixture using the anion exchange membrane. The resulting data is illustrated in FIG. 59.

As is shown in the FIG. 59, the formate in water performed substantially better than the similar system with methanol and no potassium hydroxide. The data reported in FIG. 59 is a comparison of the first linear sweep scan (2 mV/sec) of each fuel solution. The formate cell had a higher open circuit voltage, 0.84 V compared to 0.72 V in methanol, and higher current densities across the entire polarization curve. The improved performance using with the experimental AEM, of the formate system can be because of the slightly basic conditions and improved tolerance of the cathode to crossover effects of the fuel.

A test comprising of varying pH conditions and carbonation of the electrolyte was conducted by testing a formate fuel solution in potassium hydroxide (pH 14), potassium carbonate (pH 11.5), and potassium bicarbonate (pH 8.5). Since the anode reaction product is carbon dioxide, in strongly alkaline electrolyte solutions carbonate passivation of the electrolyte occurred. Due to the orders of magnitude loss in hydroxyl concentration, it is expected that there would be an observed current density loss as the pH of the electrolyte solution became more acidic. The fuel cells were tested with the standard mixed metal phthalocyanines and laccase painted onto DS ELAT cathode versus a palladium and gold deposited onto nickel foam directly via sodium borohydride. As demonstrated in FIG. 60, the fuel cell was still able to provide adequate loads at significant electrolyte carbonation levels. At 10% potassium bicarbonate, the fuel cell provided 30 mA/cm².

### Example 14

### Quaternized Poly(Vinyl Alcohol) AEM

A 7 wt. % solution of poly(vinyl alcohol) (PVA; 99+% hydrolyzed) in deionized water was prepared by stirring with a Teflon stir bar and heating to 70° C. in a round bottom flask equipped with a thermostat and condenser and placed in a heating mantle. Glycidyl trimethylammonium chloride (0.5:1 mole ratio with the OH groups in PVA) was slowly added to prevent PVA precipitation. A 2M potassium hydroxide solution (0.25:1 mole ratio with the OH groups in PVA) was then slowly added. The reaction proceeded for 18 hours at 70° C. before cooling to room temperature and neutralizing to pH 7 with concentrated hydrochloric acid to stop the reaction. The quaternized PVA (QPVA) was then collected via precipitation in methanol and dried in the vacuum oven at 50° C. Based on ¹H NMR results, this polymer had a substitution degree of 0.04 trimethylammonium groups per PVA repeat unit, corresponding to 15.1 wt % quaternized PVA.

To make an AEM, a 5 wt % QPVA solution in deionized water was prepared by stirring with a Teflon stir bar and heating to 70° C. in a glass beaker. After homogenized, the pH of this solution was adjusted to 5 using hydrochloric acid. 20 mL of this solution was then thoroughly mixed with 40 μL of a 25 wt % glutaraldehyde solution. It was then spread onto a glass plate and placed in an oven at 80° C. to dry for 3 hours. The oven temperature was then increased to 130° C. for another 2 hours to facilitate crosslinking The membrane was then removed from the oven and peeled off the glass plate. These AEMs could be tested from this dry state or hydrated by soaking for several hours in a variety of water/methanol mixtures before testing.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

1-49. (canceled)

50. A biocathode comprising
an electron conductor;
a cathode enzyme capable of gaining electrons from the electron conductor and reacting with an oxidant to produce water,
a precious metal catalyst or a combination of metal complexes wherein each metal complex in the combination has a different reduction potential;
and an enzyme immobilization material capable of immobilizing and stabilizing the enzyme, the immobilization material being permeable to the oxidant.

51. The biocathode of claim 50 wherein the combination of metal complexes comprises two or more of copper phthalocyanine, iron phthalocyanine, nickel phthalocyanine, cobalt pthalocyanine, platinum, platinum alloy, platinum black, platinum/ruthenium, copper porphyrin, iron porphyrin, nickel porphyrin, cobalt porphyrin, copper tetraazaporphyrin, iron tetraazaporphyrin, nickel tetraazaporphyrin, cobalt tetraazaporphyrin, copper tetrabenzoporphyrin, iron tetrabenzoporphyrin, nickel tetrabenzoporphyrin, cobalt tetrabenzoporphyrin, or a combination thereof.

52-104. (canceled)

105. The biocathode of claim 50 wherein the immobilization material comprises a cation modified perfluoro sulfonic acid-PTFE copolymer modified with a hydrophobic cation larger than NH₄⁺.

106. The biocathode of claim 50 wherein the enzyme immobilization material comprises an alginate and the alginate is a cation-modified alginate modified with a hydrophobic cation larger than NH₄⁺.

107. The biocathode of claim 105 wherein the hydrophobic cation comprises tetraethylammonium, tetrapropylammonium (T3A), tetrapentylammonium (T5A), tetrahexylammonium (T6A), tetraheptylammonium (T7A), trimethylicosylammonium (TMICA), trimethyloctyldecylammonium (TMODA), trimethylhexyldecylammonium (TMHDA), trimethyltetradecylammonium (TMTDA), trimethyloctylammonium (TMOA), trimethyldodecylammonium (TMDDA), trimethyldecylammonium (TMDA), trimethylhexylammonium (TMHA), tetrabutylammonium (TBA), triethylhexylammonium (TEHA), or a combination thereof.

108. The biocathode of claim 105 wherein the hydrophobic cation comprises a quaternary ammonium cation represented by formula 1 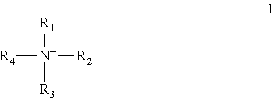
wherein R₁, R₂, R₃ and R₄ are independently hydrogen, hydrocarbyl, substituted hydrocarbyl or heterocyclo wherein at least one of R₁, R₂, R₃ and R₄ is other than hydrogen.

109. The biocathode of claim 108 wherein R₁, R₂, R₃ and R₄ are independently hydrogen, methyl, ethyl, propyl, butyl, pentyl, hexyl, heptyl, octyl, nonyl or decyl wherein at least one of R₁, R₂, R₃ and R₄ is other than hydrogen.

110. The biofuel cell or biocathode of claim 108 wherein R₁, R₂, R₃ and R₄ are ethyl.

111. The biocathode of claim 50 wherein the immobilization material is a micellar hydrophobically modified polysaccharide.

112. The biocathode of claim 111 wherein the polysaccharide comprises chitosan.

113. The biocathode of claim 112 wherein the micellar hydrophobically modified polysaccharide corresponds to Formula 2 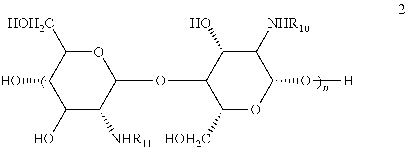
wherein n is an integer;
R₁₀ is independently hydrogen, hydrocarbyl, substituted hydrocarbyl, or a hydrophobic redox mediator; and
R₁₁ is independently hydrogen, hydrocarbyl, substituted hydrocarbyl, or a hydrophobic redox mediator.

114. The biocathode of claim 50 wherein the immobilization material entraps the enzyme, the immobilization material being permeable to a compound smaller than the enzyme and having the structure of either Formulae 5, 6, 7, or 10: 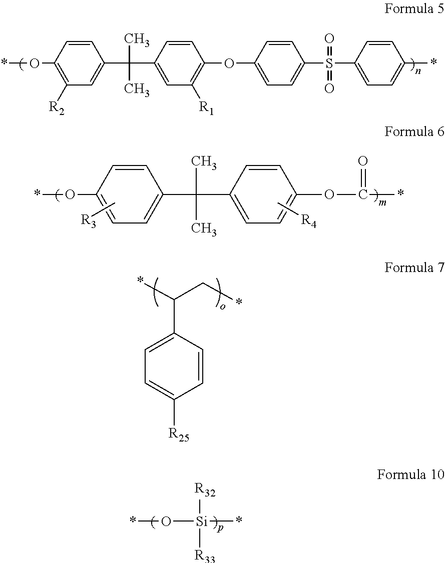
wherein
R₂₁ and R₂₂ are independently hydrogen, alkyl, or substituted alkyl, provided that the average number of alkyl or substituted alkyl groups per repeat unit is at least 0.1;
R₂₃ and R₂₄ are independently hydrogen, alkyl, or substituted alkyl, provided that the average number of alkyl or substituted alkyl groups per repeat unit is at least 0.1;
R₂₅ is hydrogen, alkyl, or substituted alkyl, provided that the average number of alkyl or substituted alkyl groups per repeat unit is at least 0.1;
R₃₂ and R₃₃ are independently hydrogen, alkyl, aryl, or substituted alkyl, provided that the average number of hydrogen atoms per repeat unit is at least 0.1; and
m, n, and o are integers of at least 10.

115. The biocathode of claim 50 wherein the immobilization material is a micellar or inverted micellar polymer.

116. A biofuel cell device for supplying electrical power to a load, said device comprising:
at least one fuel cell;
a controller for controlling an electrical output of the fuel cell according to a defined operating mode; and
a MOSFET switching circuit situated between the fuel cell and the load, said switching circuit being responsive to the controller for alternately connecting the electrical output of the fuel cell to the load and disconnecting the electrical output of the fuel cell from the load according to the operating mode
wherein said fuel cell comprises a biocathode of claim 50.

117. A biofuel cell comprising
an alkaline fuel fluid;
an oxidant;
an anode capable of oxidizing the fuel fluid and releasing electrons;
a biocathode of claim 50 comprising a cathode enzyme capable of reacting with the oxidant to produce water; and
an anion exchange membrane.

118. The biofuel cell of claim 117 wherein the fuel fluid comprises formate.

119. The biofuel cell of claim 117 wherein the anion exchange membrane has the structure: 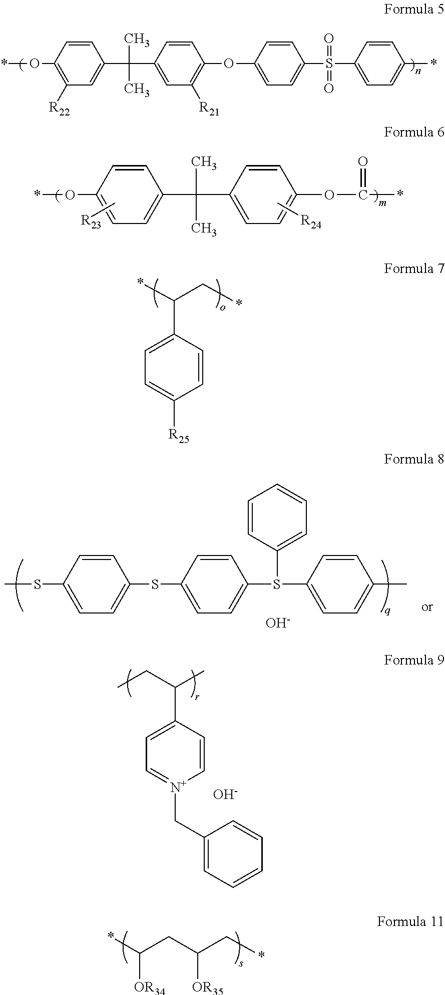
wherein
R₂₁, R₂₂, R₂₃, R₂₄ and R₂₅ are independently hydrogen, alkyl, or substituted alkyl, provided that the average number of alkyl or substituted alkyl groups per repeat unit is at least 0.2;
R₃₄ and R₃₅ are independently hydrogen, alkyl, or substituted alkyl, provided that the average number of substituted alkyl groups per repeat group is 0.1; and
m, n, o, q, r, and s are integers of at least 10.

120. A biofuel cell of claim 117 further comprising:
at least one reservoir containing a fuel fluid,
at least one anode-cathode assembly comprising at least one anode positioned for contact with fuel fluid in the reservoir and at least one biocathode positioned for flow of air to a biocathode enzyme,
an external biocathode terminal electrically connected to the at least one anode-cathode assembly, and
an external anode terminal electrically connected to the at least one anode-cathode assembly.

121. The biofuel cell of claim 120, further comprising a reservoir body defining said at least one reservoir, said reservoir body having a first end face facing the cathode terminal and a second end face facing the anode terminal, said at least one reservoir extending through the reservoir body from the first end face to the second end face, said at least one anode-cathode assembly being disposed on the first end face of the reservoir body with the assembly in contact with the fuel in the reservoir.

122. The biofuel cell of claim 121, further comprising a reservoir cap having an end wall and a circumferential side wall extending from the end wall to define a cavity for receiving said reservoir body, and a sealing member inside the cavity between the end wall of the reservoir cap and the second end face of the reservoir body for sealing the at least one reservoir.
